(19) United States
(12) Patent Application Publication
(10) Pub. No.: US 2006/0282323 A1
(43) Pub. Date: Dec. 14, 2006

(54) Systems and methods for vending machine jackpots

(76) Inventors: Jay S. Walker, Ridgefield, CT (US); Daniel E. Tedesco, (US); Paul T. Breitenbach, Wilton, CT (US); James A. Jorasch, New York, NY (US); Robert C. Tedesco, Fairfield, CT (US); Sih Y. Lee, Northvale, NJ (US); Paul D. Signorelli, Ridgefield, CT (US)

Correspondence Address: WALKER DIGITAL, 2 HIGH RIDGE PARK, STAMFORD, CT, 06905, US

(21) Appl. No.: 11/430,749

(22) Filed: May 9, 2006

Related U.S. Application Data
(63) Continuation-in-part of application No. PCT/US04/40974, filed on Dec. 8, 2004.
(60) Provisional application No. 60/527,899, filed on Dec. 8, 2003.
(60) Provisional application No. 60/679,137, filed on May 9, 2005.

(51) Int. Cl. G07G 1/14; G06K 15/00; G06Q 30/00

(52) U.S. Cl. 705/14; 235/383

(57) ABSTRACT

According to an embodiment, a jackpot may be available as a prize and/or incentive via a vending machine. In some embodiments, a network of vending machines may contribute to and/or define the jackpot.

### CROSS-REFERENCE TO RELATED APPLICATIONS

This application (i) is a continuation-in-part that claims priority and benefit under 35 U.S.C. §120 to commonly owned, co-pending International Application US2004/040974 entitled “PRODUCTS AND PROCESSES FOR PROMOTIONS WHICH EMPLOY A VENDING MACHINE” filed Dec. 8, 2004, which claims priority to U.S. Provisional Patent Application Ser. No. 60/527,899 entitled “PRODUCTS AND PROCESSES FOR PROMOTIONS WHICH EMPLOY A VENDING MACHINE” filed on Dec. 8, 2003, and (ii) also claims priority and benefit under 35 U.S.C. §119(e) to U.S. Provisional Application Ser. No. 60/679,137 entitled “PRODUCTS AND PROCESSES FOR PROMOTIONS WHICH EMPLOY A VENDING MACHINE”, filed on May 9, 2005, each of these applications being hereby incorporated by reference herein.

### BACKGROUND

Conventional vending machines and vending machine systems are generally capable of dispensing offered products to customers. Such dispensing is typically conducted on a transaction-by-transaction basis, with each customer inserting money into the vending machine and selecting one or more desired products. Conventional vending machines, however, are prone to various inefficiencies, problems, and limitations.

### BRIEF DESCRIPTION OF THE FIGURES

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3 is a block diagram of a system according to some embodiments;

FIG. 4 is a block diagram of a system according to some embodiments;

FIG. 5A and FIG. 5B are schematic block diagrams of exemplary configurations of software architecture according to some embodiments;

FIG. 6 is an illustration of potential product entitlement game results;

FIG. 7 is an illustration of potential bonus benefit game results;

FIG. 8 depicts an example display output by a vending machine according to some embodiments;

FIG. 9 depicts an example display output by a vending machine according to some embodiments;

FIG. 10 depicts an example display output by a vending machine according to some embodiments;

FIG. 11 depicts an example display output by a vending machine according to some embodiments;

FIG. 12 depicts an example display output by a vending machine according to some embodiments;

FIG. 13 depicts an example display output by a vending machine according to some embodiments;

FIG. 14 depicts an example display output by a vending machine according to some embodiments;

FIG. 15 depicts an example display output by a vending machine according to some embodiments;

FIG. 16 depicts an example display output by a vending machine according to some embodiments;

FIG. 17 depicts an example display output by a vending machine according to some embodiments;

FIG. 18 depicts an example display output by a vending machine according to some embodiments;

FIG. 19 depicts an example display output by a vending machine according to some embodiments;

FIG. 20 depicts an example display output by a vending machine according to some embodiments;

FIG. 21 depicts an example display output by a vending machine according to some embodiments; and

FIG. 22 depicts an example display output by a vending machine according to some embodiments.

### DETAILED DESCRIPTION

I. Introduction

According to some embodiments, a customer may approach a vending machine that provides “2-for-1” sales (e.g., two (2) items for one dollar ($1)). The customer deposits currency (e.g., one dollar ($1)) and selects the first of two items to purchase. In response, the vending machine initiates a “game” (e.g., a spinning wheel to indicate one of a plurality of possible results) to automatically determine a “game result”. The game result may be selected from a group that consists, in whole or part, of one or more of the following results:
1. An inventory group that has been defined and indicated (e.g., as specified in a “reactive grouping” embodiment of co-pending U.S. patent application Ser. No. 10/902,397, filed on Jul. 29, 2004), a second item is selected from the inventory group, and that second item is provided;
2. A second item and another benefit (e.g., coupon, refund, phone card, free spin of the wheel, subscription, fixed-price upsell for additional product, alternate first product offer, free second item, sweepstakes entry) are provided;
3. No second item or other benefit is provided (“game over”);
4. No second item, but a benefit is provided;
5. An inventory group is defined and indicated (e.g., as specified in a “reactive grouping” embodiment of co-pending U.S. patent application Ser. No. 10/902,397, filed on Jul. 29, 2004) and the customer can select one item from this inventory group;
6. An inventory group is indicated and the customer can select one item from this inventory group, and also another benefit is provided; and
7. A multiplier of some value is indicated, so that the customer may receive some benefit, in an amount related to the multiplier (e.g., a customer's unit balance in his subscription account may be multiplied by three).

According to some embodiments of the present invention, a customer may approach a vending machine that provides “2-for-1” sales (e.g., two items for a dollar). The customer deposits currency (e.g., $1.00) and selects two items to purchase (e.g., one each from a first inventory group and second inventory group). In response, the vending machine initiates a “game” (e.g., a spinning wheel to indicate one of a plurality of possible results) to automatically determine a “game result”. The game result may be selected from a group that consists of the following results:
1. “Improve” a first inventory group (e.g., provide an option allowing the customer to select an alternate to the first product he selected);
2. “Improve” second inventory group (provide an option allowing the customer to select an alternate to the second product he selected);
3. “Improve” both inventory groups (provide an option allowing the customer to select alternates to the products he selected);
4. Provide another benefit as well as one of the above improvements to one or both inventory groups;
5. Provide another benefit.

According to some embodiments of the present invention, a customer may approach a vending machine. The customer deposits currency (e.g., $1.00) and selects an item to purchase (e.g., a $0.65 candy bar). In response, the vending machine initiates a “game” (e.g., a spinning wheel displayed on a touch screen to indicate one of a plurality of possible results) to automatically determine a “game result”. The game result may be selected from a group that consists of the following results:
1. Provide a coupon;
2. Game over (no benefit provided);
3. Provide a non-inventory prize (e.g., provide a phone card);
4. Provide one or more “inventory prizes” (e.g., provide one or more products that might otherwise have been purchased form the vending machine);
5. Provide a subscription to products at the vending machine (“Membership”);
6. Provide a refund on the price of the first product;
7. Provide a discount or “special price” for the first product;
8. Provide a “fixed-priced upsell” (add $0.50 to the credit of the machine, allowing the customer to purchase a second product having a higher price);
9. Provide a “dynamically-priced upsell” (provide a second product for $0.35, thus giving the customer no change form a dollar tendered);
10. Provide one or more additional “spins” (i.e. one or more additional game results);
11. Provide any combination of above game results.

According to some embodiments of the present invention, the vending machine initiates a “game” (e.g., a spinning wheel to indicate one of a plurality of possible results) to automatically determine a “game result”. In some embodiments, the customer can influence or appear to influence the game result through various actions, such as:
1. Pressing a button (e.g., on a touch screen) to “stop” a spinning wheel, slot reels or other indicia that a game result is to be determined/to be presented;
2. Answering trivia questions (e.g., by selecting a multiple-choice option from a touch screen);
3. Choosing numbers, such as lottery/roulette/bingo numbers;
4. Uncovering masked game result (e.g., selecting “Door #3”);
5. Playing a “shell game” (selecting products under hats or shells that are shuffled);
6. “Catching” a game result (e.g., in basket).

The influence may be actual (i.e., the customer input is used in determining the game result) or perceived (i.e. the customer input is not used in determining the game result).

II. Terms and Definitions

Throughout the description that follows and unless otherwise specified, the following terms may include and/or encompass the example meanings provided in this section. These terms and illustrative example meanings are provided to clarify the language selected to describe embodiments both in the specification and in the appended claims.

Some embodiments described herein are associated with a “control system”. As used herein, the term “control system” may generally refer to any combination of hardware, software, firmware, and/or microcode that is operative to carry out and/or facilitate embodiments described herein. For example, a control system may comprise a processor performing instructions of a program to provide subscription accounts, account access, and/or account control or management functionality to customers and/or third parties. The control system may comprise, according to some embodiments, a single device and/or component or may comprise any practicable number of networked devices.

Some embodiments described herein are associated with a “network device”. As used herein, the term “network device” may generally refer to any device that can communicate via a network. Examples of network devices include a PC, a workstation, a server, a printer, a scanner, a facsimile machine, a copier, a PDA, a storage device (e.g., a disk drive), a hub, a router, a switch, and a modem or a wireless phone. In some embodiments, network devices may comprise one or more network components, such as a Static Random Access Memory (SRAM) device or module, a network processor, and/or a network communication path, connection, port, or cable. Some examples of network devices may include, but are not limited to, servers or controllers, customer devises, vending machines, input devices, output devices, and peripheral devices.

As used herein, the terms “server” and “controller” may be used interchangeably and may generally refer to any device that may communicate with one or more vending machines, one or more third-party servers, one or more remote controllers, one or more customer devices, one or more peripheral devices and/or other network nodes, and may be capable of relaying communications to and/or from each such device. A controller or sever may, for example, comprise one or more network devices and/or components.

As used herein, the terms “customer device” and “user device” may be used interchangeably and may generally refer to any device owned and/or operated by, or otherwise associated with a customer, which device is capable of accessing and/or outputting online and/or offline content. Customer devices may communicate with one or more servers or controllers, one or more vending machines, one or more third-party service provider servers, one or more user terminals, and/or other network devices or nodes. In some embodiments, customer devices may, for example, include gaming devices, PC devices, PDA devices, Point-Of-Sale (POS) terminals, point of display terminals, kiosks, telephones, cellular phones, Automated Teller Machines (ATM) devices, pagers, and/or combinations of such devices. In some embodiments, customer devices may communicate with vending machines and remote devices and/or computers wirelessly, through any practicable wireless communication networks, formats and/or protocols, including but not limited to those described herein.

As used herein, the term “vending machine” may generally refer to any system, apparatus, and/or module that is operable to provide and/or facilitate the provision of goods and/or services to customers. Vending machines may include, but are not limited to, for example, one or more stand-alone, networked, automated, mechanical, and/or electrical devices coupled to dispense products such as beverages and/or snacks to customers. In some embodiments, vending machines may comprise, be coupled to, and/or may be otherwise associated with one or more input devices, output devices, and/or peripheral devices (e.g., to operate in accordance with embodiments described herein).

As used herein, the terms “product,” “good,” “item”, “merchandise,” and “service” may be used interchangeably and may generally refer to anything licensed, leased, sold, available for sale, available for lease, available for licensing, and/or offered or presented for sale, lease, or licensing including individual products, packages of products (such as mystery packages), subscriptions to products, contracts, information, services, and intangibles. Examples of goods sold at vending machines may include, but are not limited to: beverages (e.g., cans or bottles of soda or water), snacks (e.g., candy bars), and recordable media (e.g., pre-recorded and/or dynamically-recorded disks or tapes). Examples of services sold by vending machines include car washes, photography services and access to digital content (e.g., permitting the downloading of digital picture, video, and/or audio files such as audio “ring tones” and/or wallpapers to a handheld device). In some embodiments, Wi-Fi™ and/or other network access (e.g., access to a peer-to-peer network), arcade style games, pinball games, and/or other media content may comprise a product and/or service offered by a vending machine.

As used herein, the term “input device” may generally refer to a device that is used to receive input. An input device may communicate with and/or be part of another device (e.g., a point of sale terminal, a point of display terminal, a customer terminal, a server, a customer device, a vending machine, a controller, and/or a peripheral device). Some examples of input devices include, but are not limited to: a bar-code scanner, a magnetic stripe reader, a computer keyboard, a point-of-sale terminal keypad, a touch-screen, a microphone, an infrared sensor, a sonic ranger, a computer port, a video camera, a motion detector, a digital camera, a network card, a Universal Serial Bus (USB) port, a Global Positioning System (GPS) receiver, a Radio Frequency IDentification (RFID) receiver, a RF receiver, a thermometer, a pressure sensor, and a weight scale or mass balance.

As used herein, the term “output device” may generally refer to a device that is used to output information. An output device may communicate with and/or be part of another device (e.g., a vending machine, a point of sale terminal, a point of display terminal, a customer device, and/or a controller). Possible output devices may include, but are not limited to: a Cathode Ray Tube (CRT) monitor, a Liquid Crystal Display (LCD) screen, a Light Emitting Diode (LED) screen, a printer, an audio speaker, an Infrared Radiation (IR) transmitter, an RF transmitter, and/or a product hopper, dispenser, and/or data port.

As used herein, the term “peripheral device” may refer to any device associated with one or more vending machines, the peripheral device being operable to perform in accordance with embodiments as described herein. For example, in one embodiment a traditional vending machine may be retrofitted with a peripheral device that comprises a processor, memory, and/or an output device for facilitating e-mailing of promotions such as mystery package promotions, subscription promotions, membership promotions, and/or other promotions associated with a vending machine, in accordance with embodiments described herein. A peripheral device may or may not be attached or coupled to a vending machine. A peripheral device may or may not be operable to direct the associated vending machine to perform certain functions. A peripheral device, or portions thereof, may be housed inside the casing of the associated vending machine. Further, a peripheral device may be operable to detect one or more events at a vending machine. For example, a peripheral device may be operable to detect one or more signals output by a processor of a vending machine. Further still, a peripheral device may be operable to communicate with a processor of an associated vending machine. According to some embodiments, a peripheral device (and/or a vending machine itself) may be configured to conserve coins and/or to facilitate intelligent dispensing of products.

Some embodiments described herein are associated with an “operator”. As used herein, the term “operator” may generally refer to the owner of a vending machine or an agent or associate thereof (e.g., a route driver or lessee of a vending machine). In some embodiments, an operator may also be associated with a server or controller and/or customer devices utilized to implement embodiments described herein. Operators may also or alternatively be associated with the manufacture and/or distribution of one or more products or services provided via a vending machine. According to some embodiments, an operator may be associated with restocking one or more vending machines (e.g., on a restock date and/or at a restock time).

As used herein, the term “promotion” may generally refer to a message that is output, regarding some product, distinct from a general offer to sell products from a vending machine at retail prices. For example, a promotion may comprise a message intended to increase machine profitability. Typically, a promotion allows customers to purchase one or more products under terms that are generally more favorable to the customer than standard retail terms (e.g., at prices less than or equal to the corresponding product's full price(s), but greater than or equal to the corresponding product's minimum price(s)). In some embodiments, a promotion may comprise an offer and/or incentive associated with providing a subscription account to a customer.

As used herein, the terms “package deal”, “combination deal”, “package promotion”, “combination promotion”, “combination product promotion”, “‘load-up deal”, “value combo deal”, and “combo deal” may be used interchangeably and may generally refer to any offer enabling a customer to purchase at least two products. In many embodiments the at least two products are sold for a single price. In many embodiments, the two products are dispensed to the customer essentially simultaneously (e.g., within seconds of each other). Typically, package offers are configured so the price of the at least two products is less than the sum of the prices of the two products, and thus the customer saves money compared to the sum of the individual component products' retail prices. According to some embodiments, customers may be presented with package offers in association with subscription accounts (e.g., an account may comprise a subscription to a package of products that may be redeemed at various times).

As used herein, the term “package price” may generally refer to the price that is charged (typically in a single transaction) for the units of products purchased pursuant to a package offer (e.g., associated with one or more package instances). Typically, package prices reflect a net-savings to the customer when compared to the sum of the respective retail prices of the individual component products. In some embodiments, such as in the case that a package is offered to a customer as a subscription offer, the package price may be equivalent to the subscription price.

Some embodiments herein are associated with “communication”. As used herein, the term “communication” may refer to any information, data, and/or signal that is provided, transmitted, received, and/or otherwise processed by an entity, and/or that is shared or exchanged between two or more people, devices, and/or other entities.

As used herein, the terms “information” and “data” may be used interchangeably and may refer to any data, text, voice, video, image, message, bit, packet, pulse, tone, waveform, and/or other type or configuration of signal and/or information. Information may be or include information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encrypted, and/or otherwise packaged or manipulated in accordance with any method that is or becomes known or practicable.

Some embodiments described herein may be associated with a “customer” and/or a “user”. As used herein the terms “customer” and “user” may generally be used interchangeably and may generally refer to any person or entity that transacts or interacts with a vending machine. For example, a user may be someone who receives a promotional message from a vending machine and/or computer associated therewith, visits the vending machine, enters a promotional code indicated in the message, and/or who accordingly receives a discounted or free product. The terms “user”, “customer”, “consumer”, “employee”, and “person” may all be used interchangeably herein. Customers and users may be transactional “customers”, “unfunded account holders”, “funded account holders”, “subscribers”, and/or “members”.

As used here, a “transactional customer” may generally refer to a cash customer or a customer of a vending machine that does not have an account with the vending machine and/or vending machine network. Cash customers and/or transactional customers may generally be unidentified and/or anonymous customers. As used herein, account-holding customers or “account holders” may generally be customers that have established accounts with the vending machine. In the case that a customer's account is created to provide free and/or promotional products to the customer, the account may be “unfunded” by the customer, and the customer may therefore be deemed and “unfunded account holder”. According to some embodiments, when a customer funds an account (e.g., upon account creation and/or in response to a promotional e-mail message), he account may be funded by the customer and the customer may therefore considered a “funded account holder”.

In some embodiments, an account holder may comprise a person who is entitled to redeem units of vended product pursuant to a registered subscription. Such customers may generally be referred to herein as “subscribers”. In one or more embodiments, a customer may register a subscription at a vending machine. Further, in one or more embodiments, a customer may register a subscription online. Further still, in one or more embodiments, a third party (e.g., a parent) may register a subscription for a customer (e.g., as a gift) either online or at a vending machine. Various apparatus, systems and methods describing “subscription” (or “prepaid unit”) accounts are disclosed in Applicant's U.S. Pat. No. 6,298,972, entitled METHOD AND APPARATUS FOR ESTABLISHING AND MANAGING VENDING MACHINE SUBSCRIPTIONS, issued Oct. 9, 2001; U.S. Pat. No. 6,085,888, entitled METHOD AND APPARATUS FOR ESTABLISHING AND MANAGING VENDING MACHINE SUBSCRIPTIONS, issued Jul. 11, 2000; and U.S. Pat. No. 5,988,346, entitled METHOD AND APPARATUS FOR ESTABLISHING AND MANAGING VENDING MACHINE SUBSCRIPTIONS, issued Nov. 23, 1999; the subscription account descriptions and concepts of each of which are hereby incorporated by reference herein.

In some embodiments, an account holder may be a “member” of the vending machine network. Such “members” may generally comprise account holders that have accepted membership promotional offers. Membership promotions may generally, for example, allow an account holder to pay a fee to receive discounts via the vending machine and/or vending machine network. In one or more embodiments, a customer may purchase a limited time membership account, and may be granted a membership identifier in return. The membership identifier allows the customer, during a limited time, to realize certain benefits and privileges at one or more vending machines. For example, in one or more embodiments, a valid membership identifier permits a customer to receive products (e.g., up to two (2) sodas per day), discounts (e.g., members may purchase items at wholesale prices or cost; only members may receive sale prices), and/or promotions (e.g., sweepstakes entries). Various apparatus, systems, and methods describing vending machine membership accounts are disclosed in Applicant's co-pending International Patent Application WO US2005/023029 entitled “PRODUCTS AND PROCESSES FOR A MEMBERSHIP FOR A CUSTOMER OF A VENDING MACHINE”, filed Jun. 29, 2005, the membership concepts and descriptions of which are hereby incorporated by reference herein.

As used herein, the terms “registered subscription” and “subscription” may be used interchangeably and may generally refer to any relationship between a customer and a vending machine operator that permits the customer to redeem multiple units of a product (and/or multiple products) at different times. The relationship may, for example, comprise a contractual relationship that is (i) formed upon the customers acceptance of a subscription offer, and/or (ii) recorded and tracked in a database (e.g., by the vending machine and/or associated devices). A registered subscription may generally be recorded in association with one or more account parameters set by an account holder and/or by a third party.

Some embodiments described herein may be associated with a “subscription code”, a “code”, and/or a “subscription identifier”. As used herein the terms “subscription code”, “code”, and “subscription identifier” may generally be used interchangeably, and may generally refer to any information or data that is associated with a vending machine customer subscription. Such a code or identifier may, in some embodiments, be correlated in a database with a registered subscription. Typically, such codes and/or identifiers may be “unique” or substantially unique identifiers. Such codes and/or identifiers may include, but are not limited to, customer-selected codes such as a Personal Identification Number (PIN) code, codes generated automatically (e.g., random digits) for the customer, a customer Social Security Number (SSN), customer credit or debit card numbers, currency serial numbers (e.g., the serial number of a dollar bill), customer birthdays, user names, passwords, device serial numbers (e.g., associated with a customers device), and/or biometric data (e.g., a customer's retinal patterns, fingerprint and/or thumbprint patterns, topical facial patterns, signatures, or the like). In some embodiments, subscription codes may be stored on, printed on, and/or otherwise indicated by tokens, coupons, cards, vouchers, wirelessly transmitting devices, RFID transmitters, and other physical media, as described herein. Subscription codes may generally be established, defined, and/or verified upon acceptance and/or consummation of a subscription offer.

As used herein, the term “subscription offer” may generally refer to any offer that is provided to a customer proposing that the customer pay a subscription price in exchange for the ability to redeem at least two units of a product or products at a vending machine in at least two redemption transactions. Thus, by accepting subscription offers, customers may be able to purchase at least two units of a product, and redeem the units of the product at different points in time (e.g., one the first day, another the following day). Subscription offers may be presented to customers via a vending machine (e.g., via voice, sound, and/or one or more displays) and/or via other devices or methods, such as via e-mail, direct mailing, etc. Subscription offers may also or alternatively be presented to every customer that interfaces with a vending machine, or only certain customers, such as customers that insert a certain threshold amount of funds, etc.

Some embodiments herein are associated with a “subscription price”. As used herein, the term “subscription price” may generally refer to the price charged in conjunction with the registration and/or acceptance of a subscription offer. In some embodiments, the subscription price may be equal to the sum of the full prices of the products indicated by the subscription offer. In other embodiments, the subscription price may be less than the sum of the full prices of the products indicated by the subscription offer. In such embodiments, subscription offers would provide customers with the ability to purchase the products at a discount relative to the total of the retail prices of all the purchased units. In yet other embodiments, such as “hard reserve” embodiments described herein, the subscription price may be more than the sum of the full prices of the products indicated by the subscription offer. A subscription price need not be fixed. For example, the amount a customer pays may not be in return for a fixed number of items. Also, the amount paid need not be known a priori. For example, the amount may be periodically charged in portions (e.g., once per week), and the amounts so charged need not be equal. In some embodiments, a third party may at least partially subsidize a subscription price.

As used herein, the terms “full price” and “retail price” may be used interchangeably and may generally refer to the normal price charged for the purchase of a given product (e.g., the price for which any customer may purchase a given product by inserting an equivalent monetary amount into the vending machine). Typically, subscription and/or package offers present customers with the opportunity to purchase items at less than full price and/or less than the total combined retail price of all subscription and/or package items.

As used herein, the term “redemption” may generally refer to the act, by a customer, of requesting, redeeming, and/or otherwise obtaining a unit of a product in accordance with and/or pursuant to a vending machine promotion and/or associated promotional message. Redemption may generally be performed via the vending machine and/or an associated device. In some embodiments, redemption may be accomplished by and/or associated with a “redemption transaction”. Redemption and/or a redemption transaction may generally comprise the process by which an account holder enters a code or identifier into an input device that is in communication with a vending machine control system, and receives one or more units of the product indicated by the underlying promotion. In some embodiments, codes may be entered directly by customers (e.g., into a keypad and/or via a fingerprint reader). In other embodiments, codes may be entered via voucher (e.g., a bar-coded voucher is deposited into a barcode reading bill validator). In some embodiments, a vending machine and/or computer associated therewith may determine whether or not certain account parameters are satisfied before honoring a request to redeem a unit of product from a vending machine.

As used herein, the terms “restock date” and “restock time” may generally refer, respectively, to the date and/or time that a vending machine is scheduled to be restocked by an operator (or agent thereof) of a vending machine. The time between restock dates may generally be referred to as a “sales period” or “fill period”. In some embodiments however, a sales period may otherwise be defined, e.g., such that multiple (and/or fractional) sales period may occur between restock dates.

As used herein, the terms “actual velocity” and “actual item velocity” may be used interchangeable to generally refer to the actual rate at which a given product is sold by a vending machine during a sales period.

Some embodiments herein are associated with an “ideal velocity”, an “ideal product velocity”, a “target product velocity”, and/or a “target velocity”. As used herein, the terms “ideal velocity”, “ideal product velocity”, “target product velocity”, and/or “target velocity” may be used interchangeably and may generally refer to a desired rate at which a given product should be sold by a vending machine during a sales period. Thus, in some embodiments, an ideal velocity may be set or calculated for each product indicating the rate at which products must be sold in order to deplete the inventory to a certain level by the end of a given sales period (e.g., by the restock time). For example, an ideal product velocity may be calculated by a vending machine control system after an operator inputs a restock date and a desired remaining inventory for the date (e.g., an operator may wish to have only one (1) of each item remaining at the restock date so that the machine sells as many items as possible without completely selling out and thereby disappointing customers). Thus, if an operator (i) stocks fifty (50) units of Soda A, (ii) inputs a restock date fourteen (14) days away, and (iii) indicates that only one (1) unit of Soda A should remain at the restock date, the control system may divide forty-nine (49; the number of units that are desired to be sold) by fourteen (14; the number of days until restock) to conclude that, on average, three and one half (3.5) units must be sold per day within the sales period in order to realize the ideal product velocity. As discussed herein, a vending machine control system may periodically, substantially continuously, or otherwise determine whether or not actual item velocity is at least equal to the ideal item velocity, and if not, may institute subscription offers and/or promotions as described herein.

As used here, an “entitlement”, a “benefit”, and/or a “prize” may generally refer to an incentive, bonus, and/or gift that is selected for a customer pursuant to a game-themed promotion. In some embodiments, a benefit is selected by a vending machine, a computer associated therewith (e.g., a server or controller), and/or an operator with the goal of increasing profitability (e.g., of a particular transaction, of overall vending machine expected profitability). In some embodiments, the benefit can be selected and then offered to a customer in accordance with a revenue or profit management rule so that revenue or profit may be increased. In some embodiments, a vending machine or computer associate therewith may output at least one benefit offer to a customer prior to, during or following a vending machine transaction, which may present the customer with an opportunity to accept and/or redeem one or more benefits. In some embodiments, a benefit may be categorized as either a product benefit or a general benefit.

A product benefit may include (i) a specific product that a customer may select, and/or (ii) an inventory group from which a customer may select one or more products (e.g., during a vending machine transaction). Inventory groups may be indicated and/or defined as specified in co-pending U.S. patent application Ser. No. 10/902,397, filed on Jul. 29, 2004, the entirety of which is incorporated herein by reference as part of the present disclosure. Alternatively, inventory groups may be indicated and/or defined as product categories (e.g., soda, candy, salty snacks, products from a particular manufacturer), products from particular rows, shelves or columns of a vending machine (e.g., row A1).

A general benefit may be a benefit other than a product benefit, and may comprise one or more of the following: (i) an immediately realizable credit toward or discount or “promotional price” for one or more products (or a group thereof, (ii) a refund of the purchase price (or portion thereof) of one or more previously selected products, (iii) a dynamically priced upsell, (iv) a fixed price upsell, (v) free or discounted alternate, non-food products (e.g., a phone card not typically sold during routine machine transactions), (vi) a sweepstakes or contest entry, (vii) a free or discounted vending machine “subscription” or “membership” account, (viii) an opportunity to procure additional benefits (e.g., a “free spin” of a “prize wheel” game-themed presentation), (ix) one or more additional product benefits (e.g., “bonus” products), (x) a coupon, (xi) a phone card, (xii) a package benefit, (xiii) a “multiplier” of some value (e.g., so that the customer may receive three times the number of outstanding units in his subscription account) and/or (x) any other entitlements.

Accordingly, in some embodiments, the prices and/or promotions of a vending machine may be dynamically constructed in a manner favorable to both consumers (who receive benefits as the result of entertaining game-themed presentations) and vending machine operators (who may experience increased profits).

As used here, a “dilution” may generally refer to the negative effect on profitability that may ensue when a product is sold for a price lower than a given customer otherwise would have paid for the product. In some embodiments, the potential for dilution is factored into stored revenue or profit management rules for determining benefit offers. Thus, in some embodiments, vending machines may be programmed to eliminate or reduce the effects of dilution by picking those benefit offers (e.g., products) that are less likely to result in dilution, or are more likely to result in less dilution.

As used here, a “diversion” may generally refer to the negative effect on profitability that ensues when a lower price or lower profit item is sold to a customer instead of a higher price or higher profit product that the customer otherwise may have purchased. In some embodiments, the potential for diversion is factored into stored revenue or profit management rules for constructing benefit offers. Thus, in some embodiments, vending machines may be programmed to eliminate or reduce the effects of diversion by picking those benefit offers that are less likely to result in diversion.

As used here, a “dynamically priced upsell” and/or a “dynamic upsell” may generally refer to an offer to a customer of a first product for the purchase of an additional product in exchange for an additional amount that is equal to an amount of change due back to the customer as a result of the customers purchase of the first product.

As used here, a “expected profitability” may generally refer to an anticipated profit amount associated with (i) a particular vending machine transaction, and/or (ii) a particular vending machine sales period (e.g., fill period). In some embodiments, calculating the expected profitability of one or more vending machine transactions involves a probability measure, which may estimate the likelihood that a vending machine may sell one or more product units over a period of time given, for example, one or more particular prices, benefits, entitlements, prizes, promotions, etc. In some embodiments, a probability measure may be estimated based on historic sales data. For example, if 20 days into a 30-day vending machine fill period, Snickers® has sold at an actual velocity of 1.5 units per day, it may be considered probable that Snickers® will continue to sell at the same velocity for the remainder of the fill period (10 days). Thus, if the margin of Snickers® is $0.20, a vending machine operator might expect that Snickers® sales would generate an additional $3.00 in profit before the fill period is over (1.5 units×10 days×$0.20).

As used here, a “fixed price upsell” may generally refer to an offer to a customer of a first product for the purchase of an additional product in exchange for an additional amount that is not necessarily correlated with an amount of change due back to the customer as a result of the customers purchase of the first product. In some embodiments, a customer who has purchased a first product and is thereby due change may be required to deposit additional currency in order to accept a fixed price upsell offer (which may have been output as a prize). Thus, the fixed price upsell offer may require that the customer pay an amount equal to his or her change due plus an additional amount of currency.

As used here, a “game-themed promotion” may generally refer to a presentation outputted to a customer via a vending machine output device (e.g., a touch-screen LCD, LED display, etc.). Game-themed presentations may be outputted for several purposes, including but not limited to (i) entertaining a customer, and/or (ii) offering a benefit to a customer (e.g., a game result is “You won a free Snickers® Bar”).

As used here, a “game result” and/or a “game outcome” may generally refer to a game-themed presentation may conclude (e.g., an animation sequence ends, physical reels stop spinning) by outputting a game result to a vending machine customer (e.g., via an input/output device). For example, as a “prize wheel” animation concludes (e.g., the wheel stops spinning), a determined benefit is presented to a customer (e.g., the wheel stops on “Pick any blinking green item!”). In some embodiments, a game result may comprise (i) at least one benefit offer, (ii) one or more benefit offers from which a customer may select at least one benefit, (iii) a marketing message (e.g., “Play again tomorrow!”), and/or (iv) any combination of the above. In some embodiments, a game result may be determined before a game-themed presentation is outputted. In other embodiments, a customer may influence a game result (e.g., by pressing a “stop” button during a “prize wheel” game, which determines, in whole or part, the particular benefit the customer may receive). In further embodiments, a game result may be determined before game-theme data is outputted, though a customer may have a perceived influence over a game result. In still further embodiments, a game result may be determined by a combination of skill (i.e. player influence) and profit management rules.

As used here, a “product data” may generally refer to information associated with the inventory of vending machine. Product data may be stored in a product database, which may be updated on a periodic, substantially continuous or event-triggered basis (e.g., after every transaction) so as to reflect changes to product data (e.g., resulting from sales, expiration, restocking). In some embodiments, product data may comprise (i) inventory quantity (e.g., n units of product x remain in the machine), (ii) cost data (e.g., the unit cost associated with one or more vending machine products), (iii) sales data (e.g., actual sales rate, ideal sales rate, etc., of one or more vending machine products), and/or (iv) fill period status (e.g., days remaining until the next restock date). In this manner, product data may be retrieved for the purpose of facilitating the profit management of a vending machine.

As used here, an “income contribution factor” may generally refer to a measure of the revenue or profit realized due to the sale of a particular product. In some embodiments, a product's income contribution factor may be defined by the total amount of revenue or the total amount of profit generated by the product during a certain time period (e.g., during a fill period, between certain dates, every twenty four hours). In other embodiments, a product's income contribution factor may be represented as a percentage, such as that which may be calculated by dividing the amount of profit generated by the product in a certain period of time by the total amount of profit generated by some or all products sold through the vending machine in the time period. For example, if a vending machine realized $100 in total profit during a fill period, and a certain product was responsible for generating $12 of the profit, that product's income contribution factor could be represented as the percentage ‘12%’. In some embodiments, an income contribution factor may be used for the purpose of determining how to allocate a product to one or more inventory groups.

As used here, an “inventory group” may generally refer to a set of products. An inventory group may include a single product, or more than one product. In many embodiments, a customer may select a component product from an inventory group. In certain proactive inventory grouping embodiments, pursuant to a package offer, customers may select at least two component products, a component product selected from each of at least two inventory groups, for a single price. In reactive inventory grouping embodiments, pursuant to a package offer, customers may select a second component product from an inventory group that is revealed after a first component product is selected from a first inventory group. In one or more embodiments, inventory groups may be communicated to customers through colored LEDs located proximately to inventoried products (e.g., products in a “red” group may be communicated via proximately located red LEDs; products in a “green” group may be communicated via proximately located green LEDs). In proactive and reactive inventory grouping embodiments, inventory groups may be “reactively? Automatically?” determined by a vending machine control system during a sales period. In other embodiments, inventory groups are not determined reactively? Automatically? (as in proactive or reactive inventory grouping embodiments), but are rather determined prior to a sales period by an operator or other person, and are stored (e.g., as rules in a database) accessible to a vending machine control system.

III. Systems and Apparatus

A. Introduction

Generally, according to one or more embodiments, a vending machine may comprise a device, or communicate with a device (e.g., a server, a peripheral device, and/or a peripheral device server), configured to manage sales transactions with customers by, among other things, receiving payment from customers, controlling the pricing and/or distribution (dispensing) of goods, controlling entitlements to services, displaying jackpot amounts, determining jackpot amounts, determining winners of displayed jackpot amounts, providing game-themed promotions, and/or providing jackpot amounts to customers.

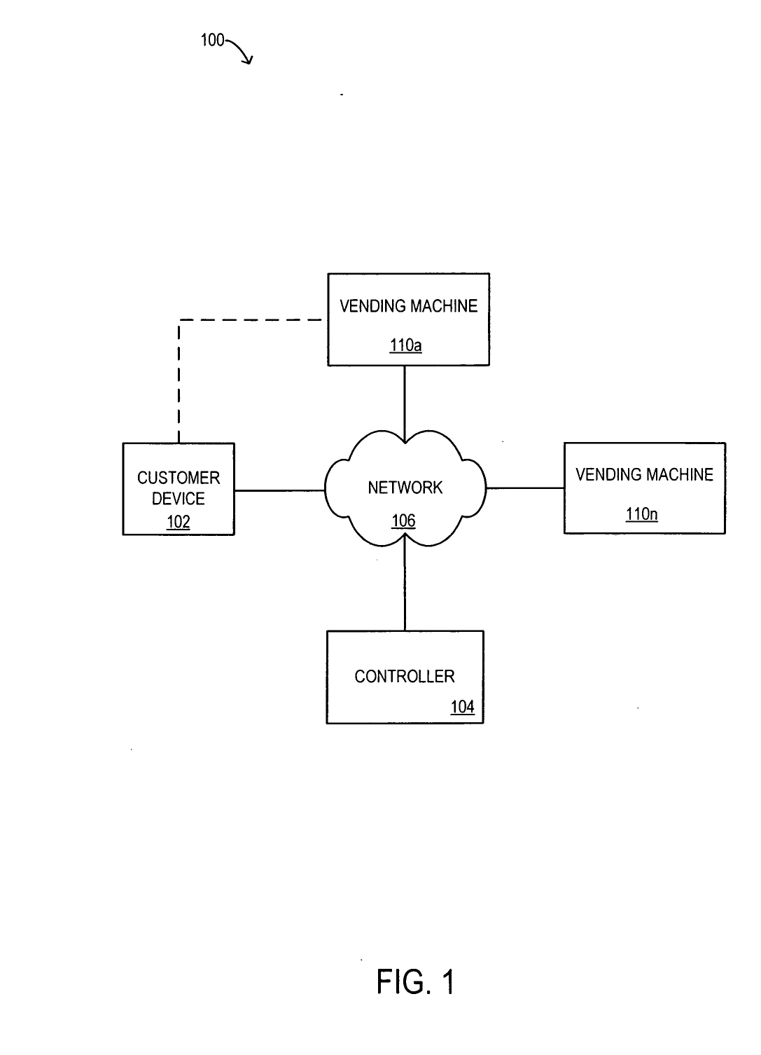

Referring first to FIG. 1, a block diagram of a system 100 according to some embodiments is shown. The system 100 may comprise, for example, a customer device 102 and/or a controller 104 in communication (e.g., via a network 106) with one or more vending machines 110a-n. This communication may generally be established by and/or facilitated via a vending machine 110a-n (although it should be understood that in some embodiments, other and/or additional devices may be utilized to establish and/or facilitate the communication, such as a kiosk, Automatic Teller Machine (ATM), etc.). Either or both of the customer device 102 and the controller 104 may communicate directly with and/or be coupled directly to a vending machine 110a-n. In some embodiments, either or both of the customer device 102 and the controller 104 may otherwise communicate with one or more of the vending machines 110a-n, such as via the network 106. The network 106 may comprise any type and/or configuration of network that is or becomes known or practicable. The network 106 may comprise, for example, any number of wired and/or wireless networks.

According to some embodiments, the customer device 102 may be utilized by a customer (not shown) to communicate with the vending machines 110a-n to (i) purchase a product, (ii) establish an account (e.g., in response to an offer from the vending machine 110), (iii) redeem a product, (iv) and/or manage an account. The controller 104 may, according to some embodiments, be utilized to communicate with the vending machine 110 (and/or other devices associated therewith that are not explicitly shown in FIG. 1) to establish accounts (e.g., on behalf of and/or for one or more customers), to manage accounts, such as by defining, editing, and/or selecting account rules and/or parameters, and/or by monitoring, updating, and/or checking account transactions and/or balances, and/or by determining and/or transmitting promotional messages (e.g., via e-mail to the customer).

In some embodiments, the customer device 102 may comprise a PC, laptop, PDA, and/or wireless or cellular telephone. The customer device 102 may, for example, comprise a Bluetooth®-enabled cellular telephone. In such embodiments, the vending machines 110a-n may detect and/or actively solicit the customer device 102 with an offer to purchase a subscription (e.g., instead of and/or in addition to displaying messages via the vending machines 110a-n). The network 106 may generally comprise any practicable and/or desirable type and/or configuration of network, such as the Internet. The controller 104 may generally comprise any type of network device such as a PC and/or a server that is operable to communicate with the vending machines 110a-n and/or with the customer device 102. The controller 104 may, for example, be owned and/or operated by and/or otherwise associated with an individual and/or entity that desires to establish, maintain, and/or manage customer accounts and/or that is associated with providing promotional messages and/or e-mails to customers.

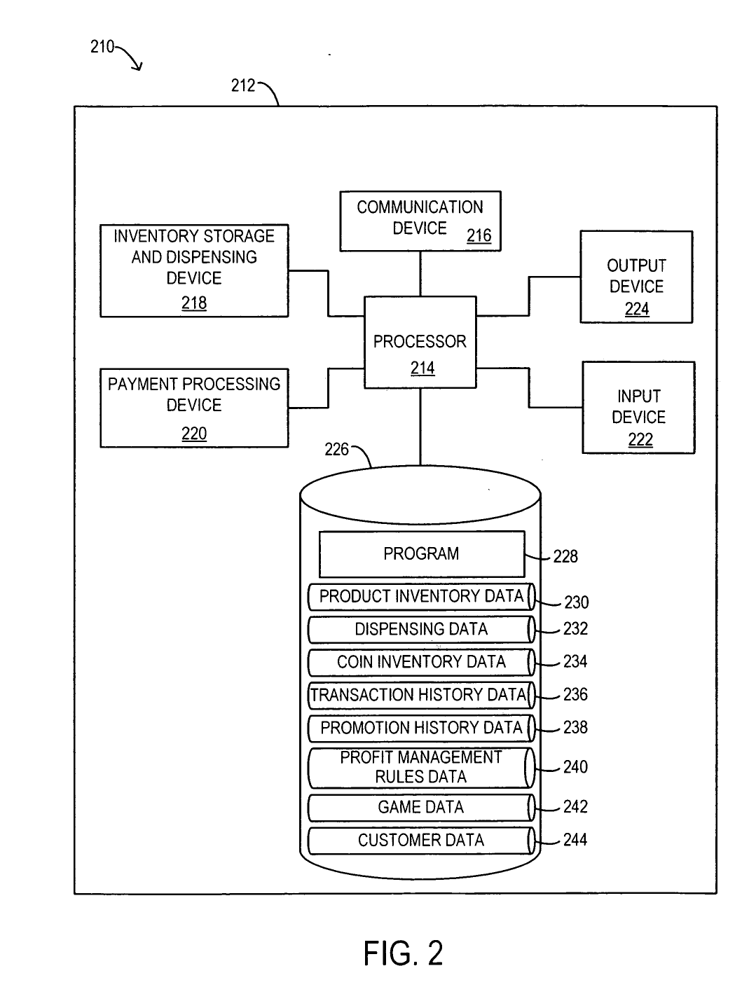

Turning now to FIG. 2, a block diagram of a vending machine 210 according to some embodiments is shown. In some embodiments, the vending machine 210 may be similar in configuration and/or functionality to the vending machines 110a-n of FIG. 1. The vending machine 210 may comprise, for example, a casing 212 enclosing one or more of a processor 214, a communications device 216, an inventory and dispensing device 218, a payment processing device 220, an input device 222, an output device 224, and/or a data storage device 226. According to some embodiments, the vending machine 210 may be configured to perform and/or facilitate processes in accordance with embodiments described herein. The vending machine 210 may, for example, be utilized to offer benefits in exchange for customer e-mail addresses, receive customer e-mail addresses, transmit promotional messages via e-mail to customers, dispense products, and/or manage customer accounts.

B. Casing/Cabinetry

In some embodiments, a suitable casing 212 and/or cabinetry may be constructed from any suitable material, including but not limited to any combination of (1) commercial grade sixteen-gauge steel (e.g., for exterior panels and internal shelving), (2) transparent materials such as glass or Plexiglas (e.g., for product display windows), (3) rubber (e.g., for waterproofing insulation), (4) plastic, and/or (5) aluminum.

Many commercially available casings 212 may be adapted to work in accordance with various embodiments. For example, in snack machine embodiments, a suitable casing 212 may comprise the “129 SnackShop” manufactured by Automatic Products International, Ltd. of Saint Paul, Minn., which stands at seventy-two inches (72″/1829 mm) wide, has a width of thirty-eight and seven eighths inches (38⅞″/988 mm), and a depth of thirty-five inches (35″/889 mm). Other suitable snack machine casings 112 include the A La Carte® machine from Automatic Products, and the GPL SnackVendor model #159 from Crane Merchandising Systems/Crane Co. of Stamford, Conn.

In beverage machine embodiments, casings 212 commercially available from Dixie Narco, Inc. of Williston, S.C. may be employed. Beverage machine casings 212 may comprise a “cooler” or “glass front” style front panel, featuring a transparent front panel (e.g., glass) enabling customers to see inventory for sale. Alternatively, beverage machine casings 212 may comprise a “bubble front” style front panel, featuring a decorative front panel, typically used to advertise a logo of a product manufacturer commercially interested in the operation of the vending machine 210.

Other embodiments are contemplated as well, including combination snack and beverage vending machine embodiments, such as those available from Crain Co. Further details concerning the suitability of machine casings 212 and/or cabinetry are well known in the art, and need not be described in further detail herein.

C. Processor/Controller

According to some embodiments, the vending machine 210 may include the processor 214 that may be or include any type, quantity, and/or configuration of processor that is or becomes known. The processor 214 may comprise, for example, an Intel® IXP 2800 network processor or an Intel® XEON™ Processor coupled with an Intel® E7501 chipset. In some embodiments, the processor 214 may comprise multiple inter-connected processors, microprocessors, and/or micro-engines. According to some embodiments, the processor 214 may include or be coupled to one or more clocks or timers (not explicitly shown) and to the communication device 216 through which the processor 214 may communicate, in accordance with some embodiments, with other devices such as one or more peripheral devices, one or more servers, and/or one or more user devices (such as the customer device 102 and/or the controller 104, both of FIG. 1). The communication device 216 may, for example, comprise any type or configuration of communication port, cable, modem, and/or signal transceiver that is or becomes known or practicable.

In some embodiments, the processor 214 may also or alternatively be in communication with and/or coupled to any number of other components of the vending machine 210 such as the inventory and dispensing mechanism 218, the payment processing mechanism 220, the input device 222, the output device 224, and/or the data storage device 226.

D. Inventory Storage and Dispensing Device

In some embodiments, the vending machine 210 may comprise the inventory storage and dispensing device 218. The inventory storage and dispensing device 218 may, according to some embodiments, comprise any number and/or configuration of devices and/or components that facilitate and/or are associated with the storage and/or dispensing of products or services available via the vending machine 210. Product inventory storage and product dispensing functions of the vending machine 210 configured in accordance with a snack machine embodiment may include, for example, one or more of: (i) a drive motor, (ii) metal shelves, (iii) a product delivery system (e.g., a chute, product tray, and/or product tray door), (iv) dual spiral (e.g., double helix) item dispensing rods, (v) convertible (e.g., extendable) shelves, and/or (vi) a refrigeration unit. In embodiments using the casing 212 of the “model 129 SnackShop” manufactured by Automatic Products, three (3) removable shelves may be employed, together providing for thirty (30) product rows and an inventory capacity of between one hundred and eighty-five (185) to five hundred and twenty-two (522) commonly vended snack products.

Inventory storage and distribution functions of the vending machine 210 configured in accordance with a beverage machine embodiment may include one or more conventional components, including: (i) metal and/or plastic shelving, (ii) product dispensing actuators/motors, (iii) product delivery chutes, and/or (iv) a refrigeration unit.

In many types of beverage and snack vending machines, operators will typically stock several units of the same product linearly arranged in a column, allowing individual units to be dispensed upon command. The same product may be stocked in more than one column. Similarly, more than one product may be stocked in a single column. In the case that one or more services are available via the vending machine 210, the inventory storage and dispensing device 218 may comprise any device or component that is associated with the storage, transmission, encoding or decoding (e.g., including encryption and decryption), and/or other processing, routing, or electronic delivery or redemption of such services.

Further details concerning vending machine inventory storage and dispensing devices 218 are well known in the art, and need not be described in further detail herein.

E. Payment Processing Device

According to some embodiments, the vending machine 210 may comprise the payment processing device 220. The payment processing device 220 may, according to some embodiments, comprise any number and/or configuration of devices and/or components for receiving payment and/or dispensing change, including a coin acceptor, a bill validator, a card reader (e.g., a magnetic stripe reader), and/or a change dispenser.

In some embodiments, a magnetic stripe card reader may read data on a magnetic stripe of a credit or debit card, for example, and it may cooperate with conventional POS credit card processing equipment to validate card-based purchases through a conventional transaction authorization network. Suitable card-based transaction processing systems and methods are available from USA Technologies, Inc.™ of Wayne, Pa. In some embodiments, a coin acceptor, bill validator and/or change dispenser may communicate with and/or be coupled to a currency storage apparatus (a “hopper”; not shown) and may comprise conventional devices such as models AE-2400, MC5000, TRC200 by Mars, Inc.™ of West Chester, Pa., or CoinCo™ model 9300-L.

Coin acceptors and/or bill validators may receive and validate currency that is stored by the currency storage apparatus. Further, a bill validator or coin acceptor may be capable of monitoring stored currency and maintaining a running total of the stored currency, as is discussed with reference to U.S. Pat. No. 4,587,984, entitled “Coin Tube Monitor Means”, the payment and coin-related aspects of which are incorporated by reference herein. According to some embodiments, a change dispenser activates the return of coinage to the customer where appropriate (e.g., where a customer rejects or otherwise fails to accept a promotional offer). Such apparatus may feature Multidrop Bus (MDB) and/or Micromech peripheral capabilities, as are known in the art.

In another embodiment, the vending machine 210 may be configured to receive payment authorization and/or product selection commands or signals through a wireless device communication network (e.g., via the communication device 216), directly or indirectly, from a customer device (e.g., a cellular telephone, not shown; the customer device 102 and/or the third party device 104, both of FIG. 1). In such an embodiment, the payment processing device 220 may comprise a cellular transceiver operatively connected to the processor 214 to receive, transmit, and/or process such signals. Systems and methods allowing for the selection of and payment for vending machine products via cellular telephones are provided by USA Technologies, Inc.™. Further, in such an embodiment, a customer cellular telephone may serve as an input device 222 and/or an output device 224, as described elsewhere herein.

Further details concerning vending machine payment processing devices 220 are well known in the art, and need not be described in further detail herein.

F. Input and Output Devices

According to some embodiments, the vending machine 210 may comprise the input device 222 and/or the output device 224. In some embodiments, the input device 222 may be operable to receive input from (i) a customer indicating a product and/or offer selection (e.g., an offer for a benefit such as a free product in exchange for an e-mail address provided by the customer), from (ii) an operator (or agent thereof during stocking or maintenance of the vending machine 210, and/or from (iii) a customer, controller, and/or third party desiring to establish and/or manage a customer account. Also, the output device may be configured for outputting product and/or offer information (such as jackpot information) to a customer, operator, and/or third party.

Many combinations of input devices 222 and output devices 224 may be employed according to various embodiments. In some embodiments, the vending machine 210 may include more than one input device 222. For example, the vending machine 210 may include an exterior input device 222 for receiving customer input and an interior input device 222 (neither shown separately) for receiving operator input. In some embodiments, the input device 222 may provide the dual functionality of receiving input data from both operators and customers (and/or third parties). Likewise, a vending machine may comprise more than one output device 224 (e.g., an LCD screen and several LED devices, as described herein). In some embodiments, such as those which feature touch screens (described elsewhere herein), the functionality of both input devices 222 and output devices 224 may be provided by a single device.

Many input devices 222 are contemplated. Thus, an input device 222 may comprise one or more of the following: (i) a set of alpha-numeric keys for providing input to the vending machine, such as the Programmable Master Menu® Keypad, (ii) a selector dial, (iii) a set of buttons associated with a respective set of item dispensers, (iv) a motion sensor, (v) a barcode reader (e.g., a 1-D or 2-D barcode reader), (vi) a voice recognition module, (vii) a Dual-Tone Multi-Frequency receiver/decoder, (viii) a wireless device (e.g., a cellular receiver; a radio-frequency receiver; an infrared receiver; a wireless access point or wireless router; other wireless devices), (ix) a smart card reader, (x) a magnetic stripe reader, (xi) a biometric identification apparatus (e.g., an iris scanner, a retinal scanner, a facial recognition device, a thumbprint reader, etc.), (xii) a customer device, and/or (xiii) any other type or configuration of input device 222 that may be or become known or practicable.

In some embodiments, an input device 222 may comprise an optical reader (e.g., a 2-D bar code scanner) capable of scanning a barcode, such as a bar code which is displayed on a screen or monitor of a user's cellular phone, PDA, Blackberry® business phone, Blackberry® handheld or other handheld device. One system employing such technology, the Cmode® service, has been developed by a partnership between Coca-Cola® Co. and NTT DoCoMo™ Inc. of Japan. According to some embodiments, the input device 222 may comprise a fingerprint (e.g., and/or thumbprint) reader such as a Fujitsu MBF200 Scanner, which is manufactured by Tacoma Technology, Inc of Taipai, Taiwan and Fujitsu® Microelectronics America, Inc. of Tokyo, Japan. The Fujitsu® MBF200 offers a resolution of five hundred dots per inch (500 dpi), an image capture area of 12.8×15 mm (0.5″×0.6″), and a unit size of 60×40×15 mm (2.4″×1.6″×0.6″). The Fujitsu® MBF200 may communicate with a vending machine processor 214 through any practicable interface such as a USB interface. The Fujitsu® MBF200 may be desirable in an embodiment where the vending machine processor 214 is instructed through a Linux-based operating system. In embodiments featuring the Fujitsu® MBF200, fingerprint-matching software may be employed. Exemplary fingerprint matching software may include, for example, VeriFinger™ 4.2 from Neurotechnologija, Ltd. of Vilnius, Lithuania.

In some embodiments, a suitable fingerprint reader for use as an input device 222 may include the AF-S2 FingerLoc™ from AuthenTec®, Inc. of Melbourne, Fla. The AF-S2 FingerLoc™ offers a resolution of two hundred and fifty dots per inch (250 dpi), an image capture area of 13×13 mm (0.51″×0.51″), and a unit size of 24×24×3.5 mm (0.94″×0.94″×0.14″). The AF-S2 FingerLoc™ may communicate with a vending machine processor through any practicable interface such as a USB interface. The AF-S2 FingerLoc™ may be desirable in an embodiment where the vending machine processor 214 is instructed through a Microsoft® Windows®-based operating system. In embodiments featuring the AF-S2 FingerLoc™, fingerprint matching software may be employed. Exemplary fingerprint matching software may include, for example, VeriFinger™ 4.2 from Neurotechnologija, Ltd. of Vilnius, Lithuania.

Likewise, many types of output devices 224 are contemplated. For example, an output device may comprise an LCD screen or device. Alternatively or additionally, the output device 224 may comprise one or more LED displays or devices (e.g., several alphanumeric multi-color or single color LED displays on the shelves of a vending machine associated proximately with each row of product inventory).

In one embodiment, an LED display screen is mounted atop and/or on the vending machine (via bolts or other mounting hardware) and is used to communicate offers and other messages (e.g., product advertisements, such as package deals and/or subscription offers or promotions) to prospective customers. A suitable LED display screen for such an embodiment may be housed in an aluminum case having a length of approximately twenty-seven and one half inches (27.5″/698.5 mm), a height of approximately four and one quarter inches (4.25″/107.95 mm), and a depth of approximately one and three quarter inches (1.75″/44.5 mm). Such a display screen may have a display area capable of showing about thirteen (13) alphanumeric and/or graphical characters. Further, such an LED display screen may comprise a serial computer interface, such as an RJ45/RS232 connector, for communicating with the processor 214. Further still, such an LED display may be capable of outputting text and graphics in several colors (e.g., red, yellow, green, black) regarding current and upcoming promotions.

Further, in some embodiments, the output device 224 may comprise a printer. In one embodiment, a printer may be configured to print on card stock paper of approximately one hundredth of an inch or less (e.g., 0.01″/0.15 mm or less) in thickness, such as the EPSON EU-T400 Series Kiosk Printer. Further, a printer may be capable of thermal line printing of various alphanumeric and graphical symbols in various font sizes (e.g., ranging from nine (9) to twenty-four (24) point) on various types of paper. Additionally, such a printer may communicate with the processor 114 via an RS232/IEEE 12834 and/or bi-directional parallel connection. Such a printer may further comprise a data buffer of various practicable sizes, such as approximately four kilobytes (4 KB). In some embodiments, the printer may be operable to output codes and/or identifiers (e.g., by printing vouchers) to customers and/or to print stickers, labels, and/or other indications to be attached to products vended by the vending machine 210. The output device 224 may also comprise a device operable to attach and/or print indications of access codes onto one or more products of the vending machine 210 (e.g., as the products are loaded by an operator, while the products are shelved within the vending machine 210, and/or as the products are dispensed—such as a hopper printing and/or coupling mechanism). According to some embodiments, the output device 224 may also or alternatively comprise an audio module, such as an audio speaker, that outputs information to customers audibly.

As stated, in some embodiments, a touch-sensitive screen may be employed to perform both input device 222 and output device 224 functions. Suitable, commercially available touch screens for use according to various embodiments are manufactured by Elo TouchSystems, Inc., of Fremont, Calif., such as Elo's AccuTouch series touch screens. Such touch screens may comprise: (i) a first (e.g., outer-most) hard-surface screen layer coated with an anti-glare finish, (ii) a second screen layer coated with a transparent-conductive coating, and/or (iii) a third screen layer comprising a glass substrate with a uniform-conductive coating. Further, such touch screens may be configured to detect input within a determined positional accuracy, such as a standard deviation of error less than plus or minus eight hundredths of an inch (±0.08″/2 mm). The sensitivity resolution of such touch screens may be more than one hundred thousand touchpoints per square inch (100,000 touchpoints/in²/15,500 touchpoints/cm²) for a thirteen inch (13″) touch screen. For such touch screens, the touch activation force required to trigger an input signal to the processor 214 via the touch screen may typically be around two to four ounces (2-4 ounces/57-113 g). Additionally, touch screens for use according to various embodiments may be resistant to environmental stressors such as water, humidity, chemicals, electrostatic energy, and the like. These and other operational details of touch screens (e.g., drive current, signal current, capacitance, open circuit resistance, and closed circuit resistance) are well known in the art and need not be described further herein.

In some embodiments, input and/or output functionality of the vending machine 210 may be facilitated through a wireless device configured to send data to, and/or receive data from, a customer device (e.g., the customer device 102 of FIG. 1), such as a laptop computer or a cellular telephone. In some embodiments, such a wireless device may comprise a sensor that detects signals from a customer device. Such signals may include but are not limited to radio frequency signals and/or IR signals. Thus, in one or more embodiments, a wireless input device 222 may comprise a WAP or router configured to operate in accordance with an IEEE 802.11 standard, including the 802.11b and 802.11g standards, which transmit at 2.4 GHz, or the 802.11a standard, which transmits at 5 GHz. Such a wireless input device 222 may, in some embodiments, have the capability to “frequency hop” between radio frequencies so as to reduce interference and/or increase security. Encryption techniques may also or alternatively be employed to increase the security of transmissions. Suitable WAPs are available from Belkin™ Corporation of Compton, Calif. and Cisco™ Systems, Inc. of San Jose, Calif. The wireless input device 222 may, in some embodiments, be used to establish a communication link (such as a first communication link with a customer device) as described herein.

Additionally, in some embodiments, an output device 224 may comprise an audio module, such as an audio speaker, that outputs information to customers audibly. Speakers may comprise conventional speakers and/or modern hypersonic speakers. An output device 224 may include, for example, unidirectional and/or hypersonic speakers which can selectively focus sound to particular locations or customers, while not disturbing others who are not in the location of the focused sound.

Such speakers may comprise, for example, one or more HSS Model H450 speakers produced by American Technology Corporation™ of San Diego, Calif., specifications for which may be found at http://www.atcsd.com/hss.html, the unidirectional and/or hypersonic speaker concepts and descriptions of which are hereby incorporated by reference herein.

In some embodiments, the output device 224 may comprise a physical device having a game theme, such as a spinning “prize wheel” similar to those featured on the television game show Wheel of Fortune™ or The Price is Right™, a roulette wheel, mechanical slot machine reels, or the like. Such a wheel may communicate to customers various information. For example, the wheel may spin and stop on an icon that represents, e.g., a prize entitlement. A physical wheel in the general appearance of the wheel on the Wheel of Fortune™ game show may be attached to a vending machine. A slot machine reel may be comprised of various outcome symbols, such that, when the reel stops spinning, one or more spay lines' identifies one or more game results, benefits, promotions, etc.

Also or in addition to a wheel, another output device 224 that is a peripheral device attached to and in communication with the vending machine 210 may communicate game-related information. By utilizing such an output device 224, vending machines 210 may be retrofitted with a separate device to employ game-themed promotions. The use of removable peripheral devices may be important in certain situations (e.g., where doorways to interior locations are low), as such satellite devices may be removed during transport and attached once vending machines are brought to the intended location. Likewise, such peripheral devices may be side-mounted, where the ceiling height may impair other location of the peripheral. Further, the use of a separate device is advantageous in that it may be in communication with more than one vending machine 210, allowing many vending machines 210 to participate in game-themed vending promotions.

G. Data Storage/Memory

The data storage device 226 may include any appropriate combination of magnetic, optical and/or semiconductor memory, and may include, for example, additional processors, communication ports, RAM, Read-Only Memory (ROM), a compact disc and/or a hard disk. The processor 214 and the storage device 226 may each be, for example: (i) located entirely within a single computer or other computing device; or (ii) connected to each other by a remote communication medium, such as a serial port cable, a Local Area Network (LAN), a telephone line, RF transceiver, a fiber optic connection and/or the like. In some embodiments for example, the vending machine 210 may comprise one or more computers (or processors 214) that are connected to a remote server computer (e.g., via the communication device 216) operative to maintain databases, where the data storage device 226 is comprised of the combination of the remote server computer and the associated databases.

The data storage device 226 may generally store one or more programs 228 for controlling the processor 214. The processor 214 may perform instructions of the program 228, for example, and thereby operate in accordance with some embodiments, and particularly in accordance with the methods described in detail herein. According to some embodiments, the program 228 may comprise any number or type of programs that are or becomes known or practicable. In some embodiments, the program 228 may be developed using an object oriented programming language that allows the modeling of complex systems with modular objects to create abstractions that are representative of real world, physical objects and their interrelationships. However, it would be understood by one of ordinary skill in the art that the embodiments described herein can be implemented in many different ways using a wide range of programming techniques as well as general purpose hardware systems or dedicated controllers.

The program 228 may be stored in a compressed, un-compiled and/or encrypted format. The program 228 furthermore may include program elements that may be generally useful, such as an operating system, a database management system and/or device drivers for allowing the processor 214 to interface with computer peripheral devices and/or the various components of the vending machine 210. Appropriate general purpose program elements are known to those skilled in the art, and need not be described in detail herein.

Further, the program 228 may be operative to execute a number of invention-specific objects, modules and/or subroutines which may include (but are not limited to) one or more subroutines to determine whether a promotion should be output; one or more subroutines to determine a promotion type; one or more subroutines to populate a promotion type (such as a subscription offer or promotion), thereby constructing a promotion instance; one or more subroutines to select a constructed promotion instance from a plurality of hypothetical promotion instances; one or more subroutines to determine an expected value of a promotion being considered for output; one or more subroutines to determine how and/or when products should be dispensed from the vending machine 210; one or more subroutines to determine and/or provide codes redeemable for products; one or more subroutines to provide management access to customer accounts (e.g., to customers and/or third parties); one or more subroutines to provide and/or facilitate the sale and/or management of customer accounts; and/or one or more subroutines to determine and/or transmit promotional messages (e.g., via e-mail) to customers. Examples of some of these subroutines and their operation are detailed with respect to the processes described herein.

The program 228 may also or alternatively direct the processor 214 (possibly in conjunction with one or more peripherals or other devices) to operate with “preprogrammed intelligence”, such as “Artificial Intelligence” (AI). Among possible intelligent abilities attributed to a vending machine 210 may be the ability to recognize people by voice or image, the ability to understand spoken language, the ability to understand written language, the ability to synthesize spoken language, the ability to compose text, the ability to compose motivational text (such as promotional messages advertising products available at the vending machine), the ability to recognize patterns in human purchasing behavior, the ability to sense external “foot traffic” (i.e., people passing by), and the ability to transmit messages to a targeted group of people on a network (e.g., e-mail transmitted messages to particular customers).

According to some embodiments, the instructions of the program 228 may be read into a main memory (not explicitly shown) of the processor 214 from another computer-readable medium (such as the data storage device 226), like from a ROM to a RAM. Execution of sequences of the instructions in the program 228 may cause the processor 214 to perform the process steps described herein. In alternative embodiments, hard-wired circuitry or integrated circuits may be used in place of, or in combination with, software instructions for implementation of the processes described herein. Thus, some embodiments are not limited to any specific combination of hardware, firmware, and/or software.

In addition to the program 228, the data storage device 226 may also be operative to store one or more databases, files, and/or tables, containing information such as (i) product inventory data 230, (ii) dispensing data 232, (iii) coin inventory data 234, (iv) transaction history data 236, (v) promotion history data 238, (vi) profit management rules data 240, (vii) game data 242, and/or (viii) customer data 244 (e.g., which may include account data such as one or more e-mail addresses associated with a customer). Any number of other arrangements may be employed besides those suggested by the tables shown. For example, even though eight separate data tables, stores, files, and/or databases are illustrated, embodiments may be practiced effectively using fewer or more functionally equivalent databases or similar structures. These databases and/or other databases (not shown) may also or alternatively store information associated specifically with jackpots, games, and/or other entertainment-related promotions. Game outcomes, jackpot values and/or amounts, progressive jackpot contribution amounts, and/or other metrics may, for example, be stored to facilitate the providing of game-themed promotions such as vending machine jackpots via the vending machine 210.

Further, despite the depiction of the data as tables, an object-based model could be used to store and manipulate the data types and likewise, object methods or behaviors can be used to implement the processes described herein.

H. Vending Machine Retrofitting

In some embodiments, one or more of the processor 214, the input device 222, the output device 224, and the data storage device 226 may be included, wholly or partially, in a separate device (e.g., separate from and/or external to the casing 212; not shown), such as the e-Port™ by USA Technologies Inc., that may be in communication with the vending machine 210. The separate devices may also or alternatively be in communication with a network such as the Internet (e.g., via the communication device 216).

The e-Port™ is a credit and smart card-accepting unit that controls access to office and MDB vending equipment, and serves as a point of purchase credit card transaction device. The e-Port™ includes an LCD that allows for the display of color graphics, and a touch sensitive input device (touch screen) that allows users to input data to the device. The display may be used to prompt users interactively with, e.g., offers and information about their transaction status.

The separate device may alternatively be a programmed computer running appropriate software for performing various functions described herein. The separate device may be operable to receive input from customers, receive input from third parties, receive payment from customers, exchange information with a remotely located server (e.g., an ISP server, a VoIP service provider's server) and/or display or transmit messages to customers (e.g., promotional messages and/or offers). The separate device may be operable to instruct the vending machine that appropriate payment has been received (e.g., via a credit card read by the separate device), that a particular product or products should be dispensed by the vending machine, and/or how and/or when those products should be dispensed (e.g., to avoid product collisions and/or other complications). Further, a separate device may be operable to instruct the vending machine to execute and/or offer customer accounts, game-themed promotions, display jackpot amounts, effectuate price changes, or the like.

Thus, a separate device may be operatively connected to a vending machine 210 to perform various processes and steps described herein including the displaying of jackpot amounts and the providing of game-themed date in conjunction therewith. In this manner, conventional vending machines may be retrofitted with such separate devices so as to perform the processes described herein.

I. Other Separate Devices

It should be noted that, in some embodiments, some or all of the functions and method steps described herein may be performed partially or entirely by one or more separate devices (not explicitly shown), which are not necessarily retrofitted to a vending machine 210. Separate devices for use with such an embodiment include, but are not limited to, kiosks and customer devices (PDA devices, laptop computers, and cellular telephones). In some embodiments featuring separate devices, such devices may be capable of communicating, directly (e.g., via Bluetoot® connectivity) or indirectly (e.g., through a web server or IVRU), to a vending machine control system in order to facilitate the inventive functionality described herein. In some embodiments featuring separate devices, such separate devices are capable of communicating with a remote computer.

J. Network Embodiments

Network environments may include a remotely located device or computer (e.g., a server, mainframe, or other device) that is in communication, via a communications network (such as the network 106 of FIG. 1), with one or more vending machines 210 and/or customer devices. Such a configuration may facilitate third party management of customer accounts and/or transmission of promotional e-mail messages as described herein.

The remote device or computer may communicate with the vending machines 210, customer devices, and/or third party devices, and the vending machines 210 may communicate with each other, directly or indirectly, via a wide variety of wired and/or wireless means, mediums, protocols and communications standards. Some, but not all, possible communication links and networks that may comprise the network or be otherwise part of the system include but are not limited to: PSTN links, satellite links, cellular links, optical links, infrared links, radio frequency links, and/or Cable TV links. Various networking configurations, standards and protocols may be employed, including but not limited to: IP addressing via the Internet, a local area network (LAN), a wireless LAN, a wide area network (WAN), Ethernet (or IEEE 802.3), Token Ring, SAP, ATP, Bluetooth™, TCP/IP and/or via any appropriate combination thereof. Communication may be encrypted to ensure privacy and prevent fraud in any of a variety of ways well known in the art.

Vending machines 210 may comprise computers, such as those based on the Intel® Pentium® or Centrino™ processor, that are adapted to communicate with the remote device or computer. Any number and type of machines may be in communication with the remote device or computer.

Those skilled in the art will understand that vending machines 210, devices and/or computers in communication with each other need not be continually transmitting to each other. On the contrary, such vending machines, devices and/or computers need only transmit to each other as necessary, and may actually refrain from exchanging data most of the time. For example, a vending machine in communication with another machine via the Internet may not transmit data to the other machine for weeks at a time.

In some embodiments, the remote device or computer may be accessible, directly or indirectly, via a separate device (such as a customer device and/or third party device) by a customer, operator, and/or third party. Accordingly, a customer, operator, and/or third party may use a device to communicate with the remote computer. A separate device may receive from the remote computer messages described herein as being output by the vending machine 210 (e.g., subscription codes), and/or may transmit to the remote computer input described herein as being provided to the vending machine 210 (e.g., e-mail addresses). Thus, various data described herein as received through an input device of a vending machine 210 may be received by the vending machine 210 from a separate device (e.g., through a Bluetooth® connection) or from a remote computer (which may relay data first received from a customer device such as a personal computer). Similarly, various data described herein as received through an input device 222 of a vending machine 210 may be received through a Web browser communicating with a remote server, which in turn communicates with the vending machine 210.

K. External Appearance

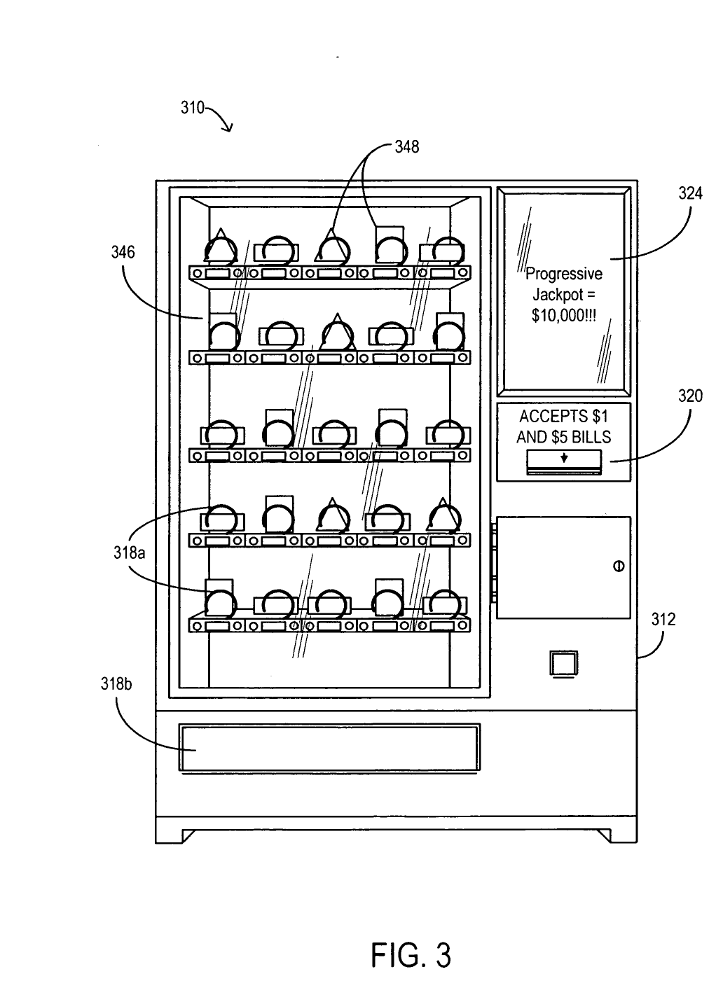

Referring to FIG. 3, a diagram illustrating an example of the external appearance of a vending machine 310 according to some embodiments is shown. In some embodiments, the exemplary vending machine 310 may be similar in configuration and/or functionality to the vending machines 110, 210 described in conjunction with any of FIG. 1 and/or FIG. 2. The exemplary vending machine 310 may comprise, for example, (i) a cabinet 312, (ii) an inventory dispensing mechanism 318a-b (comprising a product storage mechanism 318a and/or a product hopper 318b), (iii) a payment processing mechanism 320, (iii) an output device 324 (e.g., for outputting text and/or graphical information about promotions such as game-themed promotions and/or jackpot amounts), and (iv) a product display window 346 behind which are visible the products 348 available for sale from the vending machine 310 and the product storage mechanism 318a that holds the products within the vending machine 310. According to some embodiments, the components 312, 318, 320, 324, 346 of the vending machine 310 may be similar in configuration and/or functionality to the similarly named and/or numbered components described in conjunction with FIG. 2 herein.

The casing 312 may, fore example, comprise any type or configuration of cabinetry or enclosure to at least partially house components of the vending machine 310. As described elsewhere herein, for example, the casing 312 may be constructed of steel, aluminum, plastic, rubber, other metals or composite materials, and/or any combinations thereof. In some embodiments, the casing 312 may be configured for the sale of various products or services such as a typical and/or modified version of a typical snack, beverage, dessert, meal, non-edible object, media, and/or any other vending machine 310. According to some embodiments, the inventory dispensing mechanism 318a-b may comprise various component such as the product storage mechanism 318a and/or the product hopper 318b). The product storage mechanism 318a may, for example, comprise a number of latches, levers, paddles, doors, spirals, and/or other product retention, detention, and/or dispensing mechanisms, as are known in the art.

According to some embodiments, a product selected and/or purchased by a customer may be released by the product storage mechanism 318a so that it falls into the product hopper 318b. The product hopper 318b may, according to some embodiments, comprise one or more doors, holes, and/or other means via which a customer may retrieve a dispensed product. The product hopper 318b may also or alternatively comprise one or more components to facilitate prevention of unauthorized product removal (e.g., from someone reaching up into the vending machine 310 via the product hopper 318b) and/or to facilitate the reduction of impact forces experienced by products dropping from the product storage mechanism 318b above.

In some embodiments, the payment processing mechanism 320 may comprise any practicable type of payment receiving, transmitting, and/or processing device that is or becomes known (such as those described elsewhere herein). The payment processing mechanism 320 may, for example, comprise a currency validator and/or input slot, such as shown in FIG. 3. According to some embodiments, the output device 324 may display various information associated with offers and/or promotions and/or product or service sales to a customer. As shown in FIG. 3, for example, the output device 324 may comprise a display screen (and/or touch screen) that advertises the availability of a progressive jackpot. The particular information shown in FIG. 3, for example, indicates that a ten thousand dollar ($10,000) progressive jackpot is available. Such a jackpot may be available to customers that purchase products, subscription customers, etc. The “progressive” nature of the jackpot may, in some embodiments, indicate that the jackpot increases for every non-winning entry (e.g., a transaction). According to some embodiments, the “progressiveness” of the jackpot may be extended throughout and/or take into account a plurality of networked vending machines and/or sales or transactions thereof.

L. Software Architecture

In some embodiments, a control system may execute instructions for managing the operation of a vending machine (such as the vending machines 110, 210, 310 of FIG. 1, FIG. 2, and FIG. 3, respectively), and in particular in accordance with various embodiments described herein. Such vending machine functions include, but are not limited to: (1) product pricing (e.g., displaying prices via an LED and/or changing such prices where appropriate), (2) processing vending transactions by (i) receiving customer selections via an input device (such as product and/or offer selections), (ii) processing payment via a payment processing mechanism, (iii) actuating corresponding product dispensing mechanisms, (3) selecting promotional messages or promotion types and constructing promotion offer instances, (4) outputting promotional messages and/or offers to customers via output devices (including display of graphics/content, such as game-themed content, on LCD and LED displays), (5) recording transaction information (inventory levels, acceptance rates for promotions, etc.), (6) facilitating customer and/or third party account management, (7) receiving customer e-mail addresses, (8) transmitting promotional messages to the customer e-mail addresses, (9) receiving redemption codes, and/or (10) automatically recharging a funded account by utilizing a customer credit card.

In some embodiments, machine components (e.g., machine hardware, including mechanical hardware such as input devices, output devices, product dispensing devices, and payment processing devices including coin acceptors, bill validators, card readers, and/or change dispensers) may be controlled by the control system through a standard RS-232 serial interface. In such embodiments, embedded Application Programming Interface (API) devices or modules may be used to enable software to actuate and/or control vending machine components via RS-232 connectivity. Such vending machine components may be operatively connected to the control system directly or indirectly, in any manner that is practicable. Alternatively, machine components may communicate with the control system through a USB standard (e.g., USB ports may allow “plug-and-play” installation of machine components).

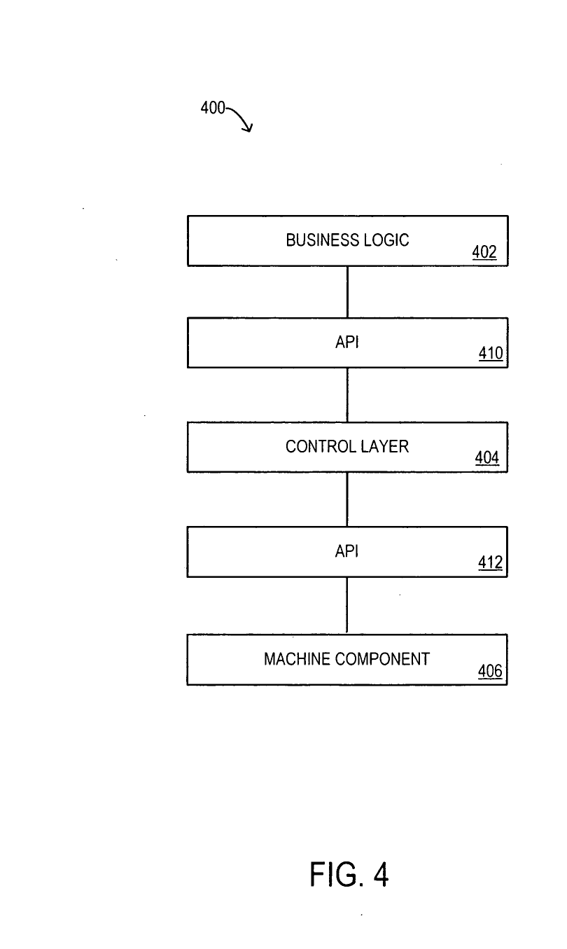

Referring now to FIG. 4, a block diagram of a system 400 according to some embodiments, is shown. The system 400 may, for example, comprise and/or represent an exemplary portion of control software that may be utilized to implement some embodiments. The system 400 illustrates, for example, control software as being divided into three abstract components. Such division may provide a clear partition of tasks, which may be desirable so that any future modification and new programming can be applied without disrupting other components. The three abstract components illustrated include a Business Logic software component 402, a Control Layer software component 404, and an exemplary Machine Components software component 406. As stated earlier, more machine components may be employed in addition to the exemplary one illustrated herein.

The software components are each connected to one another via a respective API 410, 412. As is known in the art, an API 40, 412 may comprise a set of routines, protocols, and/or tools for building software applications. The Business Logic software component 402 may, according to some embodiments, be connected to the Control Layer software component 404 via an API 410. Similarly, the Control Layer software component 404 may be connected to the Machine Component software component 406 via another API 412.

The Business Logic software component 402 visually represents the portion of the software that selects promotions or promotion type instances and/or constructs promotion instances and/or promotional messages, as discussed herein. Such a component may, for example, access a rules database and a product inventory database to perform such functions.

The Control Layer software component 404 visually represents the portion of the software which interfaces with at least one Machine Component software component 406, and thereby transmits commands to perform such functions as: (i) outputting e-mail-for-benefit offer information via an output device (e.g., a machine component), (ii) dispensing products via a product dispensing mechanism (e.g., a machine component), (iii) dispensing change due to a customer via a payment processing mechanism, which may include a change dispenser and a currency storage apparatus (e.g., several machine components), and/or (iv) providing game-themed information such as jackpot amounts.

The Machine Component software component 406 generally represents software or machine hardware, including mechanical hardware such as input devices, output devices, inventory dispensing devices, and payment processing devices including coin acceptors, bill validators, card readers, change dispensers, etc.

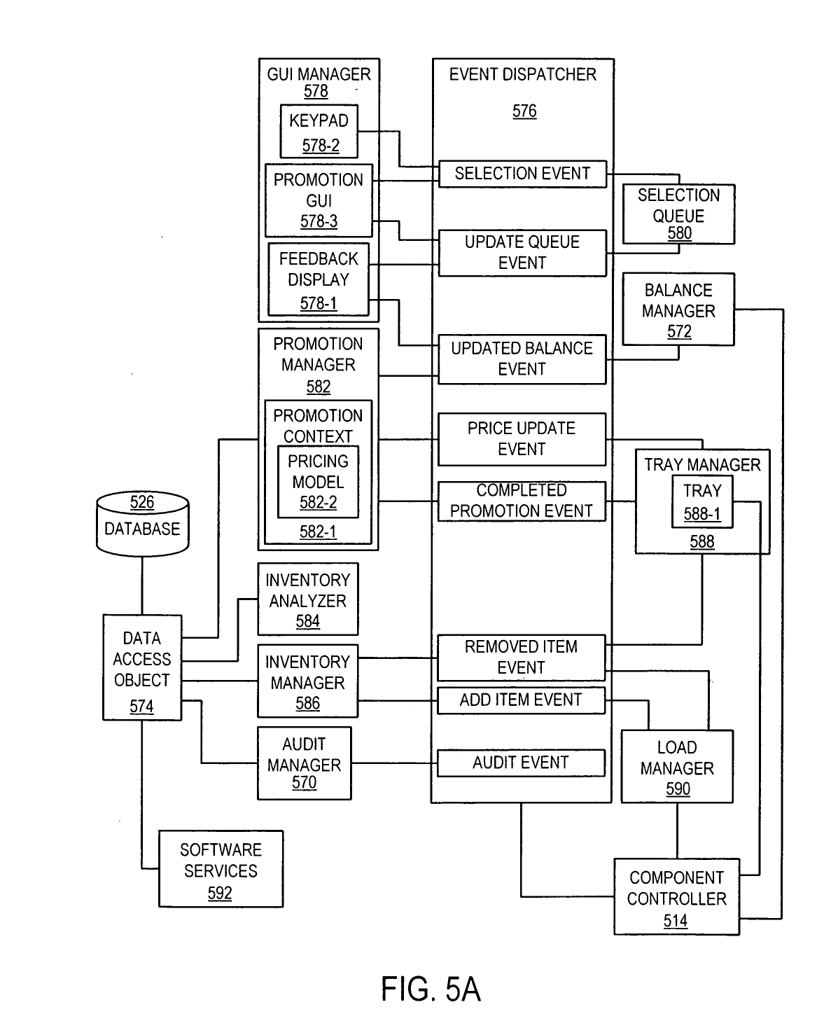

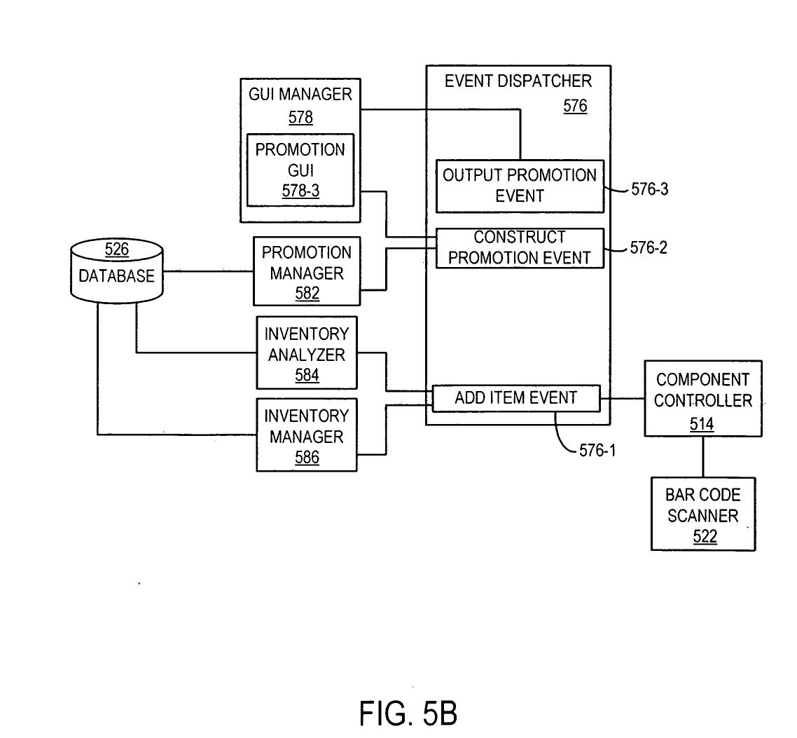

Referring now to FIG. 5A, a schematic block diagram of an exemplary configuration of software architecture 500 according to some embodiments is shown. It should be noted, however, that many architectural configurations are possible to carry out the inventive processes described herein. The software architecture 500 is a model of a software application for use in execution of embodiments described herein, designed using Unified Modeling Language™ (UML™). The model comprises various software components and illustrates how the various software components may interact with one another.

According to some embodiments, the software architecture 500 may comprise a component controller 514 and/or a database 526. The component controller 514 may manage (and mask the implementation of) vending machine components. Examples of vending machine components include: input devices, output devices, coin acceptors, bill validators, card readers, change dispensers, product dispensing mechanisms, and bar code readers. In some embodiments, the component controller 514 may be similar in configuration and/or functionality to the processor 214 described in conjunction with FIG. 2. The database 526 may comprise a persistence store (e.g., MySQL, file based, and/or Oracle®). The database 526 may, for example, be similar in configuration and/or functionality to the data storage device 226 described in conjunction with FIG. 2.

In some embodiments, an audit manager 570 listens for audit events fired by other management components and acts on them by persisting meaningful state about the event to audit data structures. This function journals all significant events, transactions, and other meaningful system operations so that they can be used in subsequent analysis and reporting functions. The definition of “meaningful state” can potentially be specified through configuration management. The event/configuration driven approach provides flexibility if auditing/reporting requirements change.

According to some embodiments, a balance manager 572 represents the current monetary balance in the machine. It interacts with the component controller 514 and responds to money insertion by incrementing its balance value. It fires UpdatedBalance events whenever the balance changes. It listens for DrainBalance events and executes processes of the component controller 514 that return funds to the user.

In some embodiments, a data access object 574 may be the layer of abstraction that is responsible for persisting domain objects such as inventory objects and audit data. The data access object 574 may, for example, be in communication with the database 526 and/or one or more other data stores (not shown).

According to some embodiments, an event dispatcher 576 acts as a proxy broker for events so that components do not need to explicitly listen to each other (e.g., have undue knowledge of each other by reference). Some examples of events that may be managed by this component, and that are shown in FIG. 5A, include: a SelectionEvent event, an UpdatedQueueEvent event, an UpdatedBalanceEvent event, a TrayLEDUpdateEvent event, a CompletedPromotionEvent event, a DispensedItemEvent event, an AuditEvent event, and/or an EnterOperatorModeEvent event.

In some embodiments, a Graphical User Interface (GUI) manager 578 is a container for all GUI components and/or sub-components and defines their layout in reference to one another. The GUI manager 578 will also listen for events from the event dispatcher 576. Swing events may be handled by the individual sub-components 578-1, 578-2, 578-3 of the GUI manager 578. According to some embodiments, the sub-components may comprise a feedback display 578-1, a keypad 578-2, and/or a promotion GUI 578-3. The feedback display 578-1 is a sub-component that manages feedback from the keypad 578-2, instructions, and error messages.

The keypad 578-2 is a sub-component that represents the keypad data entry interface (rendered as Swing graphical objects on a touch screen LCD). It forces selection events to be fired that are relevant to the feedback display 578-1 and a selection queue 580.

The promotion GUI 578-3 is a sub-component that represents promotion-related user interface rendering such as graphical selection menus, banners, animation, etc. The promotion GUI 578-2 fires events that can affect the selection queue 580 and listens for events from a promotion manager 582. The selection queue 580 is a container for cumulative product selections made during the course of user interaction with a promotional offer and/or promotion. The promotion manager 582 manages the entire promotional offer and/or promotion-related business rules in play in a vending machine. It can manage multiple promotional offer and/or promotion contexts simultaneously and executes all rules related to validation, execution, and workflow related to these subscription offer or promotion contexts. This component implements a promotional offer or promotion context factory object that encapsulates business rule logic related to promotional offer and/or promotion eligibility, selection, pricing and composition.

In some embodiments, the promotion manager 582 may comprise, define, and/or manage one or more components such as a promotion context 582-1 and/or a pricing model 582-2. The promotion context 582-1 may comprise all of the state and workflow rules required by the promotion manager 582 to execute a given promotional offer and/or promotion. The pricing model 582-2 may, according to some embodiments, be a sub-component of the promotion context 582-1. The pricing model 582-2 may, for example, contain all the product pricing data needed to execute the promotional offer and/or promotion described by that context.

According to some embodiments, an inventory analyzer 584 performs derivation and aggregation computations on inventory state and audit data. The results of these computations are persisted for use by other components (e.g., the promotion manager 582). The computation functions may be initiated on demand or by a scheduler service when the system is dormant.

In some embodiments, an inventory manager 586 maintains the current state of the machine's inventory. It listens for events that will ask it to update the inventory that was fired by components such as a tray manager 588 and a load manager 590. The tray manager 588 is the container and manager of composite tray components. It is responsible for initiating and coordinating multiple-product dispense operations. According to some embodiments, the tray manager 588 may be a module and/or device that operates and/or manages a tray 588-1. The tray 588-1 may, for example, be a sub-component of the tray manager 588 and/or may represents a product dispensing apparatus and its composite rows/slots in the vending machine. Its responsibilities include dispensing products and displaying LED data through the component controller 514.

According to some embodiments, a load manager 590 manages the inventory load processes. It may interact with a bar code scanner via the component controller 514, such as when an operator restocks the machine's inventory. The load manager 590 may also or alternatively fire inventory change events. Examples of load processors and/or devices are described in commonly owned and co-pending U.S. patent application Ser. No. 10/951,296 entitled “METHODS AND APPARATUS FOR DEFINING AND UTILIZING PRODUCT LOCATION IN A VENDING MACHINE” and filed on Sep. 27, 2004, the load management concepts and descriptions of which are incorporated by reference herein.

In some embodiments, a software service 592 may provide miscellaneous application services, including (but not limited to): account management, configuration management, connection pooling, diagnostic logging, and/or scheduling services.

Referring now to FIG. 5B, a schematic block diagram of another exemplary configuration of the software architecture 500 according to some embodiments is shown. The configuration of the software architecture 500 shown in FIG. 5B is a model of a software application for use in some embodiments, designed using UML™. The software architecture 500 may comprise various software components and one or more hardware components. For example, the software architecture 500 may comprise a component controller 514, a barcode scanner 522, a database 526, an event dispatcher 576, a GUI manager 578, a promotion manager 582, an inventory analyzer 584, and/or an inventory manager 586. According to some embodiments, the components 514, 520, 526, 576, 578, 582, 584, 586 of the software architecture 500 may be similar to the similarly named and/or numbered components described in conjunction with any of FIG. 1 and/or FIG. 5A herein.

In some embodiments, the event dispatcher 576 may include and/or define three (or more) exemplary events. The events may comprise, for example, an AddItem event 576-1, a ConstructPromotion event 576-2, and/or an OutputPromotion event 576-3. According to some embodiments, some or all of the events 576-1, 576-2, 576-3 may be triggered by an addition of a product to a vending machine.

As shown in FIG. 5B, the component controller 514 may be in communication with a particular vending machine component such as the bar code scanner 522. In some embodiments, the bar code scanner 522 may be similar in configuration and/or functionality to the input device 122 described in conjunction with FIG. 1. The bar code scanner 522 may, for example, be a particular type of input device 122 (i.e., one that is operable to scan barcodes). In some embodiments, the component controller 514 may be in communication with fewer or more components (such as input devices 122 and/or output devices 124) than are shown in FIG. 5B.

In some embodiments, when an operator of the vending machine adds a product to the inventory of the vending machine, the operator may scan a bar code of the product (e.g., using the bar code scanner 522). The component controller 514 communicates the input of the bar code scanner 522 to the event dispatcher 576, which recognizes the input of the bar code scanner 522 as an AddItem event 576-1. As described above, the event dispatcher 576 may act as a proxy broker for events, alleviating the need for components to listen for events from other components. Thus, the event dispatcher 576 may communicate the AddItem event 576-1 to the inventory manager 586, without the need for inventory manager 582 to listen for events from the component controller 514. The inventory manager 582, in turn, may cause a record of the added item and/or of the AddItem event 576-1 to be stored in the database 526 (e.g., via the data access object 574 from FIG. 5A, which is not illustrated in FIG. 5B for purposes of simplicity).

The inventory analyzer 584, in turn, may analyze the current inventory (e.g., based on the addition of the product or based on another event, such as the occurrence of a predetermined time) and store an indication of a need for a promotional offer and/or promotion for two (2) or more products based on the current state of the inventory. The indication may be stored in database 526. The promotion manager 582 may, according to some embodiments, access the database 526 and determine the need for a promotional offer and/or promotion. The promotion manager 582 may then, for example, construct a promotional offer and/or promotion, based on the need. The event dispatcher 576 may determine the occurrence of the ConstructPromotion event 576-2 and communicate the occurrence of this event to the GUI manager 578. The GUI manager 578 may, in turn, cause the promotional offer to be displayed via a promotion GUI 578-1 sub-component. The promotion GUI sub-component 578-1 and/or the GUI manager 578 may then, for example, construct the OutputPromotion event 576-3. The event dispatcher 576 may, according to some embodiments, detect the OutputPromotion event 576-3 and communicate the occurrence of this event to another component (e.g., promotion manager 582) and thus, indirectly, cause a record of the output of the promotional offer to be stored in the database 526.

IV. Processes

The systems and devices described herein, including the hardware components and the databases, are useful to perform various methods pursuant to some embodiments. However, it should be understood that not all of the above described components and databases are necessary to perform any particular method. In fact, in some embodiments, none of the above-described systems and/or devices may be required to practice one or more of the methods described herein. The systems and/or devices described herein are examples that may possibly be useful in practicing some or all of the embodiments described herein.

Further, the flow diagrams described herein do not necessarily imply a fixed order to the actions, and embodiments may be performed in any order that is practicable. Note that any of the methods described herein may be performed by hardware, software (including microcode), firmware, or any combination thereof. For example, a storage medium may store thereon instructions that when executed by a machine result in performance according to any of the embodiments described herein.

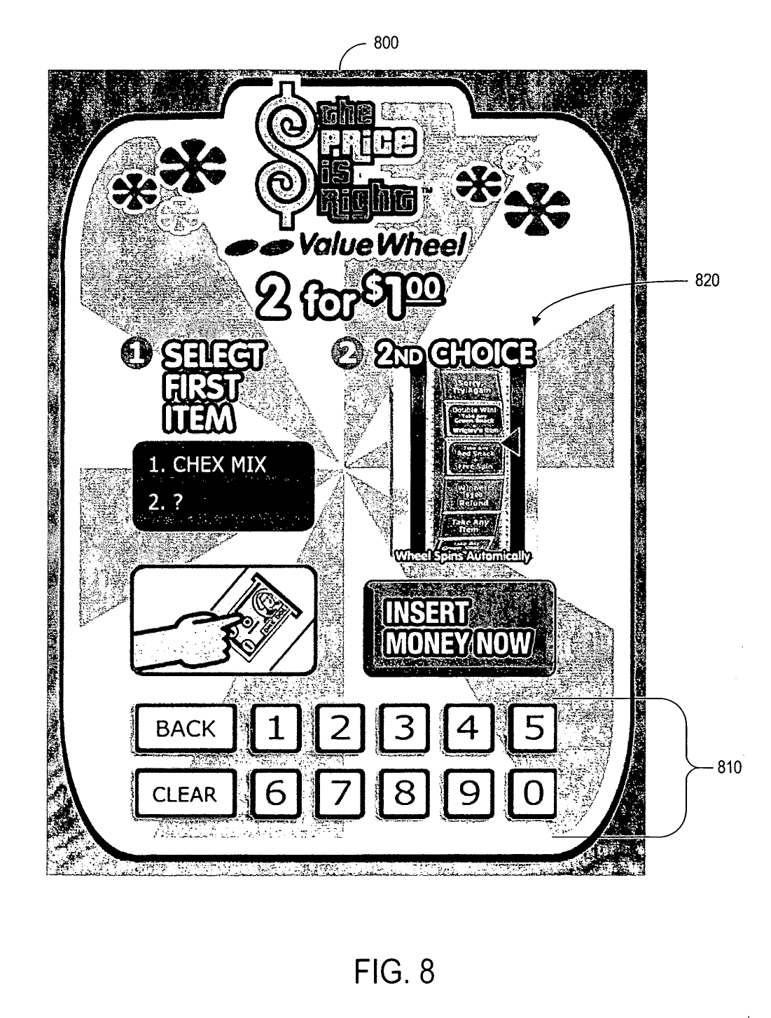

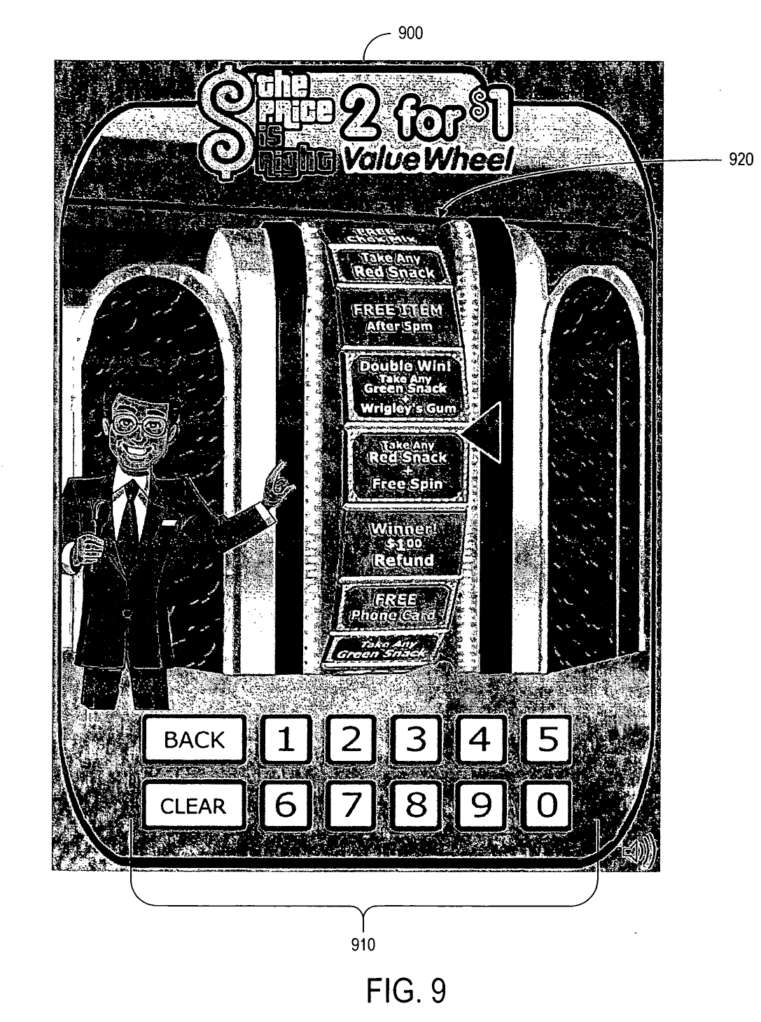

Various embodiments are characterized by different sets of steps. For example, in some embodiments (certain “product entitlement” embodiments), a customer purchasing a “package deal” selects a first product (a component product), and is then entitled to select at least one additional component product to form the package. In such embodiments, the vending machine may determine and display to a customer, in conjunction with a presentation having a game theme, an offer for a benefit. The offer may specify (i) a particular additional component product to be provided to the customer, (ii) an inventory group from which the customer may select at least one additional component product, and/or (iii) one or more general benefits that may be offered in addition to a product. The offer for the benefit may be determined based on product data and/or stored profit management rules. Example displays which may be presented during such an embodiment (e.g., via touch screen) are depicted in FIG. 8 and FIG. 9, each with reference to customer directions and customer input buttons.

As an example of such a “product entitlement” embodiment, a customer may deposit $1.00 into a “2-for-$1” package vending machine (e.g., two products in a package that sells for one dollar). The customer selects a first component product of the package (e.g., Doritos® tortilla chips), and then a vending machine control system can (i) access data about products available for sale by the vending machine (“product data”) (such data indicating, e.g., number available, prices, costs, expiration dates), (ii) determine (e.g., based on stored profit management rules and the accessed data) to output a offer for a benefit, which comprises a specific inventory group (set of products) from which one additional component product may be selected (e.g., by the customer, by the vending machine), (iii) output a game-themed presentation that indicates the offer for the benefit (e.g., on a display device, an animated “prize wheel” that spins and stops on a game result such as “Take any blinking green item as your second product!”, on another output device), and (iv) provide the benefit (e.g., by receiving the customer's selection of a Milky Way® candy bar—under which a green LED had been actuated to blink and dispensing the bag of Doritos® tortilla chips and Milky Way® candy bar).

In such an embodiment, the benefit to the customer may be in allowing that customer to select (i) from a wider variety of products, and/or (ii) a product at a discount that, if sold for its retail price, would have required the customer to deposit more money. For example, in a 2-for-1 purchase wherein the sum of the retail prices of each product is more than $1.00, the customer can be provided with a product benefit in allowing the customer to obtain “better” or more expensive products than otherwise possible (i.e., if the products were sold for their retail prices).

Accordingly, during vending machine transactions wherein customers are entitled to receive at least one component product of a package deal (i.e., a product benefit), various processes disclosed herein may function to (i) establish increased customer loyalty and goodwill (e.g., by entertaining customers, by providing them with benefits of higher perceived value, and/or by constructing package deals that typically result in net savings), and/or (ii) result in increased profits for vending machine operators (e.g., as benefit offers are determined based on profit management rules pursuant to a profit goal).

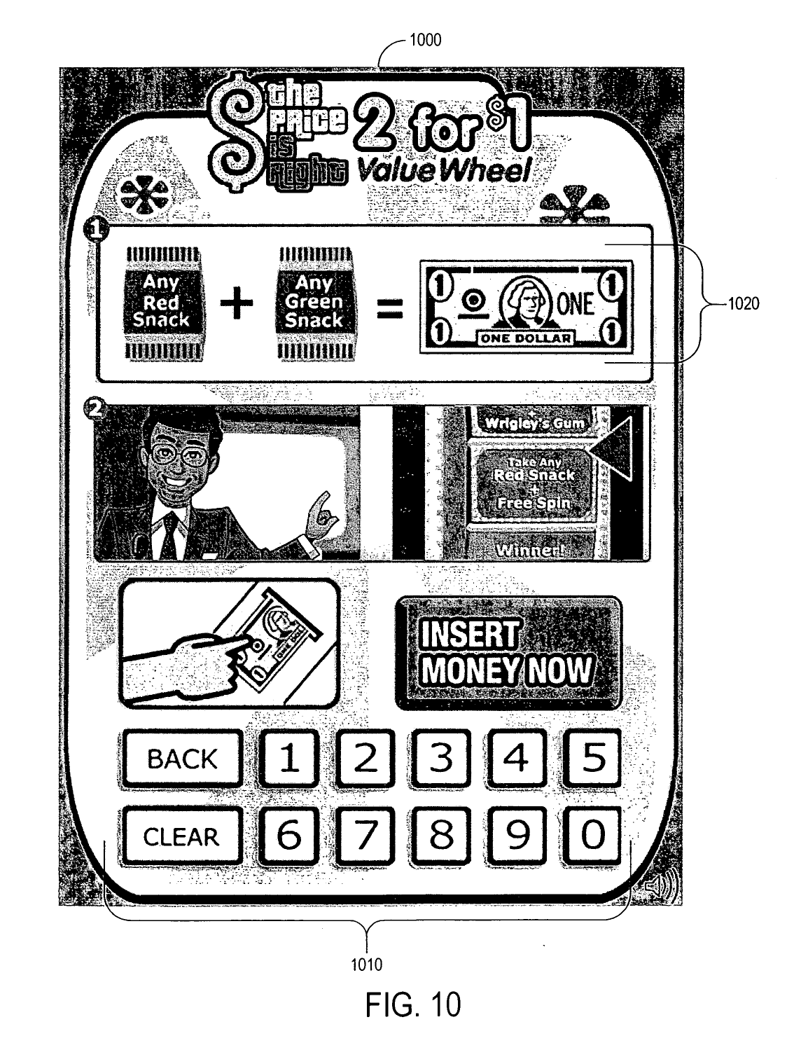

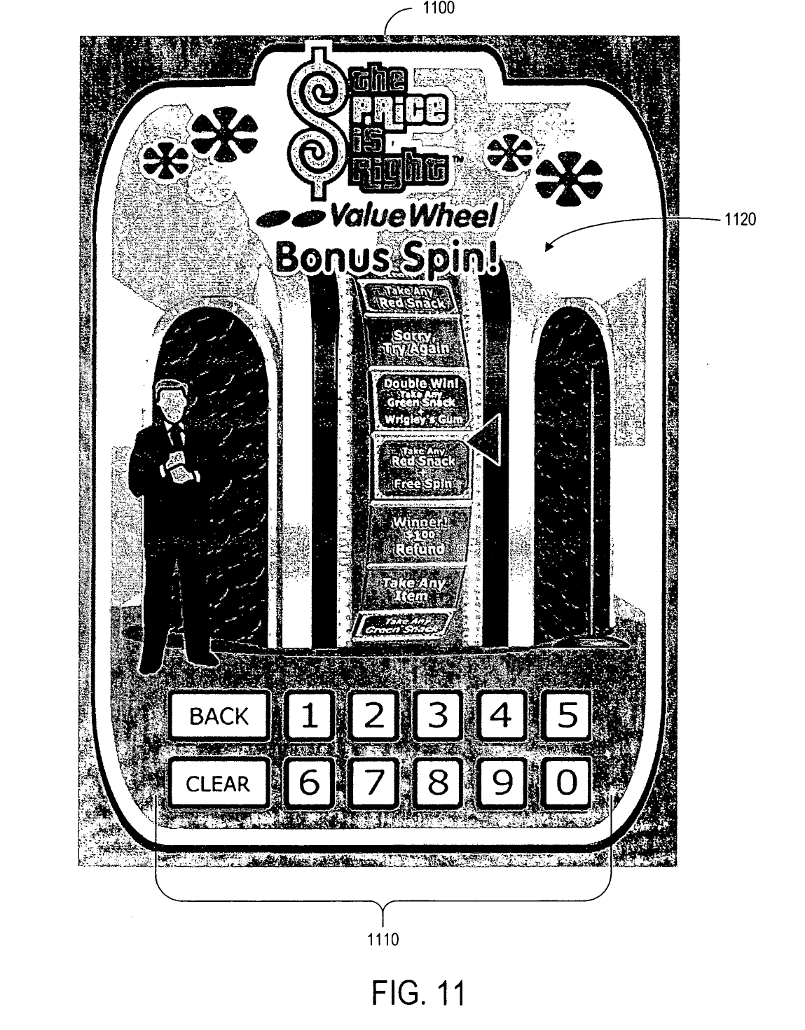

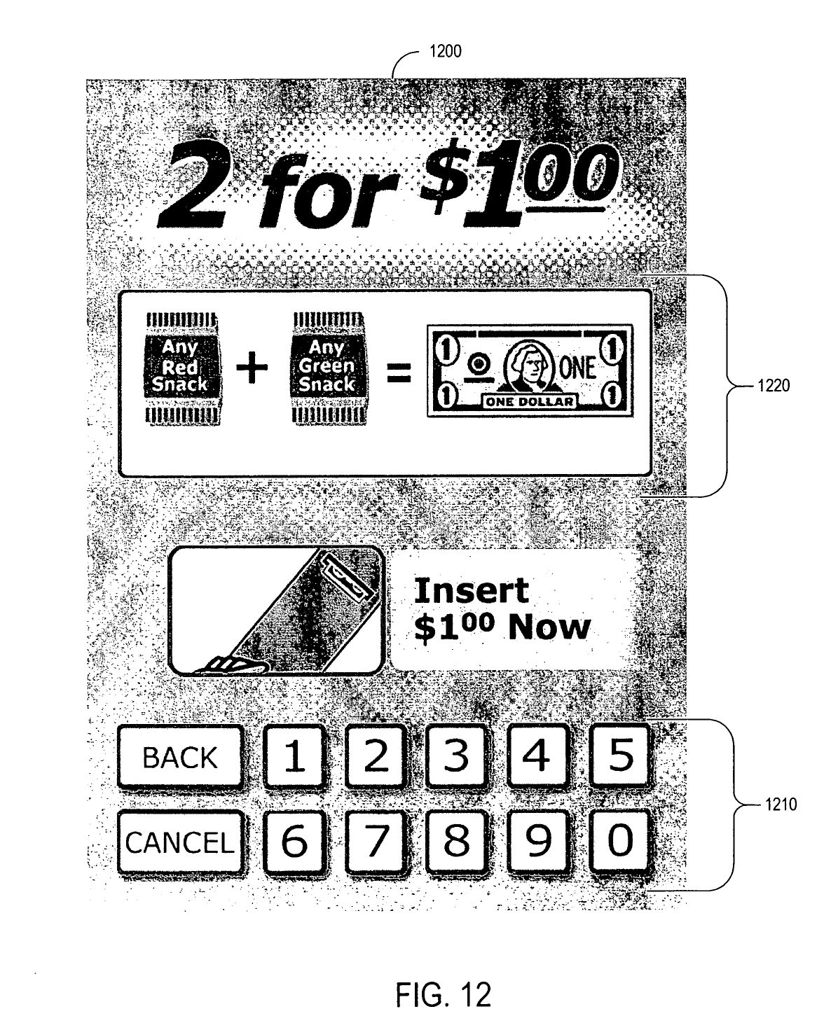

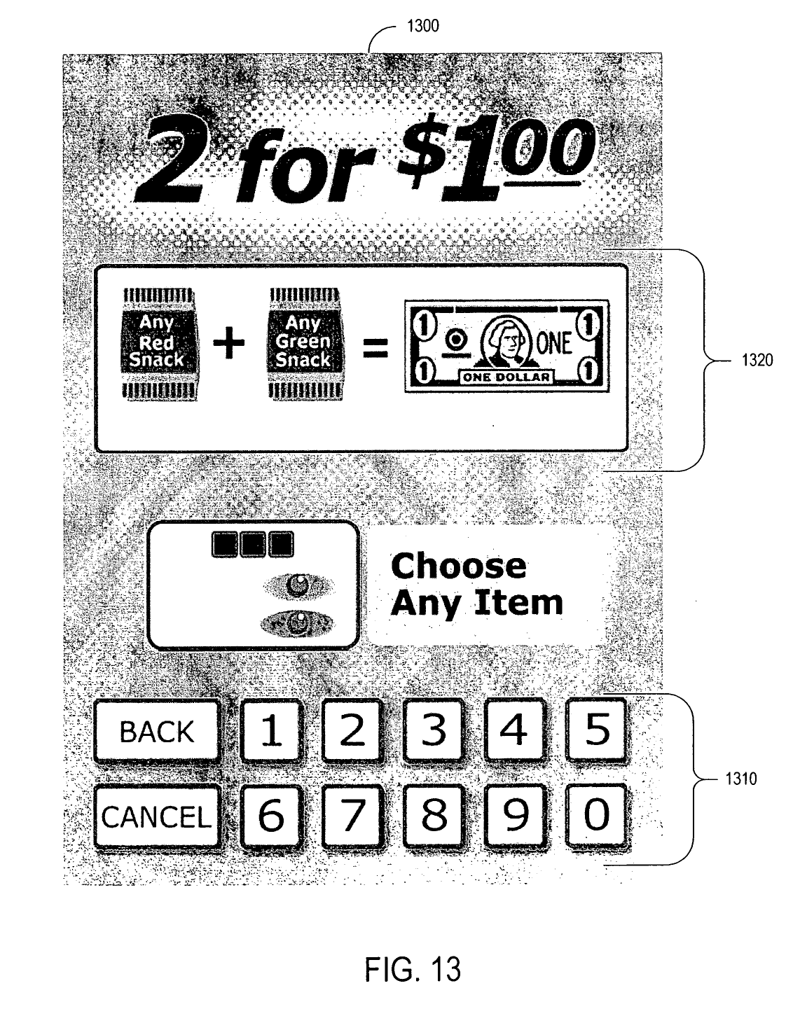

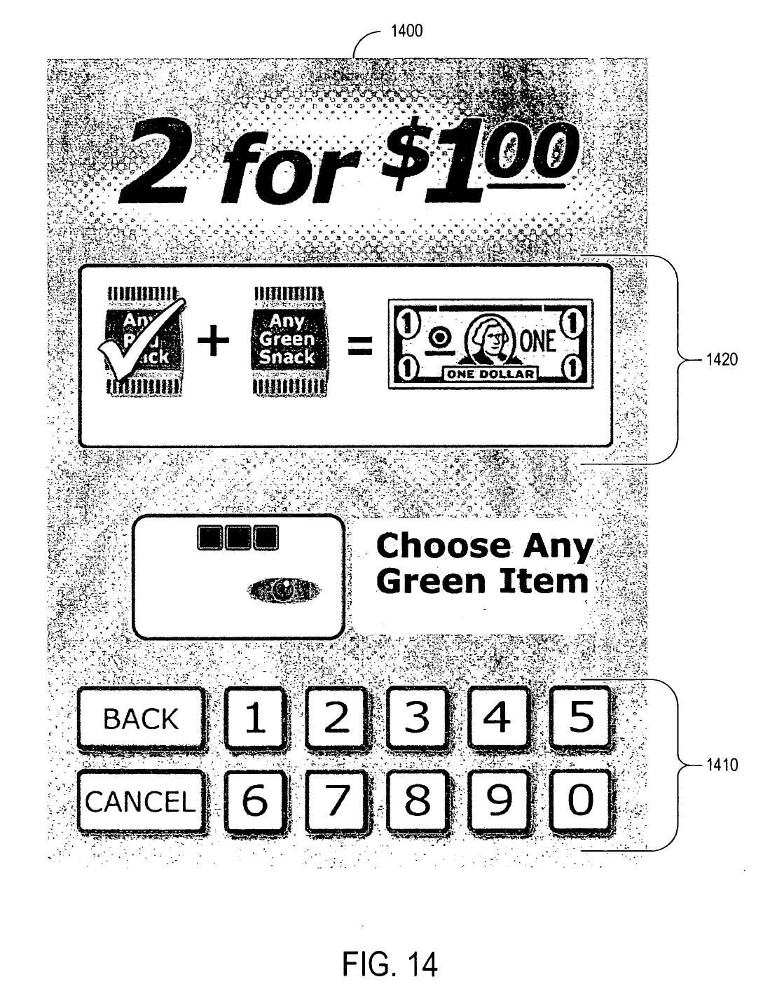

In some embodiments (certain “bonus benefit” embodiments) customers are not necessarily entitled to receive any product benefits. In such embodiments the vending machine may access product data, and one or more benefits may be determined based on stored profit management rules. Such benefits may be offered to customers utilizing a game-themed presentation. For example, a customer may insert payment of $1.00 into a “single product” vending machine, and select a Snickers® candy bar for $0.65. The vending machine (e.g., the vending machine control system) may then (i) access product data, (ii) determine, in light of stored profit management rules and product data, a benefit offer comprising a dynamically-priced upsell offer (e.g., an offer to purchase an additional product for $0.45), (iii) output a game-themed presentation indicating the benefit offer (e.g., a “prize wheel” spins and stops on “Take any blinking green item instead of your change!”), and/or (iv) provide or enable the benefit (e.g., by receiving the customers selection of a Twix® candy bar as an acceptance of the upsell offer, dispensing the Twix® candy bar and Snickers® candy bar). Example displays which may be presented during such an embodiment (e.g., via touch screen) are depicted in FIG. 10 and FIG. 11, each with reference to customer directions and customer input buttons.

A. “Product Entitlement” Embodiments

Generally, many embodiments include situations in which a customer entitled to receive an additional component product of a package deal (e.g., through a purchase transaction) is provided with a benefit that is communicated through a game-themed presentation.

1. Selecting a First Product

A customer purchasing a package deal from a vending machine may select a product that is available for dispensing by the vending machine. Thus, a vending machine may receive a selection of a product (e.g., a first component product of a package deal). As described above, a customer may initially select a first component product via an input device. The vending machine in turn receives a signal indicating the selection of the first component product from the input device.

For example, a customer may enter a position identifier of a product (e.g., “A-1”) on an external keypad in a well-known manner, or select a graphic or icon representing the product using a touch screen display. In some embodiments, payment must be received from a customer (e.g., via a vending machine bill validator or coin acceptor) before a first component item is selected. In other embodiments, payment may be received at any other stage of a vending machine transaction prior to the transaction's completion.

In some embodiments, a customer may select only one first component product (e.g., if the maximum number of component products in a package deal is two, then each purchase of a package deal consists of one first component product and one additional component product). In other embodiments, a customer may select more than one first component product (e.g., transactions of a “3 products for $2” machine may comprise the selection of two first component products). In other words, a certain number of products less than all products in the package may be selected.

In some embodiments, after a customer selects one or more first component products, a “product database” may be updated to reflect changes in product data based in the selection, such as any (i) decrease in inventory (e.g., after one Snickers® candy bar is selected, inventory decreases from 15 to 14 units), (ii) increase in actual sales rate (e.g., after a Snickers® candy bar is selected, the actual sales rate increases, such as from 1.4 units/day to 1.6 units/day), and/or (iii) additional changes to product data as described elsewhere in the present disclosure. In some embodiments, product data may be updated, stored or otherwise recorded on a periodic, substantially continuous and/or event-triggered basis. Further, in various embodiments of the present invention, product data may be recorded during any stage of vending machine transactions (e.g., after transactions are complete, on a periodic basis, etc.).

2. Selecting a Second Product

Product data is retrieved to permit evaluation thereof (e.g., in light of stored profit management rules to determine one or more benefit offers pursuant to a profit goal).

In some embodiments, product data may comprise general information relating to the products stored in a vending machine (i.e. general product data). Further, product data may comprise (i) quantity data (e.g., N units of product type X remain available sale in the vending machine), (ii) cost data (e.g., the unit cost associated with one or more vending machine products), (iii) sales data (e.g., the retail price, actual sales rate, ideal sales rate of one or more vending machine products), (iv) fill period data (e.g., days remaining until the next date the vending machine is restocked) and/or (v) any other practical data which is desirable to evaluate.

In this manner, product data may be retrieved, recorded, stored, updated and/or otherwise accessed at various different times. For example, as a vending machine is filled with products during an initial load process (e.g., performed by a route driver), certain product data may be recorded (e.g., in fields or tables of a product database). For instance, a route driver may proactively program (e.g., via an input device) the retail price, unit cost, ideal sales rate, quantity, etc. of each product he loads into a machine. Such an agent may also indicate a date and/or time at which the machine is to be restocked. Various techniques and methods of remotely (e.g., in network embodiments, a machine is programmed from a central location) and/or automatically (e.g., as RFID-tagged products are loaded, a receiver transmits product data to a control system) programming, recording, or updating product data are also contemplated within the scope of the present invention.

Further, as the products of a vending machine are sold (e.g., during a vending machine fill period), product data may be further updated on a periodic, substantially continuous, or event-triggered basis. For instance, in some embodiments the actual sales rate of a given product may be calculated by the following formula:

$$ACTUAL SALES RATE = \frac{UNITS OF PRODUCT SOLD}{TIME ( DAYS )}$$

Therefore, the actual sales rate for Snickers® candy bars may dynamically fluctuate in accordance with product sales (e.g., after each transaction in which a Snickers® candy bar is sold, the “actual sales rate” field of a product database may be updated as a processor receives a product selection signal from an input device or a product signal from a dispensing device). For example, if one Snickers® candy bar is sold every day for the first four days of a vending machine fill period (i.e. the actual sales rate is 1.0/day), then the actual sales rate will change if during the fifth day two Snickers® bars are sold (i.e. the actual sales rate increases to 1.2/day based on the average sales during the five days).

As discussed, in some embodiments, product data may be stored in a product database, maintained within a vending machine or otherwise accessible by a vending machine control system (e.g., in network embodiments, a vending machine control system may access a remotely stored product database).

A graphic representation of an exemplary product database at a particular point in time is shown below in Table 1.

TABLE 1

| | | | | | Actual | Target | Days |
|---|---|---|---|---|---|---|---|
| | Unit | | | Units in | Sales | Sales | until |
| Product | Cost | Retail Price | Margin | Inventory | Rate | Rate | Restock |
| Snickers ® | $.55 | $.75 | $.20 | 7 | 1.15/day | 1.0/day | 10 |
| candy bar | | | | | | | |
| Milky | $.50 | $.65 | $.15 | 15 | .75/day | 1.0/day | 10 |
| Way ® | | | | | | | |
| candy bar | | | | | | | |
| Twix ® | $.60 | $.65 | $.05 | 21 | .45/day | 1.0/day | 10 |
| candy bar | | | | | | | |
| Dentyne ® | $.10 | $.35 | $.25 | 24 | .30/day | 1.0/day | 10 |
| gum | | | | | | | |
| Cheetos ® | $.30 | $.60 | $.30 | 18 | .60/day | 1.0/day | 10 |
| snacks | | | | | | | |
| Doritos ® | $.35 | $.60 | $.25 | 4 | 1.30/day | 1.0/day | 10 |
| tortilla | | | | | | | |
| chips | | | | | | | |

In the above example, product data has been retrieved on the twentieth day of a thirty-day fill period, and thirty units of each product have initially been loaded. Vending machine product data may be evaluated in light of profit management rules (as described further in this disclosure) in order to determine a benefit offer (e.g., an offer for a product benefit) to be presented to a customer (e.g., during the next vending machine transaction). In some embodiments, data may be retrieved periodically (e.g., once per day). In some embodiments, data may be retrieved on an event-triggered basis (e.g., every transaction) allowing different benefit offers to be constructed in a manner that is responsive to changes in supply and demand.

3. Determine a Benefit Offer

In some embodiments, a benefit offer may be determined in light of the accessed data and stored profit management rules (e.g., after a vending machine customer has selected at least one first component product of a package deal, and after product data has been accessed). In some product entitlement embodiments, (e.g., in which a customer may be entitled to receive one or more additional component products of a package deal) a benefit offer may comprise: (i) a particular additional component product to be provided, (ii) an inventory group from which at least one additional component product may be selected, and/or (iii) one or more general benefits that may be offered in addition to a product benefit.

In some product entitlement embodiments, a profit management rule may include an instruction to offer a particular product benefit, pursuant to the increase of vending machine profit (e.g., during a fill period). In some embodiments, a profit management rule may be constructed in accordance with increasing the “expected profitability” of a vending machine, which may assume (i) that certain profit management practices (e.g., outputting product benefits characterized by low costs) may generally lead to increased profits, and/or (ii) a probability that one or more given products will sell (e.g., a certain number of units, at a certain actual sales velocity, when offered for a certain price). In this manner, a benefit offer (e.g., an additional component product of a package deal) may be determined so as to increase or otherwise increase the profitability of a vending machine.

In some embodiments, the expected profitability of a vending machine may describe the amount of profit a vending machine (or the individual products thereof may potentially earn during a given period of time (e.g., fill period) and/or from a specific transaction. Generally, the profit per fill period of a vending machine may be increased by (i) increasing the profit margin of vending machine transactions (e.g., by selling items with lower unit costs and/or for higher retail prices during those transactions); (ii) increasing the actual velocity of items sold (e.g., profit management rules may determine that expected profitability during a period of time increases if products are sold at a lesser profit margin, but with a sufficiently offsetting increase in sales volume); (iii) establishing, increasing, or promoting the overall customer loyalty and/or goodwill associated with one or more machines (e.g., customers who receive benefits and/or entertainment outputs may perceive certain vending machines to be valuable, and therefore may return to those vending machines for future transactions); and/or (iv) any other method or set of steps described herein.

In various embodiments, determining the expected profitability may involve consideration of one or more of: (i) the unit cost of one or more products, (ii) the retail price of one or more products, (iii) the profit margin of one or more products, (iv) the actual sales rate of one or more products, (v) the ideal sales rate of one or more products, (vi) the quantity of one or more products remaining in a vending machine, (vii) the amount of time (e.g., in days) left until a vending machine restock date, (viii) the expiration date of one or more products, (ix) the probability that one or more products will be sold (e.g., during a given period of time), (x) the historic “acceptance rate” of one or more benefit offers (e.g., comprising one or more products), (xi) the opportunity cost and/or potential for dilution associated with a benefit offer (e.g., and accounting for probable or expected acceptance of such offers), and/or (xii) the goodwill (or consumer loyalty) generated by distribution of one or more products via a benefit offer.

Accordingly, in light of retrieved product data and stored profit management rules, one or more benefit offers may be determined so as to increase expected profitability. Increased profitability may be determined with reference to one or more profit management rules. Such profit management rules may be stored in a vending machine “profit management rules database” or otherwise accessible (e.g., via a remotely accessible server) by a vending machine control system in order to make such determinations.

For example, for a particular transaction, a profit management rule may determine that expected profitability would be increased by offering the product benefit characterized by the lowest unit cost. In response, product data may then be accessed to determine the product having the lowest unit cost, and that product may then be presented to a customer in the context of a benefit offer (e.g., an additional component product of a package deal).

In some product entitlement embodiments, a benefit offer may define at least one particular additional component product. In such embodiments, a variety of different profit management rules may be utilized in conjunction with retrieved product data so as to select a particular product to be offered (i.e. in order to increase expected profitability).

For instance, an exemplary profit management rules database for determining at least one product to be presented in the context of a benefit offer (e.g., an additional component product of a package deal) may define a plurality of rules, as depicted in Table 2 below.

TABLE 2
To increase expected profitability, offer the product with the:

| | |
|---|---|
| 1. | Lowest unit cost |
| 2. | Lowest actual velocity |
| 3. | Lowest actual velocity as a percentage of target velocity (actual |
| | velocity/target velocity) |
| 4. | Most units of inventory currently in stock |
| 5. | Lowest average profit per day (margin × actual velocity) |

Thus, in some product entitlement embodiments wherein a first component product has been selected, it can be beneficial to define/construct profit management rules which, when employed appropriately as described herein, help assure that the selected additional component product (which satisfies a customer's entitlement and completing a package deal transaction) has certain desirable characteristics that are reflected in the product data.

A plurality of rules, as illustrated in Table 2 above, may be collectively employed to select a product (or other benefit) based on criteria such as profitability. In some embodiments, the product (or other benefit) that satisfies the most profit management rules may be selected as a benefit offer (e.g., an offer defining an additional component product). In other embodiments, a product (or other benefit) that satisfies at least one particular profit management rule (e.g., the “most important” rule) may be selected. In further embodiments, rules may be defined/constructed so as to “break ties” if more than one product satisfies a particular profit management rule. For example, a rule may state, “If more than one product satisfies Rule #1, select the product that also satisfies Rule #2.” It may be noted that any combination of rules referencing any of the expected profitability considerations described herein may trigger/be employed in a benefit offer and are within the scope of some embodiments.

In some embodiments, profitability can be increased by selecting an additional component product that has a low unit cost. For example, since at a 2-for-$1 machine revenue amount in a transaction is most often $1.00, the revenue per transaction at a 2-for-$1 machine is approximately $1.00. Accordingly, profit per fill period may be expected to increase by reducing the cost of many transactions (or every transaction).

In other embodiments, selecting a product that is selling at a less-than-desirable actual velocity (e.g., less than target velocity, substantially less than target velocity) may increase expected profitability. In some embodiments, a product may be sold for a lesser profit margin if a sufficiently offsetting increase in actual velocity would lead to increased overall profit (e.g., rather than sell three units at a margin of $0.10 each, a rule may determine to offer twenty units at a margin of $0.05 each).

In further embodiments, selecting a product with a relatively large number of units in stock may increase profitability. For example, in an embodiment in which vending machine inventory that remains in stock too long (e.g., until the end of a fill period, expires and must be disposed of at cost to an operator) earns no revenue, a profit management rule may determine to offer the product with the most units remaining as a restock date approaches (e.g., even if the unit is sold at less than unit cost because anticipated losses may be mitigated by any revenue whatsoever).

In another embodiment, selecting an additional component product that has produced relatively little profit (e.g., its profit is below a threshold, its profit is in the bottom tenth of all products' profits) during a certain time period (e.g., since the vending machine has been operating, since the last refill date, between the beginning of a fill period and the time product data is retrieved) may increase expected profitability. For example, if product data is retrieved after twenty days of a thirty-day fill period, and during that twenty-day time period the machine has sold a total of three units of Mounds® candy bars at a profit margin of $0.15 each, then during that twenty day period (i) the total profit earned by Mounds® sales is only $0.45, and (ii) the average profit per day from Mounds® candy bars is slightly greater than $0.02. Thus, if profit management rules determine to offer the product with the lowest total profit earned and/or average profit per day, Mounds® candy bars may be offered and thus potentially increase the expected profitability. Such rules may increase expected profitability because (i) the resulting sale may lead to an increase in the actual velocity of Mounds® candy bar, and/or (ii) a vending machine may recognize the opportunity to “push” (e.g., promote via benefit offers) items that otherwise contribute poorly to a vending machine's profit.

In yet another embodiment, a profit management rule may dictate that an additional component product should be a product with a high profit margin. Ensuring that customers select such items as additional component products of package deals may reduce behavior which is “diversionary” (in that it diverts from the most profitable behaviors). If products having greater profit margins are “pushed” (offered frequently, aggressively and/or exclusively) in lieu of items with lesser profit margins, diversion may be reduced.

The exemplary product database depicted in Table 1 above is referenced in the following example in order to determine a benefit offer (defining an additional component product) that increases expected profitability. For example, Dentyne® gum, which has (1) the lowest unit cost ($0.10) of the six products, (2) the lowest actual sales rate (0.30 units/day), (3) the most inventory in stock (24 units) and (4) the lowest retail price ($0.35) would satisfy “Rule #1,” “Rule #2,” “Rule #4” and “Rule #6” of the rules depicted in Table 2 above. Twix® candy bar, which thus far has produced an average profit per day of only $0.02, would satisfy “Rule #5.”

Further, in some embodiments, the determination of an additional component product may comprise a probability measure, which may evaluate the likelihood of selling one or more products (e.g., selling a certain number of units, selling at a given velocity) during a given period of time (e.g., a fill period). In some embodiments, the expected profitability of a vending machine may be increased by selecting additional component products that (e.g., at retail price) are considered (or determined to be) “unlikely to be sold” during routine vending machine transactions and/or selected by customers as first or additional component products of a package deal. As discussed, since products that are unlikely to sell are also unlikely to produce any revenue or profit, such products may be sold at a reduced retail price, provided there is also a sufficiently offsetting increase in velocity, so that overall vending machine profit is increased.

For example, in some embodiments, the probability that a product will be sold (or not be sold) may be estimated (e.g., based on historic product data). For example, if product data is retrieved on the twentieth day of a 30-day fill period, a product with an actual sales rate of 1.5 units/day for the first twenty days may be expected to sell at the same rate during the final ten days (unless other aspects are considered to alter that estimate).

In some embodiments, a product benefit determination may comprise an expected profitability or expected value calculation which may be used to determine an amount of profit that one or more vending machine products may be expected to earn during a given time period (e.g., during the next fill period). Thus, referencing the ongoing example, to determine the expected profitability of a Cheetos® snack during a given period of time (e.g., one day), an expected value may (in one embodiment) be calculated by multiplying the profit margin of the product by the number of units of the product which is likely to sell (i.e., a probabilistic measure, or “expected value”). In an embodiment in which probability or expected sales is estimated based on historic sales data (i.e., actual velocity), an expected value calculation for Cheetos® snacks (denoted with the subscript “C”) may be defined as follows:
EXPECTED VALUE PER DAY_{C}=MARGIN_{C}×ACTUAL VELOCITY_{C}

Accordingly, based on historic data, Cheetos® snacks may be expected to earn $0.18/day in profit ($0.30 margin at an actual sales rate of 0.60 units/day). Thus, if product data has been retrieved on the twentieth day of a 30-day fill period, the “total expected profitability” of Cheetos® snacks for the remainder of the fill period may be $1.80 (Cheetos® snacks will earn $0.18/day for ten days). In this manner, (i) an expected value of velocity may be calculated for each product of a vending machine, (ii) products (and corresponding data) may be sorted according to the result of the calculation (e.g., products are sorted from greatest to smallest total expected profitability), and (iii) a product benefit may be determined based on a profit management rule (e.g., “Offer the product with the highest total expected profitability”).

It may be noted that in some product entitlement embodiments involving 2-for-1 vending machines, the probability that a given product is likely to sell may refer to (or be based on) the likelihood that the product is selected as a first component product of a package deal. In other product entitlement embodiments, wherein 2-for-1 machines may process routine, non-package transactions in addition to offering package deals, the probability that a given product is likely to sell may refer to the probability of the product being (i) selected as a first component product of a package deal, and/or (ii) sold during a routine, non-package transaction. In some embodiments, at the beginning of a fill period (and/or at other times) a control system may determine a product's actual velocity to be zero (since no sales data for that period has yet been collected). Accordingly, in some embodiments a control system may access data from a prior fill period to determine or estimate actual velocity.

In some embodiments, the determination of a product benefit may comprise an analysis of the potential for dilution associated with the provision of one or more products (e.g., at a given price). For example, if it is determined that a product has a high probability of being sold at its retail price (e.g., has a high actual sales rate), selling the product at less than its retail price (e.g., as an additional component product of a package deal) may cause dilution, and thus the product should not be promoted in conjunction with a benefit offer.

In other product entitlement embodiments, a benefit offer may define an inventory group from which at least one additional component product may be selected. For example, a customer may be presented with three products (which define the inventory group), and only one product may be selected from the three products. An exemplary profit management rules database for use in such embodiments may include rules as illustrated in Table 3 below.

TABLE 3
To increase expected profitability, offer an inventory group comprising
the three products with the:

| | |
|---|---|
| 1. | Lowest unit cost |
| 2. | Lowest actual velocity |
| 3. | Lowest actual velocity as a percentage of target velocity (actual |
| | velocity/target velocity) |
| 4. | Most units of inventory currently in stock |
| 5. | Lowest average profit per day (margin * actual velocity in fill period) |
| 6. | Lowest retail price |

Accordingly, in one 2-for-$1 product entitlement embodiment, customers may be presented with a group of three different products (i.e. benefit offers) from which one additional component product may be selected. In this manner, customers can benefit from having a greater number of options from which to select one or more benefits, while operators may benefit by presenting inventory groups constructed in a manner such that expected profitability may be increased. For example, in an embodiment wherein expected profitability is increased by instituting “Rule #1” in Table 3 above, the exemplary product database provided above may be sorted by unit cost as illustrated by Table 4 below:

TABLE 4

| | | | | | Actual | Target | Days |
|---|---|---|---|---|---|---|---|
| | Unit | | | Units in | Sales | Sales | until |
| Product | Cost | Retail Price | Margin | Inventory | Rate | Rate | Restock |
| Dentyne ® | $.10 | $.35 | $.25 | 24 | .30/day | 1.0/day | 10 |
| gum | | | | | | | |
| Cheetos ® | $.30 | $.60 | $.30 | 18 | .60/day | 1.0/day | 10 |
| snacks | | | | | | | |
| Doritos ® | $.35 | $.60 | $.25 | 4 | 1.30/day | 1.0/day | 10 |
| tortilla chips | | | | | | | |
| Milky | $.50 | $.65 | $.15 | 15 | .75/day | 1.0/day | 10 |
| Way ® | | | | | | | |
| candy bar | | | | | | | |
| Snickers ® | $.55 | $.75 | $.20 | 7 | 1.15/day | 1.0/day | 10 |
| candy bar | | | | | | | |
| Twix ® | $.60 | $.65 | $.05 | 21 | .45/day | 1.0/day | 10 |
| candy bar | | | | | | | |

Thus, in this example, it may be determined that an inventory group comprising Dentyne® gum, Cheetos® snacks and Doritos® tortilla chips is to be presented to a vending machine customer pursuant to “Rule #1”. A selection of any of these three products will produce a transaction characterized by relatively low cost, thus potentially increasing overall expected profitability of the vending machine in accordance with profit management practices.

In further embodiments, rather than construct an inventory group comprising a specific number of products (e.g., three products), the number of products to be presented as part of an inventory group may be determined in other manners. Table 5 illustrates a set of exemplary profit management rules constructed to determine such inventory groups.

TABLE 5
To increase expected profitability, offer an inventory group comprising
any products wherein:

| | |
|---|---|
| 1. | Actual sales rate < target sales rate |
| 2. | ≧20 units in stock |
| 3. | Unit cost ≦$.20 |
| 4. | Actual sales rate ≦.5 units/day |
| 5. | Margin ≦$.10 |

In still further embodiments, an inventory group may comprise any number of products of a certain (i) type or category (e.g., “chips,” “gum,” “soda,” etc., such that additional component products may be complimentary to first component products), (ii) location within a machine (e.g., the bottom shelf; a particular row on a shelf), and/or (iii) subset as displayed, determined or otherwise communicated to vending machine customers in light of profit management rules. In yet another embodiment, a customer may be presented with at least two inventory groups, and the customer selects one (or more than one) product from each group. An offer for such an embodiment may be, e.g., “Pick any item from ‘Group A’ and any item from ‘Group B’!”.

In some embodiments, additional stored rules may be used to decide whether to offer (i) a particular additional component product, or (ii) an inventory group from which one or more additional component products may be selected. For instance, in one embodiment, a profit management rule may define, in general, “Present one or more products with low unit costs.” Accordingly, an “inventory group vs. single product rules database” may be consulted to determine whether to present “one” or “more” products (e.g., a single product benefit, or an inventory group from which one may be selected). Table 6 below illustrates one example of such a database.

TABLE 6

| If: | Then present benefit offer comprising: |
|---|---|
| Two or more products have a | Inventory group of those products |
| unit cost below $0.20 | |
| Only one product has a unit | That product |
| cost below $0.20 | |

In still further product entitlement embodiments, in addition to providing one or more additional component products (e.g., so as to satisfy a product entitlement), a general benefit may also be determined and provided. For example, a product entitlement benefit offer may comprise (i) an inventory group from which one additional component product may be selected, and (ii) a coupon for a further vending machine transaction (e.g., a benefit offer is “Pick any blinking green item AND get a third product free during your next package purchase!”). Determinations for providing various types of general benefits (e.g., upsells, discounts) are described further herein.

Additionally, in some product entitlement embodiments wherein at least one additional component product of a package deal may be determined in accordance with product data and profit management rules, additional “restriction rules” may place limitations on the types of additional component products offered as benefits. In some embodiments, restriction rules may consider a selected first component product and/or machine inventory status. In some embodiments, if a product benefit offer is determined in light of profit management rules, the offer may then be checked against a set of restriction rules to determine if any rules are violated. An offer which violates a restriction rule may be lower in priority or eliminated as a possibility.

In other embodiments, restriction rules may be consulted before profit management rules are considered (so as to reduce a set of potential product benefits and thereby reduce computational processing). For example, an example of a restriction rules database is illustrated in Table 7 below.

TABLE 7

| | Then additional |
|---|---|
| If: | component product must: |
| First component product is Doritos ® chips, | Not be Juicy Fruit ®, |
| Cheetos ® snack or Lays ® Potato Chips | Dentyne ® or |
| | Wrigley's ® gum |
| First component product is a “snack” | Be a “drink” |
| Machine has ≦10 total units of “chips” in stock | Not be a bag of “chips” |
| First component product is not a Mars ™, Inc. | Be a Mars ™, Inc. |
| product | product |
| Machine has ≧50 units of “gum” in stock | Be either Juicy Fruit ®, |
| | Dentyne ® or |
| | Wrigley's ® gum |

In such an embodiment, restriction rules may ensure that determinations for additional component products are not exclusively based on profit management rules, but rather may consider various marketing and promotional strategies as well.

4. Output a Game-Themed Presentation

In some product entitlement embodiments, once a benefit offer is determined, it may be indicated to a vending machine customer as the result of a game-themed presentation.

In some embodiments, a game-themed presentation may be outputted to a customer via one or more vending machine output devices described herein. For example, a presentation may comprise a game-themed animation depicted on an LCD display and sound effects emitted via audio speakers. Additionally, a game-themed presentation may incorporate various other types of machine hardware (e.g., LED price displays) or output devices, as described further herein.

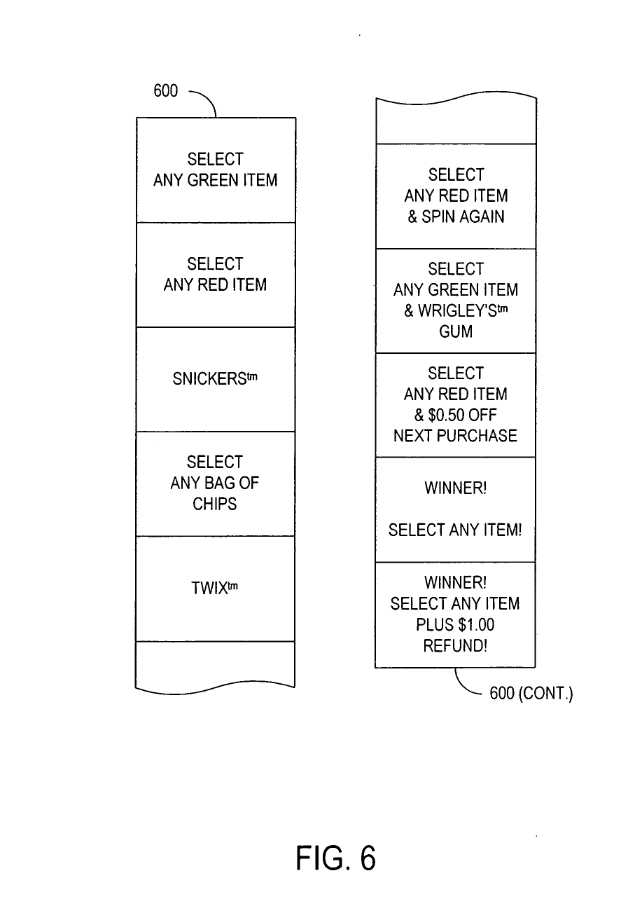

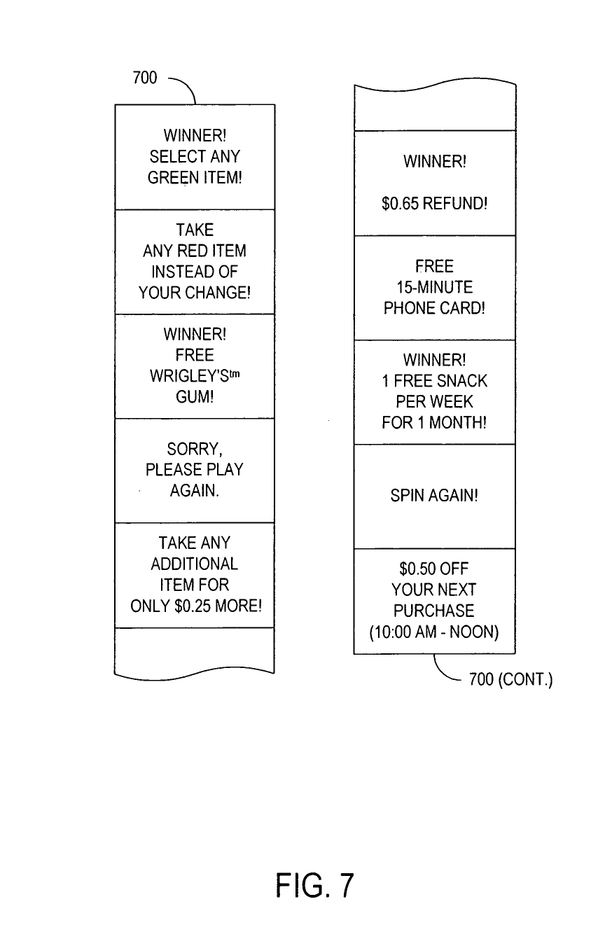

In various product entitlement embodiments wherein a benefit offer has been determined, game-themed presentations may take one or more of several different forms so as to indicate a determined benefit offer. FIG. 6 illustrates an example of some potential product entitlement game results. Any means of communicating a determined benefit offer as the result of a game-themed presentation are within the scope of the present invention, such means including but not limited to (i) text, (ii) audio, (iii) graphics, photographs or other icons, and/or (iv) any combination thereof.

In some embodiments, a game-themed presentation may comprise a “prize wheel” theme. In such embodiments, once a benefit has been determined, an animated prize wheel, which may be divided into several “wheel sections,” each representing a potential game result (i.e. benefit offer), may automatically “spin” and conclude (e.g., stop spinning, so that an arrow points to a particular, predetermined game result indicating a benefit offer). In some embodiments, a prize wheel theme may comprise a roulette wheel. In some embodiments, the wheel sections of an animated roulette wheel each represent a row position identifier (e.g., “B-1”) corresponding to a vending machine product, such that a game result (e.g., as an animation concludes, a ball “lands” on a particular row position identifier) can indicate a determined benefit offer (e.g., a customer may then receive the Snickers® candy bar in row position “B-1”). Some embodiments may involve a theme based on the television game show “The Price is Right®”. FIG. 8, FIG. 9, FIG. 10, and FIG. 11 illustrate exemplary input/output device screenshots of such a theme, each with reference to customer directions and customer input buttons. Another theme is one based on the game show “Wheel of Fortune®”.

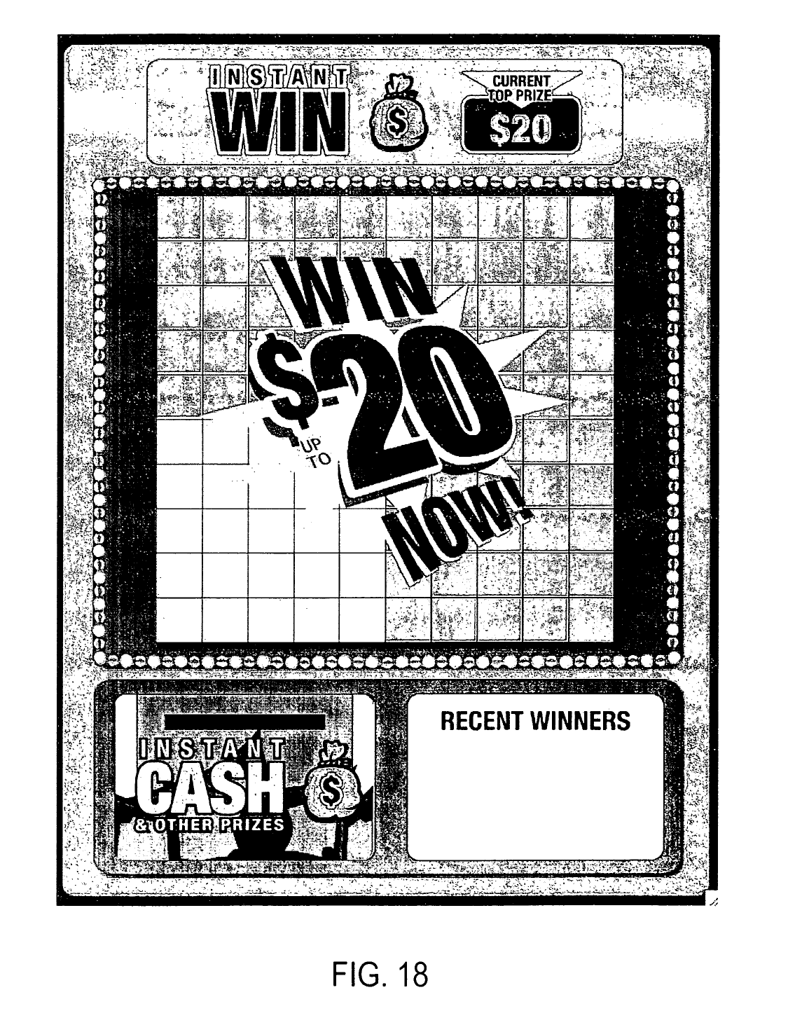

In other embodiments, a game-themed presentation may comprise a “concealed prize” theme. In such embodiments, one or more curtains, doors, squares (e.g., on a grid, such as that which is depicted in FIG. 18-FIG. 22) or other (animated or animatable) objects displayed via an output device may conceal indications of one or more benefits. In some embodiments, an animation sequence may reveal a concealed benefit offer by removing a concealing object (e.g., a door is lifted during an animation sequence, a square on a grid is removed to reveal a benefit). In some embodiments, a benefit offer may be viewable before it is concealed (e.g., during a first animation sequence which shows the “scrambling” and “covering” of possible outcomes), and then once again revealed (e.g., during a later animation sequence). In other embodiments, a customer may be shown several benefit offers which are then concealed (e.g., an animation shows three curtains covering three different prizes; an animation shows the scrambling and covering of possible outcomes), only a certain number of which are then revealed as determined benefit offers (e.g., one of the three curtains rises to show a “Pick any green item!” benefit offer; e.g., one of one hundred squares in a grid is uncovered to reveal a benefit offer). In further embodiments, a concealed benefit offer may be revealed by “flipping over,” “scratching off” or otherwise animating an object as to expose an icon or text describing a benefit offer. In still further embodiments, concealing objects may be shuffled before a benefit offer is revealed. For example, a “shell game” animation may be displayed wherein three objects each covering a benefit offer are shown in an initial position, then animated so as to “shuffle” between positions. After they are shuffled, one or more benefit offers may be revealed. Further, some concealed prize embodiments may comprise a theme based on the television game show “Let's Make a DealÔ.”

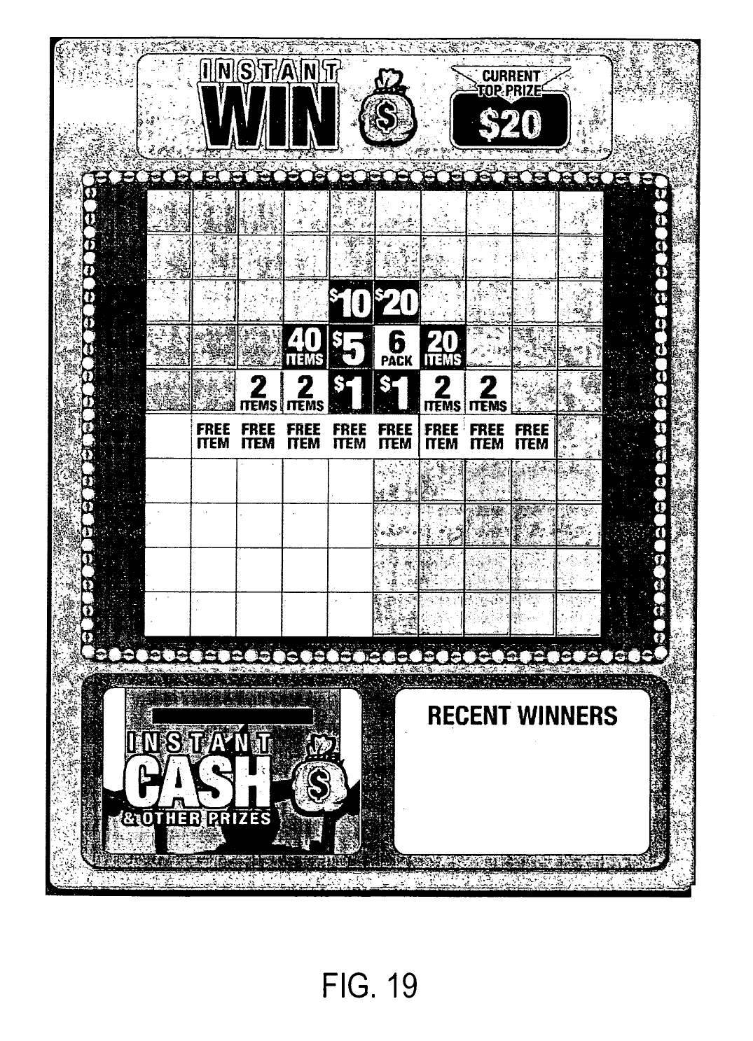

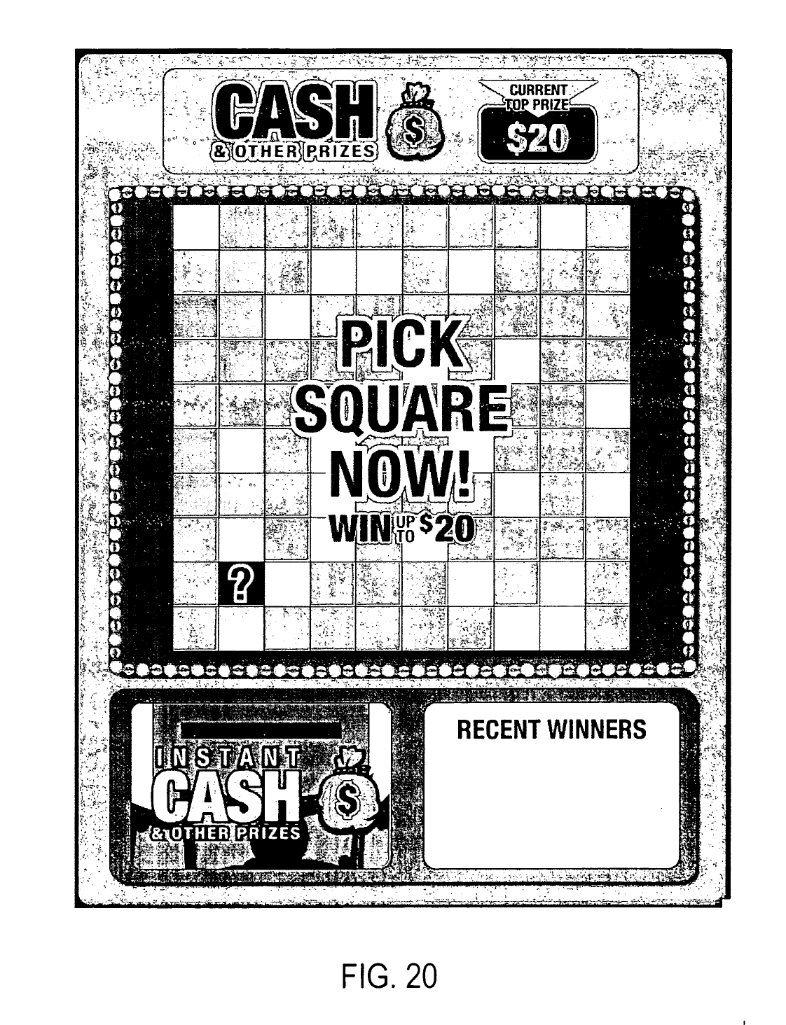

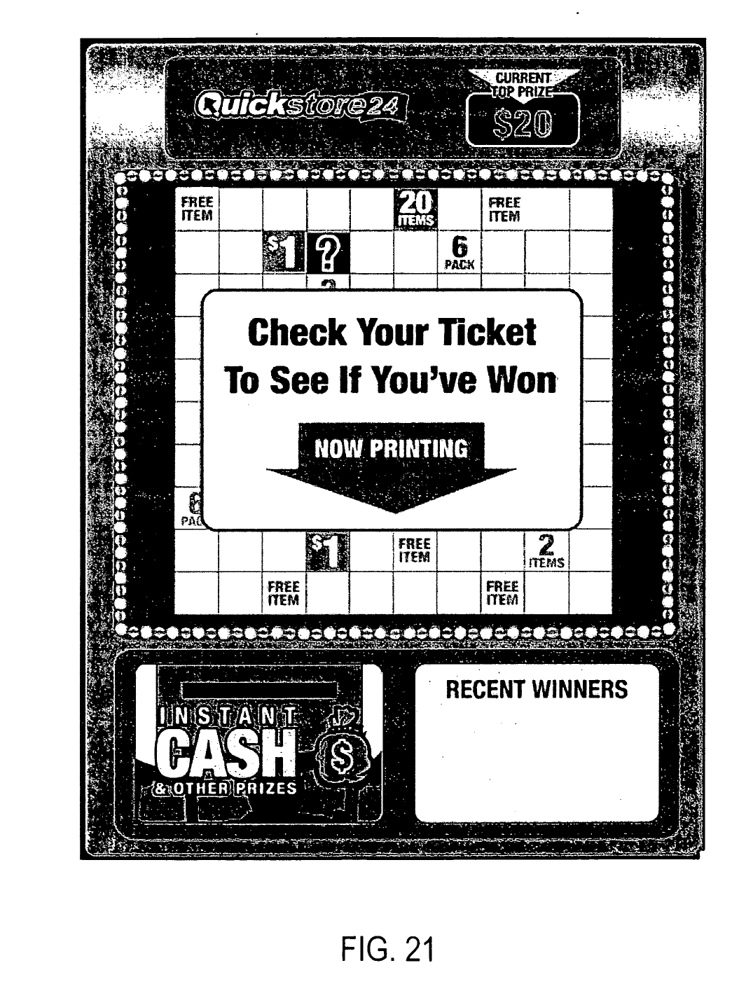

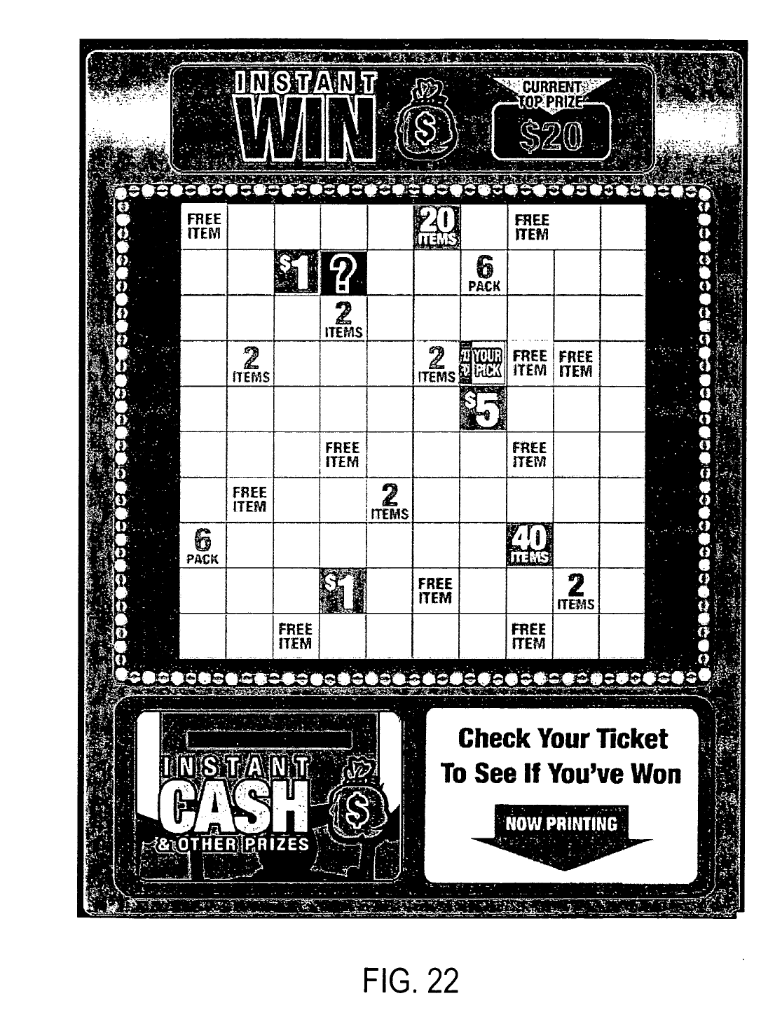

One variety of “concealed prize” embodiments is described with reference to FIG. 18-FIG. 22. As illustrated by FIG. 18, a top prize amount may be advertised on a display. A prize amount (e.g., a top prize) may be based in whole or part on the sales activity of one or more vending machines, as discussed with further reference to “jackpot” style prize embodiments, below. Subsequently (e.g., after a customer has selected a first product; after a customer has initiated the start of a game by pressing a button), as illustrated by FIG. 19, one or more possible outcomes may be shown to a customer, so as to excite the customer as to the prize possibilities. After the possible outcomes are shown to the customer at FIG. 19, the possible outcomes may, through an animation sequence, be shuffled and/or concealed. The outcomes may be shuffled and/or concealed randomly or pseudo-randomly. Thereafter, as illustrated by the display of FIG. 20, the customer may be afforded the opportunity to select a square on a grid. Thus, the customer may be encouraged by the possibility of selecting a square that may conceal a prize (e.g., a top prize of $20). After the customer selects a square on the grid, the outcome of the game may be revealed to the customer. For example, as illustrated by FIG. 21, a customer may be instructed to consult a ticket, which is printed by the vending machine's printer (an output device 172). Alternatively or additionally, as illustrated in part by FIG. 22, one or more additional animation sequences may serve to visually “uncover” the possible outcomes for the customer, revealing whether or not the customer's selection indeed corresponds to a prize.

It should also be noted that, prior to the customer's selection of a square but after the concealing of possible prizes (e.g., through shuffling and/or covering), a code may be generated pursuant to an encryption scheme which is based on the positions of the concealed prizes. The encrypted code may be provided to the customer via a printed receipt. After the resolution of the game (e.g., after the outcomes are revealed), the customer may utilize the code to confirm (i.e. through a decryption process) that the positions of the prizes were not deceptively altered after the customer selected his square(s). Such an encryption technique is disclosed with reference to Applicant's U.S. Pat. No. 6,203,427 entitled METHOD AND APPARATUS FOR SECURING A COMPUTER-BASED GAME OF CHANCE, issued on Jul. 3, 1997, this technique of which is incorporated by reference herein for all purposes.

In further embodiments, a game-themed presentation may comprise a “slot machine” theme. In such embodiments, a presentation (e.g., an animation) may resemble the spinning reels of a slot machine in a manner in which (i) symbols displayed on the reels may be representative of benefit offers (e.g., a “Snickers®” symbol instead of a “BAR” symbol), and (ii) game results may be indicative of at least one determined benefit offer (e.g., the reels “spin” and “stop” such that three “Snickers® ” symbols land on a “payline”).

In still further embodiments, a game-themed presentation may comprise a “video poker” or “Blackjack” theme. For example, an LCD screen may depict an animation sequence showing a poker hand being dealt to a customer; should the poker hand be of a certain value or higher (e.g., two pair), a benefit may be provided (e.g., a corresponding pay table presents the relationship between various game outcomes and provided benefits). In an exemplary Blackjack game-themed presentation, a customer may be automatically dealt a hand of Blackjack according to standard play. In either event, the customers “hand” may be printed for the customer through the vending machine's printer. The customer may then be provided with a benefit if the customers hand is of greater value than a “dealer hand” (i.e. a winning game result) without “busting” (exceeding a value of 21).

In still further embodiments, a game-themed presentation may comprise a “bingo drawing” or “lottery drawing” theme. In some bingo-themed embodiments, an output device may depict a bingo “board” that bears a plurality of “cells.” Further, each cell may correspond to a vending machine position identifier (e.g., “A-1” represents the leftmost product on the highest shelf of a vending machine). In such embodiments, wherein a drawing (e.g., animation sequence) reveals the identity of certain cells of a bingo board, one or more markers may be placed over one or more cells, indicating at least one determined benefit offer (e.g., a marker is placed on “B-3” and a customer may select the Mounds® bar in row position B-3). In other bingo-themed embodiments, wherein each cell may represent a description (e.g., text, graphic) of a benefit offer, markers may be placed (e.g., during an animated drawing sequence) on one or more cells so as to indicate one or more determined benefit offers. In some lottery embodiments, rather than compare the results of an animated drawing sequence to a bingo board, results may be compared to at least one “lottery ticket” (e.g., depicted via one or more output devices, such as a display screen or printer), so as to determine a game result (e.g., if a customer's lottery ticket matches a certain number of drawn numbers, the customer is provided with a benefit offer). In some embodiments, a customer may be provided with at least one lottery ticket, which may comprise any combination of the following “elements”: (i) numbers, (ii) position identifiers, and/or (iii) icons or text representing potential benefit offers. In this manner, as elements are drawn (e.g., during an animated drawing sequence), they are compared to the numbers indicated by at least one provided ticket to determine a game result (e.g., benefit offer). In another embodiment involving a lottery theme, the row position identifier of a product a customer has selected (e.g., B-3) may be used as lottery number (e.g., “Lottery Number: B-3” is printed on a ticket at the end of the transaction), such that if the same position identifier is selected during a later drawing, the customer may be entitled to receive a benefit.

In one embodiment, a plurality of tickets (e.g., lottery or bingo tickets) may be printed for two or more customers, and one or more outcomes may be revealed at a certain, predetermined time. In this manner, several customers may report to a vending machine at a particular time (e.g., for a “drawing”) in order to determine whether or not they are entitled to prizes.

In this manner, as a determined benefit offer is indicated to a customer as the result of a substantially brief (e.g., not substantially interactive and/or time-consuming) game-themed presentation, the customer may benefit from (i) the entertainment and suspense generated by the presentation and (ii) the provision of a benefit (e.g., an additional component product).

In one embodiment, a vending machines may advertise, as a prize, the ability to win prizes such as all of the machine's revenue for a given period, the cash stored in the machine, an amount equal to all the cash stored in the machine, or some other amount (e.g., a prize amount generated by diverting $0.05 from each transaction into a progressive “prize pool”). The vending machine may determine winners randomly or pseudo-randomly.

Winners may be provided with the prize amount in one of several ways. For example, winners may be issued a machine credit equal to the prize amount, winners may be provided with cash instantly through the coin mechanisms, winners may be provided with a coded voucher or check that can be redeemed at a retailer or bank, or winners may be provided with a coded voucher that can be redeemed through a web site (a winner may enter a code, and a credit may be issued automatically to a financial account associated with the winner or a check may be mailed to the winner by the site operator). The code may contain an internal (cryptographic) reference to the machine's then-current revenue total.

As necessary or desired to support alternate forms of entry (which are required in some states for compliance with gambling and/or sweepstakes laws), the vending machine may permit any person to play (i.e., “no purchase necessary”) by spinning a game wheel, and the like.

In a “subscription vending” embodiment (e.g., where machines sell pre-paid unit accounts which facilitate redemption of units pursuant to a subscription), subscribers may get an additional chance to win each time they redeem a unit of product or otherwise transact with a vending machine.

Further, to encourage redemption of subscription units (which increases sales volume), “drawings” may be held frequently (e.g., twice per day; at 10 AM and 3 PM), and subscribers could be entered into each drawing by redeeming a unit before the schedule drawing time.

It may be noted that any variations or combinations of the themes, output devices and input devices described herein, as well as additional game presentation themes, are within the scope of the present invention and may be employed for the purpose of indicating a determined benefit offer via a game-themed presentation.

In some embodiments of the invention, a promotion is based on the popular television show “Let's Make a Deal” (LMAD). In a LMAD embodiment, customers may receive the ability to make a simple choice that determines or reveals their entitlement to one or more prizes. For example, a customer may receive the ability to select an icon that determines or reveals a prize (e.g., selecting a “door” icon on a touch screen). In another LMAD embodiment, a customer may first receive an entitlement (e.g., a printed coupon) and then be presented with a choice to either keep the first entitlement or return it (e.g., deposit a printed coupon into the machine's bill validator) for the possibility of receiving a second entitlement (e.g., a prize with a greater value). Thus, customers would be able to participate in a game much like television's LMAD, where contestants are asked to choose between keeping low value prizes and risking such low value prizes in hopes of winning high value prizes. For example, a customer could trade a discount coupon for the ability to “spin” a prize wheel and potentially win all the cash then stored in the machine.

5. Provide at Least One Benefit

In some embodiments, once a determined benefit has been indicated to a customer via a game-themed presentation, the benefit may be provided without requiring any further input or action from the customer. For example, in an embodiment wherein a determined benefit is a particular additional component product of a package deal (e.g., a prize wheel spins and lands on “Lays® Potato Chips”, thereby defining the benefit), the benefit may be provided in a substantially automatic manner (e.g., one or more vending machine dispensing mechanisms may then receive a signal from a control system, and actuate so as to dispense the bag of Lays® potato chips, without requiring any further commands or instructions from a customer). In further embodiments, a determined benefit may comprise two or more additional component products, which may be provided in a substantially automatic manner (e.g., a vending machine dispenses a Snickers® bar, then a bag of Doritos® chips without any further customer input).

In other embodiments, a determined benefit may only be provided after receiving further input from a customer (e.g., via one or more input or input/output devices described herein). For example, in an embodiment wherein a determined benefit comprises an inventory group (e.g., comprising Reese's® candy, Milky Way® candy bar and Mounds® candy bar) from which a customer may select one or more additional component products of a package deal, a further selection, decision, command, signal and/or instruction may be required from a customer before a determined benefit is provided (e.g., from the aforementioned inventory group, a customer selects a Reese's® icon displayed on a touch screen input/output device, and the candy is then dispensed).

In some product entitlement embodiments, a benefit offer (e.g., product benefit) may be dispensed via a product delivery system (e.g., a delivery bin or chute) in accordance with any distribution functions or dispensing mechanisms (e.g., dual helices) described herein and/or known in the art. In other product entitlement embodiments, wherein in addition to a product benefit, a determined benefit offer comprises a general benefit (e.g., a coupon), the general benefit may be dispensed by any output device (e.g., a printer) as detailed elsewhere herein.

As stated, in some embodiments, a customer of 2-for-$1 machine may elect not to purchase a package deal. In such embodiments, a vending machine may not necessarily provide the corresponding benefit of a determined benefit offer. For example, a customer may (i) insert payment (e.g., of $1.00), (ii) select a first product (e.g., with a retail price of $0.65), (iii) elect not to purchase a second product (e.g., by pressing a “no thanks” button of an input device), (iv) receive the first product, and (v) receive change due (e.g., $0.35).

In this manner, upon evaluating profit management rules, restriction rules and/or product data, a benefit offer (defining at least one product benefit which the customer is entitled to receive) may be indicated to a vending machine customer in conjunction with a game-themed presentation, and provided to the customer. It should be noted that any processes, determinations, concepts and/or rules disclosed with respect to product entitlement embodiments can be applicable to the other embodiments and processes disclosed elsewhere herein.

B. “Bonus Benefit” Embodiments

In certain embodiments, a vending machine customer is not necessarily entitled to receive a product benefit during a transaction at a vending machine. Rather, a customer may be afforded a benefit as “bonus”, solely within the discretion of the operator, a third party, a vending machine and/or a computer associated therewith.

1. Receive a Customer Selection of a Vending Machine Product

In some “bonus benefit” embodiments in which vending machine customers are not necessarily entitled to receive any products (e.g., additional component products of package deal), product data may be analyzed in light of stored profit management rules, and one or more benefit offers (i.e. general benefits) may be determined and presented to customers as the result of a game-themed presentation.

For example, if a customer (i) approaches a single product vending machine, (ii) inserts payment of $1.00 and (iii) selects a Snickers® candy bar which has a price of $0.65, a vending machine control system may (a) access product data, (b) determine, in light of stored profit management rules and product data, a benefit offer comprising a dynamically priced upsell, (c) output a game-themed presentation indicating the benefit offer (e.g., a “prize wheel” spins and lands on “Take any blinking green item instead of your change!”), and/or (d) provide or enable the benefit (e.g., by receiving the customers selection of a Twix® candy bar as an acceptance of the dynamically-priced upsell, and dispensing the Twix® and Snickers® candy bars).

Thus, in some bonus benefit embodiments, a vending machine customer may first select at least one product in a conventional manner (e.g., by inputting payment and pressing “A-1” on an external vending machine keypad). Additionally, as described above, product data may be updated and/or recorded to reflect any changes associated with the selection of a product (e.g., a decrease in inventory, increase in actual sales rate).

2. Access Data

In some bonus benefit embodiments, the vending machine may access product data after a customer has first selected at least one product. In various embodiments, product data may be recorded, updated and/or retrieved at various times. Further, various types of product data may be stored in one or more vending machine databases or in any manner such that data may be otherwise accessible by a vending machine control system (e.g., stored on a remotely accessible server).

Any type of benefit described herein may be awarded to a customer as a bonus benefit. For example, in some bonus benefit embodiments, a general benefit may comprise an opportunity to purchase one or more vending machine products at less than their respective retail prices (e.g., a benefit offer may be a dynamically-priced upsell, such as: “Select any blinking green item to receive instead of your change!”).

In some embodiments, retrieved product data may comprise any data associated with the inventory of a vending machine as described herein (general product data). Various descriptions of such data and visual examples depicting hypothetical databases thereof are described herein.

Additionally, in some embodiments, retrieved data may comprise “machine status data,” which may consider (i) aggregate machine sales data (e.g., a machine has X total units of product in stock, has made a total of Y in profit during the current fill period, has sold an average of Z units/day during the current fill period), (ii) the current date and time, (iii) the amount of time remaining until a restock date, (iv) the amount of coins (e.g., number of units of each denomination) stored in a vending machine currency storage device, and/or (v) any other data related generally to a specific vending machine. Table 8 below illustrates an example of a “machine status database” according to one embodiment.

TABLE 8

| | | Total | | Average | | | |
|---|---|---|---|---|---|---|---|
| Total Units | Total | Profit | Average | Velocity | Total | Days | |
| Initially | Units | (in fill | Profit | (Units | Coins | Until | |
| Stocked | Remaining | period) | per Day | per Day) | Remaining | Restock | Date/Time |
| 180 | 30 | $37.50 | $1.88 | 7.5 | $12.70 | 10 | Sunday, |
| | | | | | | | 10/04/05, |
| | | | | | | | 8:00 p.m. |

Still further, in some embodiments (e.g., wherein a general benefit comprises a product benefit or an opportunity to purchase a product at a reduced price), retrieved product data may comprise “benefit acceptance data,” which may indicate the acceptance rate of one or more previously determined and offered general benefits. In some embodiments, the acceptance rate of a general benefit which has been previously offered (e.g., outputted as the result of a game-themed presentation) may be expressed by the following formula:

$$ACCEPTANCE RATE = \frac{\# OF ACCEPTANCES}{\# OF PRESENTATIONS}$$

For example, if a specific general benefit (e.g., a dynamically-priced upsell for a Snickers® candy bar in lieu of change) is offered as the result of fifty game-themed presentations (e.g., offered to fifty different customers during fifty separate transactions), and is “accepted” thirteen times (e.g., thirteen different customers chose receive a Snickers® bar instead of their change), an acceptance rate (e.g., 13/50=“0.26” or “26%”) may then be associated with the general benefit offer.

Further, in some embodiments, wherein a general benefit offer provides an opportunity for a customer to purchase an additional product at a discounted price, each of different “discount amounts” associated with the provision of the same additional product may be represented as a unique benefit offer. For example, one offer may be for Doritos® chips to be sold at a first price, and another offer may be for Doritos® chips to be sold at a second price.

A discount amount may be defined by the difference between an amount a product is offered for sale for (i.e. the “sale price”) and the product's retail price. For example, if the retail price of Doritos® chips is $0.55, and a unit of Doritos® chips is offered for $0.40 as the result of a first fixed-price upsell, the first fixed-price upsell may represent a unique general benefit with a discount amount of $0.15. If a unit of Doritos® chips is offered for $0.50 as the result of a second fixed-price upsell, the second fixed-price upsell may represent a unique general benefit with a discount amount of $0.05.

Such “discount amounts” may be embodied in a coupon having a face value that corresponds to the discount amount. Different coupons (e.g., coupons for the same product but different discount amounts) may be considered different offers.

It can be advantageous to determine the acceptance rate for different offers. For example, if general benefit offers are defined by a coupon for a unit of Twix® candy bar, a different acceptance rate may be determined for each Twix® candy bar coupon value (e.g., such that an acceptance rate for a “$0.25 off Twix®!” coupon may be 30%, whereas an acceptance rate for a more attractive “$0.50 off Twix” coupon may be 70%). Table 9 illustrates an exemplary “benefit acceptance database which records benefits and corresponding acceptances.

TABLE 9

| Benefit | Benefit | Discount | Presen- | Accep- | Acceptance |
|---|---|---|---|---|---|
| Offered | Type | Amount | tations | tances | Rate |
| Snickers ® | Dynamic | $0.30 | 50 | 35 | 70% |
| candy bar | Upsell | | | | |
| Snickers ® | Dynamic | $0.25 | 50 | 27 | 54% |
| candy bar | Upsell | | | | |
| Snickers ® | Coupon | $0.10 | 50 | 4 | 8% |
| candy bar | | | | | |
| Twix ® | Dynamic | $0.25 | 50 | 29 | 58% |
| candy bar | Upsell | | | | |
| Twix ® | Coupon | $0.30 | 50 | 17 | 34% |
| candy bar | | | | | |
| Twix ® | Fixed | $0.05 | 50 | 7 | 14% |
| candy bar | Upsell | | | | |
| Dentyne ® | Fixed | $0.05 | 50 | 3 | 6% |
| gum | Upsell | | | | |
| Doritos ® | Full refund | $0.60 | 50 | 50 | 100% |
| chips | | | | | |
| Cheetos ® | “Free” | $.60 | 50 | 44 | 88% |
| snack | product | | | | |

Employing a structure to store data such as that stored in Table 9, benefit acceptance data may be retrieved and analyzed in light of stored profit management rules in order to facilitate the determination of a general benefit offer (e.g., which defines a product benefit or an opportunity to purchase one or more products at a discounted price). Further, as general benefits are accepted and rejected, the benefit acceptance data may be updated on a periodic or event-triggered basis (e.g., so as to reflect a change in an acceptance rate).

In further bonus benefit embodiments, a general benefit may comprise an opportunity to receive or purchase at a discount one or more products not sold during routine vending machine transactions (e.g., “non-food products” or services, such as a phone card, via a food vending machine). Accordingly, in such embodiments, retrieved data may comprise “non-food product data,” which may describe (i) the number of units of one or more non-food products in inventory, (ii) the acceptance rate associated with one or more non-food products, (iii) the unit cost of one or more non-food products, (iv) subsidy information pertaining to one or more non-food products (e.g., a third-party phone card manufacturer pays a premium to a vending machine operator for each phone card that is provided to a customer as a general benefit), (v) operator-programmed promotion instructions (e.g., during this fill period, provide every customer with a “third-party sweepstakes entry” general benefit), and/or (vi) any other data relevant to one or more non-food products.

Such products not sold during routine vending machine transactions may be stored in one or more rows of vending machines, which are stocked with transparent containers, each containing a prize (e.g., digital watches, $20 bills, phone cards). The vending machine control system may be programmed to only dispense items from such “prize rows” when a customer has won a prize. Thus, such prize rows would not be selectable by customers who attempt to purchase a prize from a prize row.

In this manner, various types of product data (i.e. general product data, machine status data, benefit acceptance data and/or non-food product data) may be retrieved (e.g., accessed by a vending machine control system) pursuant to the process of determining of one or more general benefit offers in light of stored profit management rules.

3. Determine Whether to Offer at Least One Benefit

In some embodiments, after a customer has selected at least one vending machine product (e.g., during a transaction of a single product vending machine), and data has been accessed, one or more general benefit offers may be determined in light of the accessed data and stored profit management rules. In some embodiments, only one type of product data may be accessed (e.g., only general product data). In other embodiments, more than one type of product data may be accessed (e.g., a vending machine control system may access a product database and a machine status database for analysis in light of stored profit management rules) so as to determine one or more general benefit offers.

In various embodiments, a general benefit may comprise one or more of: (i) a discount or “promotional price” for one or more products (or a group thereof, (ii) a refund of the cost (or portion thereof of one or more already-selected products, (iii) a dynamically priced upsell, (iv) a fixed price upsell, (v) free or discounted alternate, non-food products (e.g., a phone card not sold during routine machine transactions), (vi) a sweepstakes or contest entry, (vii) a free or discounted vending machine subscription or membership, (viii) an opportunity to procure additional benefits (e.g., a free spin of a prize wheel game-themed presentation), (ix) one or more bonus products, and/or (x) any other entitlements whose provision may lead to an increase in expected vending machine profitability.

In some embodiments, a general benefit may comprise a bonus product which is provided subject to vending machine “status” data. For example, after a customer of a single product vending machine has inputted payment and selected a Diet Coke® soda, a general benefit offer may entitle the customer to a free, additional product (e.g., the result of a game-themed presentation is “Winner! One free A&W Root Beer®!”). In such embodiments, a vending machine control system may access (i) general product data, (ii) machine status data and/or (iii) benefit acceptance data, in light of one or more stored profit management rules in a manner such that one or more particular product benefits (free products) may be determined. In some embodiments, a vending machine control system may first retrieve machine status data to determine whether or not a vending machine's “status” warrants the provision of one or more free products (e.g. the provision of one or more free products may increase expected profitability). One or more stored profit management rules may then be used to make such a determination. Table 10 below illustrates an example of a “machine status rules database”, including several exemplary rules.

TABLE 10
To increase expected profitability, offer a free product to a customer when:

| | |
|---|---|
| 1. | Machine actual velocity > machine ideal velocity |
| 2. | Total profit in fill period ≧$50.00 (target profit already exceeded) |
| 3. | There is at least one product in which: actual velocity/ideal |
| | velocity ≧2 |
| 4. | There is at least one product in which: total profit in fill |
| | period ≧$10.00 (target profit already exceeded) |
| 5. | Transaction occurs on Sunday between 5:00 P.M. and 11:00 P.M. |
| 6. | There are ≧100 total units in stock AND ≦2 days remaining in |
| | fill period |

Utilizing such a machine status rules database, profit management rules may be used to determine whether and how the status of one or more particular vending machines permits the provision of a free product in a manner which increases expected profitability. Typically, the provision of one or more free products may increase overall machine expected profitability due to increased customer satisfaction, goodwill and/or loyalty (e.g., by encouraging repeat visits and future transactions). Thus, several circumstances may arise wherein a profit management rule may determine that a vending machine should offer one or more free products.

As demonstrated by the exemplary database in Table 10 above, such rules may determine that (i) the machine has already reached a suitable profit and/or velocity threshold, as in “Rule #1” and “Rule #2,” such that a machine may provide a free product yet still expect to accrue sufficient or target profit during a fill period; (ii) one or more specific products have reached or exceeded a target velocity, as in “Rule #3” and “Rule #4,” such that one or more units of those products may be provided for free because the products have already contributed significantly toward overall machine profit; (iii) as in “Rule # 5,” the time of day and/or date is such that should a free product be provided, a further transaction during a specific time period may be encouraged during a time period which is typically low sale volume (e.g., by offering free products during “off-peak” or “low-traffic” hours, customers may return during such times), (iv) a vending machine may not be likely to sell one or more products by the end of a fill period, and thus one or more products may be offered for free (e.g., if products will expire soon and possibly be thrown out anyway, provide those products for free so as to increase customer satisfaction).

Accordingly, once it has been determined that one or more free products (i.e., product benefits) may be provided (e.g., to a customer of a single product vending machine), a determination may then be made (using general product data and/or benefit acceptance data and stored profit management rules) as to which specific product to provide for free. For example, as described herein, a profit management rule may be constructed in accordance with general product data so as to select one or more products characterized by (i) low unit cost, (ii) low profit margin, (iii) a large number of units currently in inventory, etc. Additionally, one or more profit management rules may, in light of retrieved benefit acceptance data, indicate to select one or more products characterized by a high benefit acceptance rate (e.g., Snickers® candy bar has the highest acceptance rate of all products offered for free as a general benefit), such that the benefit offer has a high likelihood of being accepted by a customer (e.g., if expected profitability may be increased by increasing customer satisfaction, then select the product most likely to satisfy a customer).

In other bonus benefit embodiments, a determined benefit may comprise an opportunity to purchase one or more vending machine products at less than retail price (i.e. at a discount). For example, if a customer has selected at least one first vending machine product, a general benefit offer may comprise an opportunity to (i) purchase a second vending machine product at a discount during the same transaction (e.g., a benefit offer is a dynamically-priced upsell, such as “Pick any bag of chips instead of your change,” wherein the amount of change due is less than the retail price of any bag of chips), and/or (ii) purchase a second vending machine product at a discount during a later transaction (e.g., a benefit offer is a “$0.15 off a Snickers® candy bar Tuesday through Thursday” coupon).

In such embodiments, a vending machine control system may first analyze machine status data in light of stored profit management rules in order to determine whether, given the status of the vending machines, providing a discounted product may increase expected profitability. Such a determination of machine status may be made in a manner substantially similar to bonus product embodiments described above. Accordingly, once it has been determined that machine status is such that outputting a general benefit offer comprising an opportunity to purchase one or more vending machine products at a discount may potentially increase expected profitability, a general benefit may be determined by analyzing general product data and/or benefit acceptance data in light of additional stored profit management rules.

In some bonus benefit embodiments, in which a customer has selected at least one first vending machine product, a general benefit offer may comprise an opportunity to purchase a second vending machine product at a discount during the same transaction. Such a general benefit offer may comprise one or more of, but is not limited to, (i) a dynamically-priced upsell or “round-up offer,” wherein the customer may purchase an additional product in exchange for an amount of change due (typically less than the product's retail price) as the result of selecting at least one first product, and/or (ii) a fixed-price upsell or “promotional price” that enables the customer to purchase an additional product for a discount (e.g., at a price that is less than full price, but that is not necessarily the amount of change due to the customer as the result of a first selected product).

In some embodiments wherein a general benefit offer comprises a dynamically-priced upsell, one or more profit management rules may be constructed in accordance with general product data and/or benefit acceptance data so as to determine one or more particular general benefit offers. Table 11 illustrates an exemplary “dynamically-priced upsell rules database” including several exemplary rules.

TABLE 11
To increase expected profitability, offer a dynamically-priced upsell to
a customer wherein:

| | |
|---|---|
| 1. | The corresponding product's unit cost is ≦$0.15 |
| 2. | The corresponding product's actual velocity is ≦0.50 units/day |
| 3. | The amount of change due > the corresponding product's unit cost |
| 4. | The acceptance rate of the benefit offer (comprising corresponding |
| | product) is ≧70% |

Product data and/or benefit acceptance data may be analyzed in light of such stored dynamic upsell rules in order to determine one or more particular dynamically-priced upsells to offer to a customer pursuant to an increase in expected profitability. For example, a rule similar to “Rule #1” may be executed so as to select a corresponding product (i.e. if a benefit offer is “Get a Snickers® bar instead of your change!”, Snickers® candy bar is the corresponding product) in a manner that reduces cost. “Rule #2” promotes the sale of corresponding products that are not selling well; “Rule #3” assures that a dynamically-priced upsell is profitable; “Rule #4′ may assure that a dynamically-priced upsell offer has a high likelihood of being accepted. Any variations and/or combinations associated with these and other such rules are within the scope of the present invention.

In other embodiments, a rule may determine that the status of a vending machine is such that a general benefit comprising an opportunity to purchase one or more items at a discount may be offered (e.g., during the same transaction in which a first item is purchased at a single product vending machine). Thus, a general benefit may comprise a fixed-price upsell or promotional price (i.e. a discounted price for one or more products, specific to a particular transaction). In such embodiments, one or more profit management rules may be utilized to determine one or more specific fixed-price upsells to be presented to a customer as a benefit offer. A “fixed-price upsell rules database” may contain such profit management rules; a hypothetical depiction of such a database follows, in Table 12:

TABLE 12
To increase expected profitability, offer a fixed-priced upsell to a customer
wherein:

| | |
|---|---|
| 1. | The corresponding product's unit cost is ≦$0.15 |
| 2. | The corresponding product's actual velocity is ≦0.50 units/day |
| 3. | The fixed price > the corresponding product's unit cost |
| 4. | The acceptance rate of the benefit offer (comprising corresponding |
| | product) is ≧70% |
| 5. | The fixed price < the retail price |

It may be noted that several rules referencing product data and/or benefit acceptance data (e.g., “Rule #1,” “Rule #2” and “Rule #4”) may be applicable to both dynamic- and fixed-price upsell determinations pursuant to the increase of expected profitability. Moreover, certain rules (e.g., “Rule #3”) may be utilized so as to specifically assure the profitability of fixed-price upsell benefit offers. In this manner, a fixed-price upsell may (i) enable a customer to purchase one or more vending machine products at less than full price, and (ii) be constructed in accordance with one or more profit management rules so as to increase the expected profitability of a vending machine.

In other bonus benefit embodiments (e.g., wherein a customer has selected at least one first vending machine product during a transaction of a single product vending machine), a general benefit offer may comprise an opportunity to purchase a second vending machine product at a discount during a later transaction (e.g., a benefit offer is a “$0.15 off Snickers® candy bar Tuesday through Thursday” coupon). Accordingly, should the status of a machine (e.g., as determined by a profit management rule) be such that a benefit offer may comprise an opportunity to purchase one or more additional products at a discount during a later transaction, one or more profit management rules may be constructed in accordance with general product data and/or benefit acceptance data so as to determine a benefit offer that increases a vending machine's expected profitability.

In such embodiments, a benefit offer may comprise a coupon provided via a vending machine output device (as is well known), enabling a customer to redeem a discount during a later transaction. In some embodiments, a coupon may be tangible (e.g., including a paper or other substrate that is outputted via a printer). In other embodiments, a coupon may be intangible (e.g., rather than print a tangible coupon, a vending machine display device outputs a code which a customer may then input via a keypad during a later transaction). Accordingly, in some embodiments, a coupon may comprise a means for validation (e.g., a barcode, a machine-readable substrate), such that valid redemption requests (e.g., issued, non-duplicate codes) may be honored upon a customer's return visit to one or more machines.

Accordingly, various profit management rules may be constructed in accordance with general product data and/or benefit acceptance data so as determine a coupon (e.g., general benefit offer), which may then be presented to a customer (e.g., in conjunction with a game-themed presentation) so as to increase a vending machine's expected profitability. Such profit management rules may be stored in a “coupon rules database,” a hypothetical example of which is illustrated in Table 13 below.

TABLE 13
To increase expected profitability, offer a coupon to a customer wherein:

| | |
|---|---|
| 1. | The corresponding product's unit cost is ≦$0.15 |
| 2. | The corresponding product's actual velocity is ≦ target velocity |
| 3. | The coupon may only be redeemed 5:30 P.M.-9:00 P.M. |
| 4. | The acceptance rate of the benefit offer (coupon) is ≧70% |
| 5. | The discount amount is ≦$0.15 |
| 6. | The corresponding product is Cheetos ® snack |
| 7. | The sale price > unit cost |

A profit management rule may determine to offer a coupon such that (i) one or more specific products are promoted (e.g., a product with a low unit cost), (ii) customers may be driven to transact at vending machines during certain times (e.g., “off-peak” or “low-traffic” periods), (iii) the coupon has a high likelihood of being accepted (e.g., high acceptance rate), and/or (iv) expected profitability may be increased in any manner described herein.

Any combination of rules may be used to determine a benefit offer involving a coupon. For example, if a determined coupon is “$0.15 off your next Dentyne® gum purchase Friday 5:00 P.M. to Monday 9:00 A.M.,” then multiple profit management rules may have been utilized to construct the offer such that (i) the unit cost of the product is low, (ii) the product has been selling at a less-than-desirable velocity, (iii) the customer may be driven to transact during off-peak hours, (iv) the discount amount is relatively low, etc.

In various bonus benefit embodiments, a profit management rule may indicate to offer an inventory group (e.g., of coupons for discounted products) from which at least one may be selected by a customer as detailed previously herein (see product entitlement embodiments).

In further embodiments wherein a benefit offer may comprise an opportunity to purchase one or more products at a discounted price, a general benefit may comprise a refund of at least one first-selected item. For example, if a customer (i) approaches a single product vending machine, (ii) inserts $1.00 into a bill validator and (iii) selects Sprite® soda for $0.75, a game-themed presentation may occur in a manner such that (i) the result of the presentation is a general benefit offer comprising a refund (“Winner! $0.75 refund!”), (ii) the first-selected product is provided (a unit of Sprite® soda is dispensed) and (iii) payment for the first-selected product is returned to the customer (e.g., four quarters are provided via a change dispenser). Refunds for one or more particular first-selected products may be determined based on profit management rules that consider machine status data and product data as described herein (e.g., in a manner substantially similar to embodiments involving the provision of free or discounted products).

In further bonus benefit embodiments, a general benefit may comprise a product not typically available for sale at the vending machine (e.g., a non-food product benefit at a food vending machine). In some embodiments, a non-food product benefit (e.g., at a food vending machine) may comprise a free product (and/or service, such as a pre-paid phone card) and/or an opportunity to purchase such a non-food product at a discount. In some embodiments, a non-food product benefit may be determined and offered to every customer of a vending machine (e.g., at the conclusion of every transaction). In other embodiments, a non-food product benefit may be determined and offered in accordance with one or more machine status rules as described herein (e.g., if total machine profit in fill period exceeds a threshold, offer a non-food product benefit). Additionally, a vending machine control system may, in light of retrieved machine status data, non-food product data and/or at least one first selected product, determine to offer one or more non-food product benefits based on one or more stored rules, which may be stored in a “non-food product rules database.” Table 14 illustrates such a database.

TABLE 14
To increase expected profitability, offer a non-food product to a customer
wherein:

| | |
|---|---|
| 1. | The non-food product has ≧20 units in stock |
| 2. | The margin of first selected product is ≧$0.20 |
| 3. | The manufacturer of first selected product is Mars ™ |
| 4. | The acceptance rate of the benefit offer (non-food product) is ≧70% |

Utilizing such data, one or more non-food product benefits may be determined and offered to vending machine customers in a manner such that expected profitability may increase (e.g., if a third-party pays a vending machine operator a bounty for each non-food product distributed, then customers receiving non-food products from vending machines are likely to return to those machines for future transactions).

In still further bonus benefit embodiments, a general benefit may comprise a subscription to one or more vending machines. Such a subscription may provide a customer with an opportunity to procure a certain number of products during a certain time period and/or at certain frequencies (e.g., “One Diet Coke® soda per week during the month of June”).

In some embodiments, a general benefit may comprise a free subscription. In other embodiments, a general benefit may comprise an opportunity to purchase a subscription at a discount (e.g., “Get nine cans of Sprite® soda for $5.00—redeem by April 1”). Since a subscription may effectively provide a customer with one or more free or discounted products (depending on the subscription price compared to aggregate retail prices of all units in the subscription), determinations for providing subscriptions may be made in a manner substantially similar to determining benefit offers comprising free or discounted products (discussed in previous bonus benefit embodiments). For example, a vending machine control system may (i) execute a stored machine status rule determining to offer a free product as part of a subscription, (ii) determine, in light of product data, benefit acceptance data and/or or more stored “subscription rules” to offer a discounted subscription (e.g., a subscription may be “Four bags of Doritos® tortilla chips for $2” if Doritos® have low unit cost and are not selling at a desired velocity).

Additionally, a determination to provide a subscription may consider (be based at least in part on) at least one first-selected product. For example, if a customer selects a Snapple® Lemon Iced Tea during a transaction of a single product vending machine, a vending machine control system may determine to offer a subscription including Snapple® products. A general benefit comprising a subscription may additionally comprise a means for redeeming the subscription during later transactions (as discussed in “coupon” embodiments). Subscription offers are described at length in Applicant's patents: U.S. Pat. No. 6,298,972, entitled METHOD AND APPARATUS FOR ESTABLISHING AND MANAGING VENDING MACHINE SUBSCRIPTIONS, issued Oct. 9, 2001; U.S. Pat. No. 6,085,888, entitled METHOD AND APPARATUS FOR ESTABLISHING AND MANAGING VENDING MACHINE SUBSCRIPTIONS, issued Jul. 11, 2000; and U.S. Pat. No. 5,988,346, entitled METHOD AND APPARATUS FOR ESTABLISHING AND MANAGING VENDING MACHINE SUBSCRIPTIONS, issued Nov. 23, 1999. The entirety of each of these patents is incorporated by reference herein.

In still further bonus benefit embodiments, a general benefit offer may comprise an entry to a contest or sweepstakes (e.g., “Winner! You've been entered in a drawing for a Ford Explorer!”). In some embodiments, machine status data and associated rules may determine whether or not to present a sweepstakes or contest entry as a general benefit offer to one or more vending machine customers. In some embodiments, winners of such a sweepstakes may be entitled to receive one or more vending machine products (e.g., a contest winner gets one of each product of a vending machine); such products may be determined as discussed previously (e.g., bonus product embodiments). In other embodiments, winners may receive non-food products (e.g., a contest winner receives an Apple iPod® music player) at a food vending machine. Such non-food product benefits may be determined as discussed previously (i.e. non-food product embodiments). For example, applicant's co-pending patent application, entitled SYSTEM FOR VENDING PHYSICAL AND INFORMATION ITEMS, Serial No. 09/713,001, filed Nov. 17, 2000, incorporated herein by reference, discusses the vending of music files and other information.

Further, in some embodiments, a vending machine control system may determine to offer a sweepstakes or contest entry to a limited number of vending machine customers (e.g., only 1,000 entries will be allowed). In other embodiments, every customer of a vending machine may be presented with a benefit offer comprising a sweepstakes or contest entry. In still further embodiments, a customer may only be provided with a benefit offer comprising a sweepstakes or contest entry if various customer data is provided, as discussed further herein (e.g., customers provide an e-mail address via a vending machine input device so that winners may be notified upon the completion of a sweepstakes or contest drawing).

In yet further bonus benefit embodiments, a general benefit offer may comprise an opportunity to receive additional benefit offers (e.g., a benefit offer is a free spin of an animated prize wheel game-themed presentation). Such benefit offers may be determined (i) based on machine status data (e.g., if a machine has met a profit goal, a general benefit may comprise a free spin), (ii) based on at least one first-selected product (e.g., if the margin of at least one first-selected product is larger than a predetermined threshold, a general benefit offer may comprise a free spin), (iii) randomly (e.g., a vending machine control system receives a signal from a random number generator which indicates that a free spin should be presented to a customer), and/or (iv) in a any other manner.

Various other types of benefit offers are contemplated within the scope of the present invention, so long as such benefit offers may increase expected profitability by (i) increasing the profit margin of vending machine transactions (e.g., by selling items with lower unit costs and/or higher retail prices), (ii) increasing the actual velocity of items sold (e.g., in some embodiments, profit management rules may indicate that expected profitability increases if products are sold at a lesser profit margin, but with a sufficiently offsetting increase in volume), (iii) establishing, increasing, or promoting the overall customer loyalty and/or goodwill associated with one or more machines (e.g., customers who receive benefits may perceive machines to be valuable and/or entertaining, and therefore may return to machines for future transactions), and/or (iv) any other method described herein. Additionally, any combination of benefit offers may be determined and presented in any manner described herein (e.g., a benefit offer may comprise a dynamically-priced upsell as well as an opportunity to receive additional benefit offers: “Take any green item instead of your change—AND spin again!”).

Additionally, in some embodiments wherein a general benefit may comprise a product benefit and/or an opportunity to purchase a product at a discount, one or more restriction rules may be utilized in determining whether or not a particular general benefit may be offered. As discussed in relation to product entitlement embodiments, a restriction rule may determine that a certain product benefit may or may not be offered depending on at least one first selected product. For example, during a transaction of a single product (non-package deal) vending machine, if a customer chooses a bag of chips as a first selected product, a restriction rule may dictate that a product benefit comprising a pack of gum may not be offered to the customer.

In this manner, general product data, machine status data, benefit acceptance data and/or non-food product data may be analyzed in accordance with various profit management rules so as to determine a general benefit offer to be presented to a customer as the result of a game-themed presentation.

4. Output a Game-Themed Presentation

In some bonus benefit embodiments, once a general benefit offer is determined, it may be indicated to a vending machine customer employing a game-themed presentation.

In some embodiments, a game-themed presentation may be outputted to a customer via one or more vending machine output devices as previously described. For example, a presentation may comprise a game-themed animation depicted on an LCD display with accompanying sound effects emitted via audio speakers. Additionally, in some embodiments, a game-themed presentation may incorporate various other types of machine hardware (e.g., LED price displays) as described further herein.

In various product entitlement embodiments wherein a general benefit offer has been determined, game-themed presentations may comprise one or more of several different themes so as to indicate a determined benefit offer as the result of such a presentation (FIG. 4 illustrates by way of example some potential bonus benefit game results). Several examples of such themes are described herein. Any means of communicating a determined benefit offer as the result of a game-themed presentation are within the scope of the present invention, such means including but not limited to (i) text and/or numerals, (ii) audio, (iii) graphics, photographs or other icons, and/or (iv) any combination thereof.

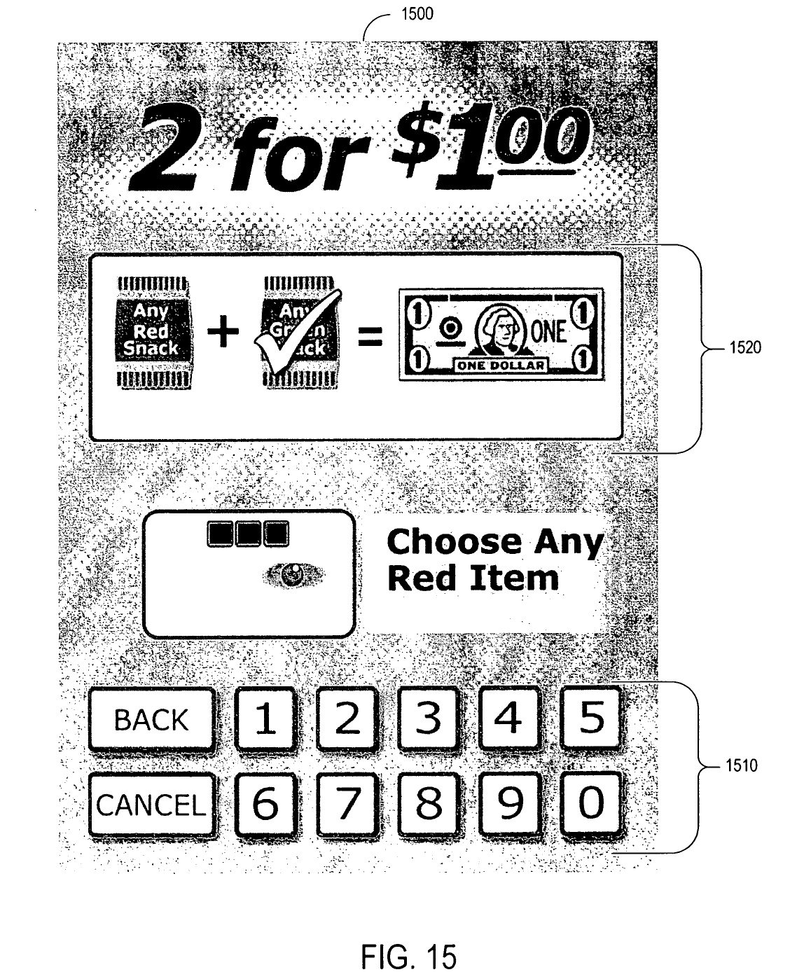

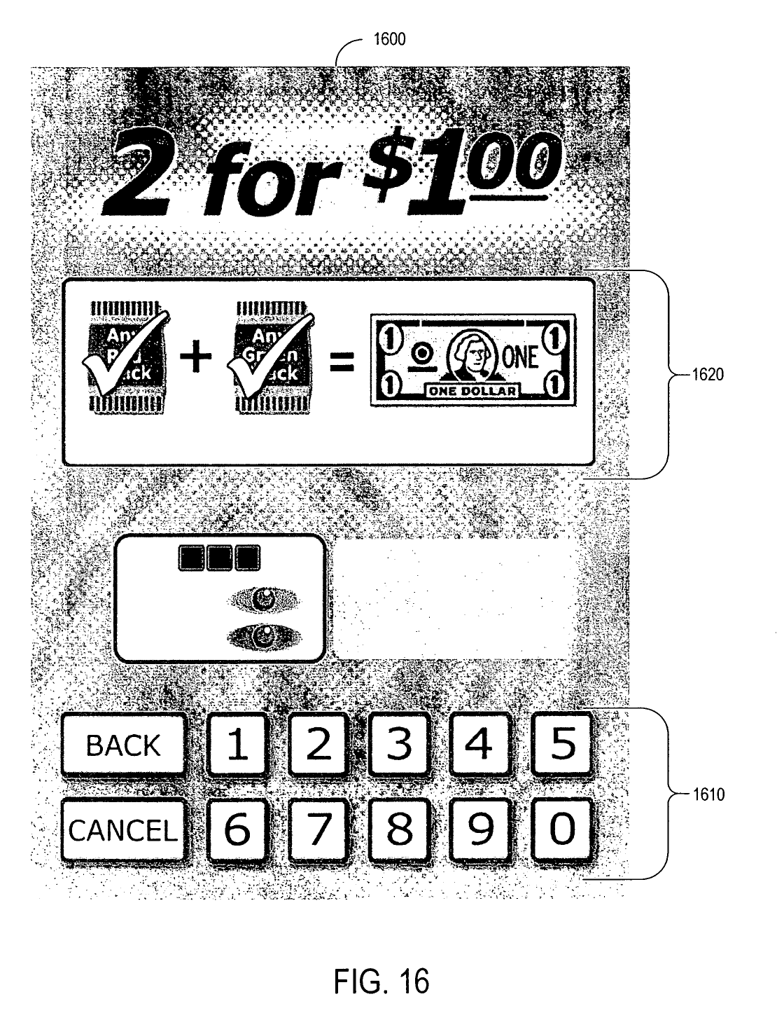

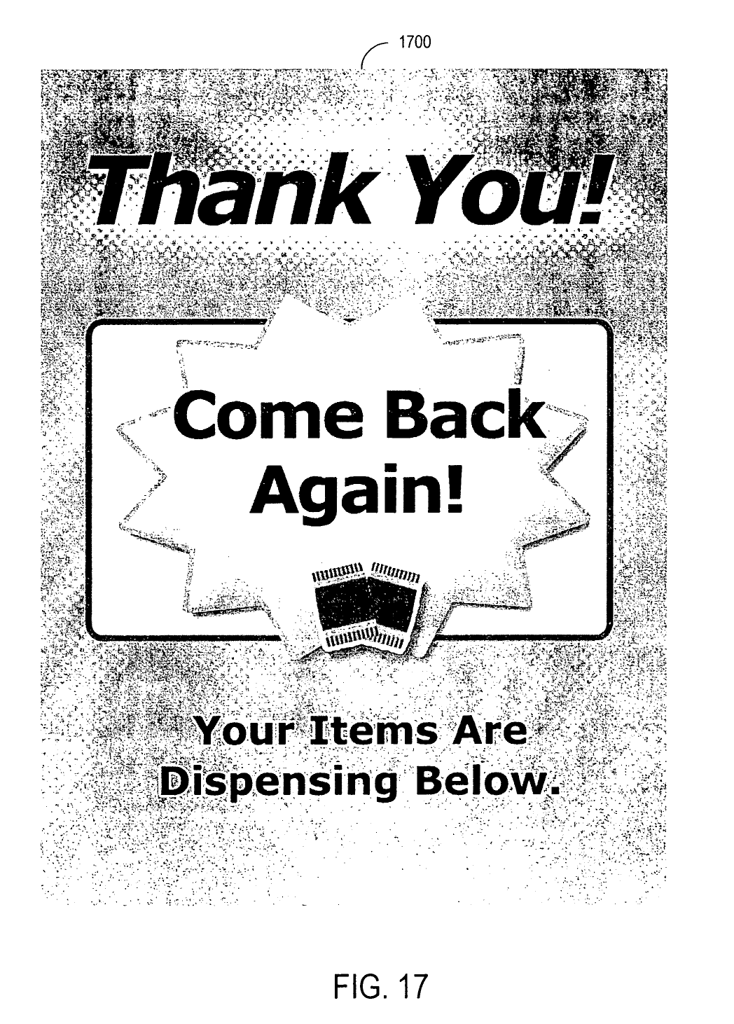

Additionally, in some embodiments wherein a general benefit offer comprises an opportunity to receive additional benefit offers (e.g., a free spin of a prize-wheel game), more than one game-themed presentation may be outputted to a customer (e.g., an animated prize wheel spins, lands on “Spin Again!”, animates once more, and lands on “Take a pack of Dentyne® gum instead of your change!”). In some embodiments, after viewing a first game-themed presentation, further input may be required from a customer before a second game-themed presentation is outputted (e.g., a customer must press a “Spin Again!” button of an input/output device). In other embodiments, a second game-themed presentation may be outputted automatically (e.g., upon the conclusion of a first game-themed presentation, a prize wheel automatically animates once again). Further, a grid-style game such as that which is provided by FIGS. 15 to 19 may be utilized to indicate a determined benefit to a customer.

5. Provide at Least One Benefit

In some embodiments, once a determined general benefit has been indicated to a player as the result of a game-themed presentation, the benefit may be provided in a manner such that no further input or action is required from a customer. For example, in an embodiment wherein a determined general benefit comprises a free product (e.g., a prize wheel spins and lands on “Winner! Free Lays® Potato Chips!”), the benefit may be provided in a substantially automatic manner (e.g., one or more vending machine dispensing mechanisms may then receive a signal from a control system, and actuate so as to dispense the bag of chips, without requiring any further commands or instructions from a customer).

In other embodiments, a determined benefit may only be provided after receiving further input from a customer (e.g., via one or more input or input/output devices described herein). For example, in an embodiment wherein a determined general benefit comprises an opportunity to purchase one or more discounted vending machine products during a first transaction, (e.g., a benefit offer comprises a dynamically-priced upsell offer: “Take a Snickers® bar instead of your change!”), a further selection, decision, command and/or instruction may be required from a customer before the benefit is provided (e.g., a customer selects an “OK—Give me the Snickers® Bar!” button displayed on a touch screen input/output device, the candy is dispensed, and the customers change is routed internally to a machine coin storage device rather than to a change dispenser). Further, input regarding a selection of at least one product from at least one inventory group (e.g., “Take any blinking green item instead of your change!”) may be required and received in any manner as discussed previously. In contrast, in some bonus benefit embodiments (e.g., wherein a game-themed presentation concludes in the presentation of a general benefit offer), a vending machine customer may provide further input so as to, e.g., reject a benefit offer (e.g., a customer presses a “No thanks—Just give me my change!” button).

In some bonus benefit embodiments, a general benefit comprising a vending machine product (e.g., provided for free or at a discount) may be dispensed via a product delivery system (e.g., a delivery bin or chute) in accordance with any distribution functions or dispensing mechanisms (e.g., dual helices) described herein and/or known in the art.

As stated, in other bonus benefit embodiments, a general benefit may comprise an opportunity to purchase one or more vending machine products at a discount during a later transaction (e.g., a benefit offer comprises a coupon printed via a vending machine output device). In such embodiments, before a corresponding product is provided for a discounted price, it may be necessary to validate a requested discount. Several methods for validating discounts (e.g., coupons) are contemplated and described herein. For example, a vending machine control system may first receive a “coupon identifier,” such as by (i) scanning a barcode of a physical coupon, (ii) receiving a numeric “coupon code” via an input device (e.g., external vending machine keypad), and/or (iii) receiving encoded information via a plastic card with a magnetic strip, etc. A vending machine control system may then (i) access a “coupon database” to determine if the identifier is valid (e.g., the code has been outputted but not yet redeemed), and if so (ii) make a record in the coupon database reflecting the redemption of the coupon, and/or (iii) enable that one or more corresponding products be purchased at a discount (e.g., for one transaction, the price of a corresponding product is reduced by a discount amount from full price to a sale price, a credit balance is increased by a discount amount).

Further, in an embodiment wherein a general benefit comprises a subscription, a corresponding product may only be provided if a customer's request to receive the product is valid (e.g., the customer has not redeemed every unit of Diet Coke® to which he was entitled per the terms of his subscription, the specific product requested by the customer is valid in light of the terms of the subscription). Subscription offers are described at length in Applicant's U.S. Pat. No. 6,298,972, entitled METHOD AND APPARATUS FOR ESTABLISHING AND MANAGING VENDING MACHINE SUBSCRIPTIONS, issued Oct. 9, 2001; U.S. Pat. No. 6,085,888, entitled METHOD AND APPARATUS FOR ESTABLISHING AND MANAGING VENDING MACHINE SUBSCRIPTIONS, issued Jul. 11, 2000; and U.S. Pat. No. 5,988,346, entitled METHOD AND APPARATUS FOR ESTABLISHING AND MANAGING VENDING MACHINE SUBSCRIPTIONS, issued Nov. 23, 1999. The entirety of each of these patents is incorporated by reference herein.

Still further, in an embodiment where a general benefit offer comprises a refund of payment rendered in purchasing at least one first selected product, the refund may be provided in any manner such that the purchase amount of a first selected product (e.g., $0.65) is returned to the customer (e.g., an inputted bill is returned via a bill validator, change is output via a change dispenser).

Still further, in embodiments wherein general benefit offers comprise non-food products or services not typically available for sale via the vending machine, such general benefits may be provided by any appropriate means. Methods of providing non-food product benefits may include, but are not limited to (i) a physical product (e.g., a phone card) is dispensed via a vending machine distribution function, (ii) a discount redeemable for a non-food product (e.g., a “10% off at The Gap” coupon with an accompanying redemption code) is provided via an output device (e.g., a printer), (iii) customer data is collected such that a free or discounted non-food product may be provided at a later time (e.g., in network embodiments, a customer fills in his contact information via a vending machine input device connected to a third-party Web site), and/or (iv) any other practical means.

In this manner, in light of profit management rules, restriction rules and various data, a general benefit offer may be indicated to a vending machine customer as the result of a game-themed presentation, and provided to the customer. Any processes, determinations, concepts and/or rules disclosed with respect to bonus benefit embodiments may be applicable to any other embodiments disclosed elsewhere herein.

Various additional or alternative embodiments may be included as well. Some of these embodiments ameliorate the potentially detrimental affect that game-theme presentations may have on multiple customers awaiting transactions with a vending machine.

In some embodiments, one or more sensory device may be utilized to detect one or more external vending machine conditions, such as (i) the length (e.g., measured in seconds) of one or more vending machine transactions, and/or (ii) the approximate number of customers waiting (e.g., in a line) to transact with a vending machine. For example, a sensor may comprise a motion, weight and/or infrared sensor equipped so as to detect the presence of a person in proximity to one or more vending machines (e.g., a customer standing substantially close to the front of a vending machine cabinet is detected by a vending machine sensory device).

In various embodiments, such sensory devices may be utilized in communication with a vending machine control system so as to alter a game-themed presentation (or characteristic thereof) in light of external vending machine conditions. For example, a vending machine sensory device may detect the formation of a long line at a vending machine, and thus (i) decrease the length of one or more game-themed presentations (e.g., rather than take five seconds to resolve, a prize wheel animation concludes immediately), (ii) eliminate the chance that a game result comprises a “free spin,” and/or (iii) reveal a benefit offer without first outputting a game-themed presentation. In this manner, a vending machine may be equipped to output game-themed presentations in a manner such that external vending machine “traffic conditions” are considered, thereby reducing the likelihood that prospective customers are discouraged from transacting with the vending machine (e.g., customers are not forced to wait in long lines as game-themed presentations are not substantially lengthy).

Various methods for detecting and marketing to prospective vending machine customers are described at length in Applicant's U.S. Pat. No. 6,324,520, entitled METHOD AND APPARATUS FOR COLLECTING AND APPLYING VENDING MACHINE DEMAND INFORMATION, issued Oct. 1, 1998, the entirety of which is incorporated by reference herein.

In another embodiment, an internal vending machine timer may be utilized to measure the time elapsed (e.g., in seconds) during one or more vending machine transactions. For example, an input device and/or sensory device may receive a signal indicating the “beginning” of a transaction (e.g., a customer inserts a dollar into a bill validator). Upon the receipt of such a signal, a vending machine processor may instruct a vending machine timer to begin measuring the time elapsed during the transaction. In some embodiments, should the length of a transaction meet or exceed a predefined threshold of time (e.g., thirty seconds or more), a vending machine may alter a game-themed presentation or result thereof (e.g., by outputting a shorter presentation, determining to offer a particular benefit as opposed to a selection of a product from an inventory group).

The “beginning” and “end” of a transaction may be represented by various events (e.g., a transaction begins when a weight sensor detects a customer in front of a machine, and ends when the weight sensor no longer detects the customer; a transaction begins upon the receipt of payment and ends upon the actuation of a dispensing mechanism). In this manner, a customer need not prevent further customers from transacting with a vending machine by unnecessarily lengthening a particular transaction (e.g., by taking too long to decide whether or not to accept a benefit offer, select a particular product from an inventory group, etc.).

In some embodiments, should situations arise wherein sensor-detected traffic” is light (e.g., few people walk past a vending machine), a profit management rule may indicate to output bonus benefits at a higher frequency (or benefits of greater perceived value), so as to entice more customers to transact with a vending machine. Additionally, it may be determined that such “low-traffic” periods are an ideal time for presenting “attraction sequences” via vending machine display devices (e.g., an LCD screen depicts a loop of a “sample” game-themed presentation so that it is viewable to passers-by).

In some embodiments, a vending machine control system may output a game-themed presentation to a customer who has not selected or purchased any product during the transaction (e.g., a first component product of a package deal or a first selected product of a single product vending machine). Such a game-themed presentation may indicate a determined benefit offer. For example, a vending machine control system may determine, in light of machine status data, general product data, benefit acceptance data and/or corresponding stored rules, to offer a free or discounted product (as described herein). Accordingly, a vending machine may (i) continually output game-themed presentations to prospective vending machine customers (e.g., when idle or not engaged in a transaction, a vending machine outputs game-themed presentations as “attraction sequences”), and/or (ii) output game-themed presentations upon the detection of one or more prospective customers (e.g., one or more sensory devices detects a favorable “traffic condition” or person in proximity to a machine).

In some embodiments, a vending machine may output instructions to customers (e.g., via a display device) for obtaining a chance to receive benefits without first purchasing one or more vending machine products (e.g., obtain a free spin of a prize wheel game). For example, a customer may be instructed to send a self-addressed, stamped envelope to a particular address requesting a free spin. In such an example, a physical game piece indicating a “game entry code” may then be sent to the customer, such that a customer may enter the code (e.g., via an external vending machine keypad) and receive a game result without first purchasing a vending machine product.

In some embodiments, a customer may be required to pay a fee (in addition to a purchase price of a product) in order to initiate a game. Such an embodiment is particularly suitable for profit-managed, non-package vending machines. Payment further could be requested at particular times, for example, after the customer tenders currency and selects a first item, the payment of a fee for a game could be a fixed price or dynamically-priced upsell (e.g., “Instead of your change, play a game to win one or more items!”. In another embodiment, a customer can play a game without (i) depositing currency and (ii) selecting at least one product provided they pay a fee. For example, a customer could be prompted to “Insert $0.25 to win a green item!”

In some product entitlement embodiments, wherein a customer may be entitled to receive a first component product and at least one additional component product of a 2-for-$1 package deal, a vending machine control system may output a game-themed presentation indicating (i) a specific first component product and a specific additional component product, and/or (ii) one or more inventory groups from which all component products may be selected. Such game results (i.e. product benefits) may be determined based on product data and profit management rules as described herein. In this manner, any or all component products of a package deal may be determined and presented to customers as the result of game-themed presentations as detailed herein.

In some embodiments, a game-themed presentation may incorporate various machine hardware or devices, including but not limited to (i) colored “product LEDs” corresponding to each row position of a vending machine (e.g., the shelf section underneath each product of a vending machine has both a green and a red LED corresponding to that particular product), (ii) digital price displays underneath each product of a vending machine (e.g., an LED price display underneath each product displays a price for that product, e.g., $0.65), and/or (iii) any other hardware, such as dispensing mechanisms, keypads, delivery bin doors, etc.

For example, a game-themed presentation may comprise a product LED “chasing sequence,” in which adjacent product LEDs may turn on and off sequentially (e.g., so as to create the illusion that LEDs are “chasing” each other), ultimately indicating a determined benefit as the game result (e.g., the sequence “stops” such that the LED under a particular product is lit). Such a game-themed presentation may additionally comprise a roulette theme (e.g., an LCD screen depicts an animated roulette wheel that spins while the product LEDs chase each other).

A bingo-themed game presentation may also incorporate product LEDs. As detailed previously, a vending machine output device (e.g., LCD screen) may display a bingo-themed animation that may reveal one or more row positions corresponding to a determined product benefit (e.g., an animated bingo ball depicts “A-1”). Accordingly, product LEDs corresponding to such identified row positions may be actuated in accordance with the presentation (e.g., the green LED for row position A-1 is lit).

A promotional price-themed game presentation may incorporate one or more digital pricing displays. For example, in an embodiment wherein a determined benefit is a transaction-specific discount for a particular product (e.g., a promotional price or fixed-price upsell), the digital pricing display, which may have previously been used to display the retail price (e.g., $0.65) of the corresponding product, may blink, light, animate and/or otherwise change so as to alert the customer to the new, discounted sale price (e.g., $0.50).

Such embodiments incorporating various devices (e.g., vending machine peripherals) may also be utilized in accordance with game-themed presentations indicating benefit offers comprising one or more inventory groups from which one or more products may be selected. For example, the result of a game-themed presentation may comprise a “green inventory group” from which one product may be selected (e.g., a green product LED underneath each product in the determined inventory group is actuated such that a customer may easily discern all products belonging to the inventory group). Further, in an embodiment where a machine's products can be divided into two inventory groups—“red” and “green”—the green and red spaces of a roulette wheel may be used to represent such groups during game-themed presentations (e.g., if an animation depicts a ball landing on a green space, a customer may select a product from the green group). Inventory groups are described in detail in Applicant's co-pending U.S. patent application Ser. No. 10/902,397, filed on Jul. 29, 2004, which is incorporated by reference herein for all purposes.

Additionally, various vending machine devices or hardware may be utilized for the purpose of receiving promotional codes, coupon codes and/or coupon identifiers discussed herein. For example, to activate a discount (e.g., provided as the result of a game-themed presentation during a previous transaction), a vending machine customer may input an alphanumeric code via an external vending machine keypad (e.g., “90A1B75”) in a known manner. Further, the first digit of such a code may be used to identify that a promotional code, and not a product selection, is being received (e.g., if a code is “90A1B75,” a vending machine processor may recognize that an input comprising the first digit “9” applies to receiving promotional codes and not product selections). U.S. Pat. No. 5,924,078, entitled CONSUMER-PROVIDED PROMOTIONAL CODE ACTUABLE POINT-OF-SALE DISCOUNTING SYSTEM, discusses methods of accepting promotional codes from customers using a point-of-sale keypad, and is incorporated by reference herein.

In some embodiments, various alphanumeric codes may be provided via one or more vending machine output devices (e.g., a code is printed on a coupon, displayed on an LCD screen, etc.). In other embodiments, a promotional code may be provided via various other devices. For instance, in one embodiment, a promotional code may be output and received in the following manner: (i) a vending machine display device prompts a customer with the message, “To receive your discount, just remember the following sequence of products,” (ii) several product LEDs may then actuate in sequence (e.g., an LED underneath Twix® candy bar product row blinks, followed by those for Snickers® candy bar and finally Mounds® candy bar), (iii) the customer remembers and later returns to the vending machine to input the sequence (e.g., by selecting icons representing the products via an LCD input/output device, inputting the row position identifiers of the products via a keypad), and (iv) the corresponding benefit (e.g., free product) is provided to the customer.

Additionally, in further embodiments, a game-themed presentation may result in the provision of a physical “game piece” to a vending machine customer. For example, a printer may output a paper “lottery ticket” or “bingo card” which a customer may use during a later transaction to potentially redeem one or more benefits. For instance, the customer may (i) return to a vending machine at a later time, (ii) input a “lottery ticket” (e.g., comprising a machine-readable barcode and human-readable “lottery numbers”), (iii) receive an indication of a determined benefit (e.g., an animation sequence portrays a lottery drawing and the result: “3 numbers correct! Take any green item at half price!”), and (iv) receive one or more determined benefits. In other embodiments, a game piece may require further action on behalf of a customer (e.g., a customer must first visit an operator-maintained Web site and input a code printed on the game piece before receiving a promotional code useable to redeem a benefit offer of one or more vending machines). In still further embodiments, a “scratch-off” game piece may comprise a description of a benefit offer and/or a redemption code that may not be visible to a customer until, for example, a latex-based material concealing such information is removed (e.g., the customer “scratches off” a concealed area with a coin).

In some embodiments, a vending machine customer may have the ability to influence the result of a game-themed presentation. For example, a customer may (i) command a spinning prize wheel to “stop” (e.g., by pressing a “Stop!” button of an LCD screen), (ii) choose to remove an object concealing a particular benefit offer when presented with more than one concealing object (e.g., when presented with “Door #1,” “Door #2” and “Door #3,” the customer selects “Door #2”; when presented with several squares or tiles in a grid, the customer selects one, as demonstrated by the embodiment of FIGS. 15 through 19), (iii) select specific lottery numbers, a particular bingo card, etc., (iv) partake in any game of skill (e.g., answering trivia questions, selecting an appropriate icon after it has been “shuffled” via an animation sequence, remembering the location of concealed icons such as in a “memory” game, etc.), and/or (v) command, input, or interact with a vending machine game-themed presentation in any way so as to influence the game result. In some embodiments, in accordance with stored data and profit management rules as described herein, a vending machine control system may determine a unique pool of potential benefit offers relative to such “customer influence” embodiments before outputting a game-themed presentation (e.g., such that when a customer “stops” a prize wheel, a particular determined benefit offer may still increase expected profitability as all sections of the prize wheel represent benefit offers determined in such a manner).

In other embodiments, a vending machine customer may be provided with the perception of influence over the result of a game-themed presentation, however the game result may be determined regardless of the customer's input or actions. For example, a customer may command an animated, spinning prize wheel to “stop,” providing the customer with the illusion that they have influenced the result of the game-themed prize wheel presentation, however the result may have already been determined (e.g., “Pick any green item instead of your change!”).

In one embodiment, a group of customers who live (or work, attend school, etc.) in proximity to one or more particular vending machines (e.g., residents of an apartment building, laborers in the same office complex, etc.) may work collaboratively toward a game result. For example, a vending machine LCD touch-screen may output a crossword puzzle game, wherein each customer may have an opportunity to enter a word. If the puzzle is solved completely before a certain deadline, each customer (or, e.g., resident) may be entitled to a discount or other benefit. Further, a particular customer might work cumulatively (e.g., tracked over the course of several vending machine transactions) toward solving a puzzle or achieving a certain game result.

In some embodiments in which customers influence game results through player skill, “high scores” or other player achievements may be output via a vending machine display device. In this manner, customers may enjoy the psychological benefit of their name or initials being displayed in association with a particular game achievement.

In some embodiments, a benefit may comprise an increase in a vending machine customer's credit balance (money available for making purchases). For example, if a customer approaches a single product vending machine and inputs payment of $0.55, a game-themed presentation may indicate a balance increase before a first product is selected (e.g., “Winner! $0.10 toward your purchase!”), such that a customer may purchase a more expensive item than planned.

Such balance increases may be determined in any manner detailed herein referencing stored data (e.g., machine status data) and associated profit management rules. In some embodiments, a customer may only use a balance increase in purchasing one or more vending machine products (e.g., during a specific transaction, else the balance increase is forfeited). In other embodiments, a customer may “cash out” such a balance increase (e.g., no purchase is required). In further embodiments, balance increases may only be redeemed for certain products (e.g., those determined by stored profit management rules referencing product data).

Further, in some embodiments, a benefit offer may comprise an opportunity for a customer to increase his balance by inputting currency (e.g., coins) of a particular denomination (e.g., as the result of a game-themed presentation, a customer may be presented with a benefit offer stating, “Double your money! Every dime you insert is worth $0.20!”). In some embodiments, such balance increases may only be redeemed for certain products (e.g., those determined by stored profit management rules referencing product data). Additionally, in other embodiments, the particular denomination of currency (e.g., dimes) may be determined by one or more rules referencing machine status data (e.g., a particular vending machine maintains an unacceptably low number of dimes in inventory; thus, a machine's inventory of dimes may increase as customers are motivated to input more of such a denomination than they otherwise would have).

In a still further embodiment, a customer may be provided with a benefit for depositing a certain amount of currency. For example, a customer may be provided with a benefit if a machine's credit balance is more than $20.00.

In some embodiments, a benefit offer determination may consider “customer data,” which may be recorded, stored and/or updated in a “customer database” in any manner detailed herein. For example, each customer of a vending machine may (i) partake in a registration process (e.g., performed at a vending machine or at an operator-maintained Web site), (ii) be assigned a unique alphanumeric customer identifier (e.g., “1285732”), (iii) be provided with a means for indicating the customer identifier to a vending machine (e.g., a customer may key in an alphanumeric code via an external vending machine keypad, swipe a plastic “customer card” comprising a magnetic stripe encoding the customer identifier), (iv) indicate the customer identifier before a particular vending machine transaction, and (v) be presented with various benefit offers based on the received identifier, customer data and stored “customer rules.” Customer data may describe various purchase behavior associated with one or more particular customer identifiers. For example, a customer rule may indicate that if a customer has purchased fewer than two items during the current fill period, a determined benefit offer should comprise a dynamically-priced upsell. In another example, a customer rule may indicate that if a customer has purchased more than one Diet Coke® soda during the current week, a determined benefit offer should comprise a coupon for Diet Pepsi® soda. In this manner, individual customers of a vending machine may be marketed to in a manner such that determined benefit offers may (i) more accurately reflect customer tastes, and thus (ii) have a higher probability of being accepted, thereby having a positive effect on expected profitability.

In some embodiments, after being presented with a benefit offer, a vending machine customer must first meet one or more further requirements (e.g., perform a specified task) before a benefit is provided. For example, in an embodiment wherein a benefit offer states, “Free Snickers® candy bar! Just enter your e-mail address!”, a customer must first provide his e-mail address (e.g., via a vending machine keypad, operator-maintained Web site, etc.) before being provided with a Snickers®(bar (the product benefit). In another embodiment, a customer must first purchase a certain amount of products from one or more vending machines before a benefit is provided (e.g., “Buy nine sodas, get the tenth free!”).

In some embodiments, game-themed presentations and the results thereof may be output via a display screen of a user device, such as a personal computer, PDA, cellular phone, an mp3 player (e.g., an iPod®), or the like. For example, a customer may use a personal computer to access a Web site maintained by a vending machine operator, elect to play a game and be presented with a benefit offer (e.g., as the result of an interactive game or game-themed presentation). In such embodiments, a benefit offer may comprise not only a description of the benefit, but also (i) a redemption code that must be keyed in to receive the benefit (e.g., 9-12345), and/or (ii) an identification of at least one particular vending machine at which the benefit must be redeemed (e.g., “The machine in the lobby of 5 High Ridge Park, Stamford, Conn., 06905”).

In some embodiments, a customer may signal via an input device to begin a game-themed presentation. Exemplary input devices of such embodiments include, but are not limited to buttons, keys, levers, biometric inputs and the like.

In some embodiments, various other output devices (e.g., flashing lights, spotlights, audio speakers, bells, whistles, etc.) may be actuated upon the output a one or more particular game results. In this manner, the excitement a customer may experience by winning a benefit may be enhanced (e.g., as lights flash and audio speakers emit an emphatic “Winner!” voice recording).

An embodiment of the invention includes a method comprising: retrieving, from a database, data that represents vending machine products; determining, based on the retrieved data, at least one benefit; outputting a presentation which indicates the at least one benefit, in which the presentation is output employing a game theme; and providing the at least one benefit.

C. “Jackpot” Style Prize Embodiments

In one embodiment of the invention, an operator, vending machine or computer associated therewith offers a chance at a jackpot style payout.

A jackpot style payout may entitle the customer to cash, vending machine credit (good for vended product) and/or vending machine products. For example, in one embodiment, a vending machine may output a prize amount on an LED or LCD screen (an output device 172). The screen may advertise the amount of the jackpot style payout that would be awarded to a winning customer. For example, a $1000 payout amount may be advertised. Or, a payout amount equal to $10 in machine credit may be advertised, enabling a winning customer to receive $10 worth of vended product. Further, a payout amount of 500 Snickers® candy bars may be advertised, where a winning customer would be awarded a subscription account having a balance of 500 units of Snicker's® candy bars.

It may be determined whether a customer may be awarded such a jackpot style payout (1) when a customer buys one or more products from the machine, (2) when a customer redeems an item in conjunction with a subscription account, and/or (3) at any other time as described herein.

In one illustrative embodiment, the vending machine 100 may offer a $500 jackpot that has a 1 in 10,000 chance of being won by the customer. According to one process, a vending machine may receive a payment tendered by a customer (e.g., the customer inserts money into the machine), and receive a selection of a product from the customer (e.g., the customer selects a product such as a chocolate candy bar). The vending machine may then dispense the selected item. A processor of the vending machine (or of an associated server) may then generate a random number, for example between 1 and 10,000. If that number matches a stored predetermined jackpot number (such as 575), a message may be output through an output device 172 (e.g., a display screen) indicating that the player has won the prize. A printer (i.e. an output device 172) then produces a receipt that the customer can then use to receive payment.

In some embodiments, the payment of a prize may be provided by a vending machine 100. It may be desirable to have vending machines facilitate the payment of lower value prizes (e.g., under $20). For example, every vending transaction may include a 1 in 100 chance at winning $5 in quarters dispensed directly from the hopper of the vending machine. Again, in one or more embodiments, payment may be made in the form of merchandise, such as free soft drinks or candy bars.

In some embodiments, payment may be facilitated by a server computer. For example, a customer may log onto a website, provide a number printed on the ticket, and the server computer may credit an account associated with the customer, such as a credit card account or subscription account.

In one embodiment, the probability that a customer receives a jackpot prize varies depending on any of a number of factors, including but not limited to vending machine sales, profits, etc. For example, the probability of winning the top jackpot may be 1 in 10,000 if the actual sales rate of one or more products is less than or equal to the ideal sales rate for one or more products, and the probability may be reduced to 1 in 12,000 if the actual sales rate of one or more products is less than or equal to the ideal sales rate for one or more products. By way of another example, the probability of hitting the top award may be 1 in 10,000 if sales for the day are under 25 units (or $25), but 1 in 8,000 if sales for the day are over 25 units (or $25). In another embodiment, the probability of a prize payout increases as sales per hour increase. In calculating the sales per hour, one or more additional vending machines in a nearby location or regional area may be included.

Instead of sales levels or rates of sales, the probability could instead be affected by whether the vending machine had achieved a particular profit goal at a particular point in the sales cycle. For example, the probability of the machine awarding a prize to a customer may increase if profit targets have been earned early in a sales cycle. In an alternative embodiment, the probability of winning a prize changes based on the time at which the customer makes his vending purchase. For example, the probability of being awarded a top prize may be highest during off peak hours for the vending machine such as between midnight and 8:00 AM. In this way customers may be encouraged to make off peak transactions, resulting in fewer lines for product during peak time periods such as during a lunch hour at an office park.

In yet another embodiment, the product purchased may impact the probability of receiving a prize payout. For example, purchasing a product which has a relatively high margin and/or which contributes a certain amount or percentage to overall machine profitability (a “margin contribution” factor or percentage) may result in a larger chance of winning a prize, while purchasing a product with a lower margin and/or margin contribution may result in a relatively smaller chance of winning a prize.

In yet another embodiment, the probability may be impacted by the type or character of payment tendered by a customer. Thus, in one embodiment, the probability may be impacted by the denomination of bill or coin inserted by the customer. For example, larger denomination bills or coins might result in higher probabilities of achieving a large payout. In another embodiment, the probability of winning a jackpot prize may be increased should the customer tender cash or coin denominations that are depleted or are in short supply. For example, as discussed with reference to Applicant's co-pending U.S. Provisional Patent Application US2004/016895, entitled METHOD AND APPARATUS FOR MANAGING VENDING MACHINE OFFERS (the entirety of which is incorporated by reference for all purposes), a vending machine or controller may determine that based on historic transaction data, there is not likely sufficient working capital stored at a vending machine (e.g., coin reserves stored in a hopper) to make appropriate change for every anticipated customer throughout the remainder of a fill period. As such, customers paying exclusively with coins (rather than cash) may benefit through the greater probabilities afforded to such tendering customers. In some embodiments, customers paying in particular coins that are in short supply (e.g., dimes) may benefit from greater odds of winning a payout.

Prizes may also be deterministically set, rather than randomly determined. For example, every 100th purchase may result in a prize payout. Alternatively, every 20th purchase of a particular product may result in a prize payout. In yet another embodiment, a prize payout is made only after a certain combination of products is purchased, such as the purchase of a bag of chips, followed by a bag of pretzels, followed by a candy bar, followed by a pack of gum. Only after this exact sequence is achieved is the prize payout made. And once the payout is made, another product combination may be determined that is different from the first. Such sequence-based embodiments provide operators with a way to promote trial of many different products.

In one embodiment, a vending machine may have more than one prize payout level. For example, the machine may offer prizes of $5, $25, and $100. Each of these prize payouts may have an associated probability of occurrence. By multiplying the prize payouts by the associated probabilities, an expected value for each prize may be determined. The following is a sample table, Table 14, of such an embodiment:

TABLE 14

| Payout Amount | Probability | Expected Value |
|---|---|---|
| $100 | .0001 | $.01 |
| $25 | .0005 | $.0125 |
| $5 | .004 | $.02 |

Various prize structures may be developed with differing expected values. For example, payout structures may include “small”, “top weighted”, and “normal.” The small structure may allocate a larger expected value to the lower payouts, while the top weighted structure may allocate more of the expected value to the higher payouts. In a normal structure, a more balanced approach is taken to allocating the expected value more evenly over each of the three payouts. In embodiments with multiple payout levels, one or more payout levels may be activated or deactivated based on actions at the vending machine. For example, the $100 top payout may be deactivated if the customer purchases a product with cash. For electronic money transactions or subscription account redemptions, the $100 prize is activated. Such an embodiment may encourage customers to utilize those payment methods that allow operators, vending machines and/or computers associated therewith to more readily track purchase patterns, transmit promotional communications (e.g., via email), and the like. Alternatively, a payout (e.g., a $100 payout) may be deactivated if sales for that machine are currently running higher than expectations.

For embodiments with multiple payout levels, the vending machine may have data storage capability to correlate payout levels with sales activity of the machine. The operator, vending machine and/or controller may thus experiment with many different payout levels (and associated expected values) to determine which levels result in the greatest boost to machine sales and/or profits. In other words, the promotional value or effect of different payout levels may be tested so that the level which achieves the greatest sales and/or profits may be implemented in one or more vending machines. Such experimentation could be done at a stand-alone vending machine, or be done by a central server controlling a network of vending machines. Processes for testing promotions and propagating successful promotions throughout a network of vending machines is disclosed with reference to Applicant's U.S. Pat. No. 6,230,150, the entirety of which is incorporated by reference herein for all purposes.

In some embodiments, printed reports could be generated by a vending machine (and picked up by a route operator) which indicate how much prize money was being distributed compared to the contribution margin from product sales over that same period.

In some embodiments, prize money awarded by a vending machine may be determined in a pari-mutuel manner, rather than generating a random number for each transaction as described above. For example, the vending machine may have a fixed $100 budget for prize money over a month. Each vending transaction eams the customer a code which may be entered into an online website. At the end of the month, a drawing is held from all of those codes submitted by vending customers. A code number is selected (e.g., randomly) and the corresponding customer is then awarded the $100. In this way, the amount of money paid out by the vending machine is kept fixed over a period of time. Such an embodiment would mitigate the chance that a number of customers will get lucky and win a substantial amount of money which may in fact even exceed (for a period of time) the sales or profits of that machine. In another embodiment, the drawing is done when the machine is filled with new product. Further, in one or more embodiments, a vending machine may periodically (e.g., weekly; at the end of each fill period) output results of a drawing through an output device, such as an LED screen, so that customers may see publicly which code is the winning code. Such an embodiment may encourage customers to congregate around a vending machine just prior to restocking, increasing the chances that customers will purchase any remaining products from the vending machine before it is restocked.

Prize money (for a fixed budget prize or otherwise) may come from a number of sources. For example, third parties (such as product manufacturers) may provide some or all of the prize money (in exchange for promotion of their products). Alternatively, the operator may provide the funding in the hopes of increasing machine sales. Funding may also come from transactions, such as by applying 3 cents from each transaction toward a prize pool. In fixed budget prize pools, the amount of the prize pool may start at a predetermined positive level (such as $50) so as to ensure that a customer always has a chance to win a relatively meaningful amount.

In embodiments in which large prize payouts are made, the amount of the payout may be made over a period of time. For example, instead of paying out $1,000 in a single lump sum payout the amount may be paid as $100 each month for a period of ten months.

In another embodiment, the amount of the prize payout is unknown to the customer even after it is awarded. For example, the customer might win a payout of 3 cents for each transaction made by that machine over the next month. At the end of the month, the amount of the payout is determined and payment is made to the customer.

In one or more embodiments, the amount contributed towards the prize pool may be based on the margin of a product and/or the degree to which the product contributes to the vending machine's overall profit (“margin contribution”). For example, products with relatively high margins may contribute towards a prize pool in greater magnitude (e.g., $0.10 per unit sold; 40% of margin), while producs with relatively low margins may contribute towads a prize pool in relatively lesser magnitute (e.g., $0.05 per unit sold; 20$ of margin).

Thus, in some embodiments, the amount of the top prize payout increases over time. For example, it might start at a level of $200 and then increase by 3 cents for each vending transaction completed. In this way, customers may be excited by an ever-increasing prize. The vending machine could have a display (e.g., an LED screen) devoted to showing the current amount of the prize level, such as $236.12. After the next transaction, the prize level would increase to $236.15. When a customer triggers the win of the prize, the prize level display then resets to the $200 level and begins incrementing again by 3 cents for each competed transactions. In an alternative embodiment, the prize level increases by 4% of the retail price of each transaction or 20% of the margin of each transaction.

In additional embodiments, a group of vending machines are networked such that they share a top prize level. Each machine may contribute 3 cents of each transaction into the top prize pool, with each transaction having a 1 in 50,000 chance of winning the top prize. In this manner, a much larger prize payout amount may be supported since many machines are contributing to the prize pool. An additional benefit of this embodiment is that the top payout increases incrementally at a given vending machine even if that particular vending machine has not had any recent transactions. A customer sees a constantly increasing top prize amount since many machines are currently contributing 3 cents per transaction.

In embodiments in which the top prize amount is funded by contributions from a number of networked machines, there are a number of ways in which the prize level may be communicated throughout all machines on the network. For example, the vending machines could be wirelessly networked to a central server that continuously transmits the current prize level. When a customer wins the top prize, a reset signal is sent out to each vending machine on the network so that each machine can reset the payout level to the starting value.

In another embodiment, prize levels are updated in a batch process once per day at a predetermined time (e.g., 3:00 AM). A central server stores the number of transactions that occurred in the previous 24 hours, multiplies this by 3 cents per hour to determine the top prize increment, adds the increment to the previous day's closing prize value, and transmits this new value to each vending machine on the network. These vending machines may then update a display screen each day to show the new prize level. Alternatively, the vending machines may increment the prize level throughout the day by an amount that reflects a typical day's transactions. For example, if a typical day generates 800 transactions in the vending network then the machines may increment by $24 (800×3 cents/transaction) or $1 per hour. Alternatively, the increment for the day may be based on the previous day's vending transactions.

In embodiments in which a prize payout amount increases over time, the rate at which the prize level increases may not necessarily remain constant. For example, the rate may begin at 3 cents per transaction and then drop to 2 cents per transaction after the prize level reaches a predetermined amount (e.g., $1,000). Alternatively, the prize increment rate may increase from 3 cents to 4 cents per transaction whenever the top prize has not been awarded for more than one month.

In any of the above embodiments, there are many ways for a customer to be awarded a chance to receive a prize payout. For example, a random number may be determined (and prize awarded for a match) whenever the customer buys a product, buys a particular product, buys more than one product, establishes a subscription, inserts a bill into the bill validator, buys a product using a code (e.g., a subscription identifier) or other electronic payment system, watches a promotional video, answers questions about a product, and the like. Customers may also be provided with the opportunity to request a chance to win the top prize by sending in a self-addressed postcard to a central location, or going to a website to electronically request a free entry. Such an alternate form of entry may be required in some jurisdictions when the customer is required to buy a product in order to receive a chance at winning a prize.

In some embodiments, the vending machine may be equipped with a display device capable of showing a broad range of prize information. For example, the names of past prize winners at that machine may scroll across an LED display at the top of the vending machine. In a multi-machine vending network, the location of vending machines which have paid out significant prizes may be displayed. Information about how much time had progressed since the last large payout could also be displayed. A display screen could also show photos of past winners, with photos either uploaded by customers to a central server or taken at the vending machine by a built-in camera.

V. Revenue Management Embodiments

Some embodiments may be associated with various revenue management considerations of a vending machine. Jackpots and/or jackpot qualifications or probabilities thereof, for example, may be determined based at least in part on revenue management metrics of one or more vending machines. Examples of some such revenue management considerations are detailed below, as incorporated from commonly-owned and co-pending U.S. patent application Ser. No. 10/902,397, filed on Jul. 29, 2004.

Various embodiments, including products and processes, are disclosed for facilitating the sales of combinations of units of products. The disclosed embodiments are particularly suitable for use in one or more vending machines or like apparatus.

According to an embodiment, a vending machine or other apparatus is configured to increase sales and/or profitability through novel processing of sales data, cost data and/or other data available to the vending machine.

In particular, various embodiments allow groups of products to be defined according to various criteria. Customers are prompted to purchase products from the groups. Thus, appropriate definition of the groups can lead to benefits such as increased profits per time.

According to a “proactive inventory grouping” embodiment of the present invention, on a periodic, substantially continuous or event-triggered basis, sales and/or cost data is monitored and evaluated against stored rules for the purpose of determining how to apportion inventory among at least two inventory groups from which, pursuant to a package offer, a customer may select and purchase at least two products for a single price. In determining how to apportion inventory to the different inventory groups, a vending machine may consider a value rating of one or more products. For example, products having a relatively high value rating may be allocated to a first inventory group, while products having a relatively low value rating may be allocated to a second inventory group. Thereafter, package offers encouraging the purchase of at least two products (e.g., at least one product from each of at least two inventory groups) may be output to prospective customers through one or more output devices. For example, a scrolling light emitting diode (LED) display may read “Pick any item from the red group and any item from the green group for $1.00!”, and shelf-mounted LED displays located adjacent to the various qualifying products may contemporaneously flash in red and/or green to indicate the products' inventory grouping statuses (i.e. green or red). The vending machine may be further configured to process package offer transactions in accordance with such advertised package offers by (i) receiving, through an input device, an indication of customer acceptance and (ii) dispensing a combination of products consistent with the advertised package offer.

According to a “reactive inventory grouping” embodiment, a customer is offered the ability to purchase a combination of products for a single price by the customer selecting a first product from a first group of inventoried products, and then the customer picking a second product from a second inventory group that is revealed to the customer after the first product is selected. In determining which inventoried products will be included in the second inventory group, a vending machine may consider a value rating of one or more products.

Further, according to some embodiments, a value rating of one or more products may be determined by considering one or more of (i) the time remaining until a restock date, (ii) the time remaining until an expiration date of a product or products, (iii) an actual sales rate of a product or products, (iv) a target or ideal sales rate of a product or products, (v) the cost of a product or products, (vi) the retail price of an individual unit of a product or products, (vii) the profit margin of a product or products at a given sale price such as the retail price, (viii) the historical acceptance rate of package instance comprising a given combination of products, and/or (ix) one or more products' income or profit contribution factor(s) (e.g., measures of one or more products' historic success in the marketplace).

A. Package Offer Rules and Execution Thereof

1. General Description

Applicants have recognized many effects that, when exploited according to many disclosed embodiments, can significantly increase the profit per time period realized by a vending machine. Applicants have recognized that by, for example, selling products at a lower margin, but at a higher velocity or volume, the overall profitability of a vending machine can be increased. Accordingly, in some embodiments, the vending machine may define, output and process package offers enabling customers to purchase a combination of products (from one or more vending machines) for a single price.

By encouraging the sale of at least two products (particularly for a single price, for a discounted price, or with a single payment) according to various disclosed embodiments, both vending machine operators and customers can benefit.

As customers are encouraged, through package offers, to purchase more products than they otherwise would, operators can benefit through increased sales volume. Operators further can benefit from the increased profitability (e.g., per time period, per transaction, per customer interaction) that results when such increases in sales volume sufficiently offset any discount from the packaged products' individual retail prices. Additionally, operators may economically configure machines to accept alternative payment forms that have higher transaction costs (e.g., credit cards) than conventional payment forms (e.g., cash) because of the higher per-transaction revenue and profit that results from selling combinations of products. Such alternate payment forms can prompt customers to spend more than they would have spent otherwise.

Customers can benefit through (i) the net-savings that often results when package prices are compared to the sum of the individual component products' retail prices, and/or (ii) the added convenience gained from the ability to purchase several products in a single transaction. Further, as vending machines may be configured to economically offer alternate payment forms, customers may benefit from the flexibility provided by an increased number of payment options.

2. Process Steps of Various Embodiments

According to some embodiments, a memory stores instructions that, when executed by a processor, direct a vending machine or other apparatus to identify, output and/or process package offers.

Several embodiments of advantageous processes are described below to illustrate the wide breadth of the disclosed invention. Many of the embodiments below are described as being performed wholly by a vending machine. However, it will be readily apparent to one of ordinary skill in the art that these processes may be performed, in whole or part, by a vending machine, by components of a vending machine, and/or by a device in communication with a vending machine.

Further, although the description herein refers to a vending machine as dispensing units of products, a plurality of vending machines may cooperate to provide units of products. Typically, more than one vending machine may be employed to provide units of different types of products (e.g., a first vending machine which sells snack food and a second vending machine which sells carbonated beverages).

Although one or more embodiments are described herein as enabling the sale of packages comprising two component products, it should be understood that package offers may provide for the sale of any number of component products, including three, four and five component products.

According to one embodiment, a vending machine defines at least one inventory group, which includes at least two products that are available for sale by the vending machine. For example, the vending machine may define an inventory group that includes three specific products (e.g., Snickers® candy bar, Milky Way® candy bar and Twix® candy bar). The vending machine may define an inventory group by storing appropriate data in a database or other memory structure. For example, the Table 16 immediately below discloses one manner of defining an inventory group.

TABLE 16
Example Definition of an Inventory Group

| Inventory | Products Included |
|---|---|
| Group Identifier | in the Inventory Group |
| G001 | P34 |
| G001 | P35 |
| G001 | P17 |
| G001 | P22 |

In the Table 16 above, the group identified by code “G001” includes the four products identified by codes P34, P35, P17 and P22, respectively. One of ordinary skill in the art will readily understand any other ways to define an inventory group.

In an embodiment, an inventory group may include one or more products. Furthermore, in an embodiment, a product may be included in more than one group. Furthermore, in an embodiment, a product may be included in no group.

For example, in an embodiment, the vending machine defines at least two inventory groups, and each of the at least two inventory groups includes at least one respective product that is available for sale.

As described in detail herein, there are many ways to advantageously determine which products are included in which groups.

According to an embodiment, the vending machine outputs an indication of products that the at least one inventory group includes. For example, in an embodiment the vending machine may control an output device to communicate (e.g., to a potential customer near the vending machine) the products that the at least one inventory group includes. When there is more than one inventory group, the vending machine may output, for each of the inventory groups, an indication of products that the respective inventory group includes.

If employed, an output device may comprise a flat panel monitor, cathode ray terminal (CRT), liquid crystal display (LCD) or a like device that displays text and/or images (e.g., still graphics, animated graphics) as directed by the vending machine (e.g., that a group includes “any candy bar” or “anything in the top row”). Alternatively or additionally, the output device may comprise an audio output device such as a speaker that is operated by the vending machine to output the appropriate sounds (e.g., synthesized sound, pre-recorded sound), typically verbal instructions/offers to potential customers. Sounds may be output with reference to one or more data files (e.g., wave tables, MP3 files).

Alternatively or additionally, the output device may comprise a plurality of colored lighting devices (e.g., LEDs, light bulbs, LCD panels), in which each colored lighting device is located proximate to one product column. The vending machine could selectively illuminate the plurality of colored lighting devices to indicate the products that a particular inventory group includes. For example, each product column may have proximate thereto a pair of LEDs, each a different color (e.g., red and green respectively). To indicate the products that a first inventory group includes, the vending machine could illuminate only the red LEDs that are proximate to the product columns of those included products. To indicate the products that a second inventory group includes, the vending machine could similarly illuminate the appropriate green LEDs.

Several variations may be readily made to the above-described method for indicating an inventory group. For example, each product column may include more than two LEDs. Similarly, each product column could include a single LED that is capable of displaying more than one color, or otherwise indicating more than one inventory group, as directed by the vending machine.

In an embodiment, the products that are included in an inventory group may be indicated by any means for denoting product columns. For example, a sticker, sign, flag or the like could be applied to certain product columns to indicate that the products of that column are included in an inventory group.

In an embodiment, the products that are included in an inventory group may be indicated by any means of communicating product information to a customer. For example, a sign (e.g., located atop a vending machine) or advertising (displayed or communicated to the customer in any manner whether or not proximate to the vending machine) may inform a customer that an inventory group includes, e.g., all products of a certain type (e.g., candy bars, snack food, Mars® products), all products of a certain location (all products in the top row of the vending machine, any product from the right hand vending machine of a connected pair of vending machines, any product in any machine on the fourth floor of a building) and/or certain products by name (e.g., a Snicker's® candy bar).

In some embodiments, the indication of inventory groups may be advantageously combined with the provision of an offer to the customer. For example, the vending machine may provide, to the customer, an offer to sell to the customer, for one predetermined price, (i) at least one unit of any product that is included in a first inventory group, and (ii) at least one unit of any product that is included in a second inventory group.

As is well known, offers may be output via many types of devices, such as via a flat panel monitor, cathode ray terminal (CRT), liquid crystal display (LCD) or a like device that displays text and/or images as directed by the vending machine (e.g., that a group includes “pick any candy bar and any beverage”). Alternatively or additionally, the output device may comprise an audio output device such as a speaker that is operated by the vending machine to output the appropriate sounds (e.g., synthesized sound, pre-recorded sound), typically verbal instructions/offers to potential customers. Sounds may be output with reference to one or more data files.

In an embodiment, an offer may be provided by any means for communicating information to a customer. For example, a sign (e.g., located atop a vending machine) or advertising (displayed or communicated to the customer in any manner whether or not proximate to the vending machine) may include an offer to sell to the customer, for one predetermined price, (i) at least one unit of any product that is included in a first inventory group (e.g., all candy bars), and (ii) at least one unit of any product that is included in a second inventory group (e.g., all products in a second vending machine).

The offer may be provided at various times. For example, the offer may be provided in response to receiving payment or receiving any input (e.g., a touch screen has been pressed). Alternatively or additionally, an offer may be provided after receiving a first selection of a product but before receiving a second selection of a second product.

The offer is particularly enticing, and thus is more likely to be accepted, if the offer provides the customer with a discount or other benefit. For example, the vending machine could provide, to the customer, an offer to sell to the customer, for one predetermined price, (i) one unit of any product that is included in a first inventory group, and (ii) one unit of any product that is included in a second inventory group. The predetermined price could reflect a discount over the retail prices of the component products. In other words, the predetermined price could be less than the sum of (a) a price of one unit of any product that is included in the first inventory group, and (b) a price of one unit of any product that is included in the second inventory group.

An “acceptance” of an offer may include payment and/or selection of product(s) which correspond to the offer.

According to an embodiment, the vending machine may receive from a customer (whether or not in response to an offer) a selection of a first product that the at least one inventory group includes. For example, the vending machine may indicate that all candy bars are included in a first inventory group, and a customer may in response indicate that select a Snickers® candy bar (which the first inventory group includes).

In an embodiment, the vending machine may receive, from a customer, a selection of (i) a first product that one of the inventory groups includes, and (ii) a second product that another one of the inventory groups includes.

In such an embodiment, the selection of products may be received simultaneously (e.g., “pressing a single button”). Alternatively, the vending machine may receive, from the customer, a first selection of a first product, and then a second selection of a second product.

As is well known, selection of products may be made in many ways. Customers may press certain combinations of buttons (e.g., “A1” indicates a particular product column, so the customer may press an “A” button and then press a “1” button on the vending machine). Such buttons may be physical buttons (e.g., composed of plastic and appropriately in communication with a processor of the vending machine). Such buttons may additionally or alternatively be “soft buttons” (e.g., graphically displayed on a touch-screen device, and responsive to pressure resulting from the customer pressing the appropriate areas of the touch screen). Many other ways of selecting one or more products are readily understood by one of ordinary skill in the art.

According to an embodiment, the vending machine may process a sale of (i) a unit of the first product selected by the customer, and (ii) a respective unit of at least one additional product, for a single price. In processing the sale, the vending machine will typically await sufficient payment, dispense the appropriate units of the appropriate products, and/or provide change if any change is due the customer.

The at least one additional product may have been explicitly selected by the customer, for example, by pressing appropriate buttons that indicate the additional product(s). Additionally or alternatively, the at least one additional product may have been selected “for” the customer in various manners. For example, the at least one additional product may be a product which is, by default, added to an order by a customer. In another embodiment, the at least one additional product may be offered to a customer (“would you like a stick of gum for an extra ten cents?”) and “selected” by the customer when the customer accepts the offer (e.g., pressing an “OK” button).

According to an embodiment, the vending machine may process a sale of a unit of the first product and a unit of the second product upon receiving from the customer one payment of at least a predetermined price. For example, the vending machine may receive from the customer a single payment (e.g., a dollar bill is inserted, a credit card account is charged) which constitutes the predetermined price. Alternatively, the vending machine may receive from the customer a single payment which exceeds the predetermined price. The vending machine would typically provide change to the customer in such a situation.

In addition to the features and embodiments described above, it is highly advantageous to define inventory group(s) according to various processes and/or utilizing various information. Accordingly, many embodiments for defining inventory groups are described in detail immediately below.

B. Proactive Inventory Grouping Embodiments

In “proactive inventory grouping” embodiments, various data (e.g., product sales data, product cost data) may be employed to determine how to apportion inventory among inventory groups (typically at least two inventory groups) before a customer selects any product. After the apportioning of products to inventory groups is complete, package offers encouraging the purchase of at least two products from at least two inventory groups may be output by a vending machine to prospective customers.

Of course, steps performed in a proactive inventory grouping embodiment does not imply that those steps may only be performed in a proactive inventory grouping embodiment.

A proactive inventory grouping process by which one or more inventory groups are each defined to include one or more respective products may be initiated periodically, substantially continuously or after an event (e.g., a transaction, a restocking, a power-up). It can be desirable that customers throughout each day will receive the same ability to purchase products from the same inventory groups (e.g., one customer will not be offered the ability to select products from a more or less favorable inventory grouping than that which was provided to another customer that day). Thus, in embodiments where the process is initiated periodically, it may be desirable to set the time interval between process executions (i.e. defining inventory groups) so that the process is executed at convenient times (e.g., every 24 hours starting at midnight).

Alternatively or additionally, in embodiments where the process is executed after a triggering event such as a transaction with a customer, it may be desirable that the process is initiated a number of minutes after a transaction, when no intervening transaction has been processed (e.g., the process is initiated 30 minutes after a transaction, provided no intervening transaction has been consummated). In this manner, it may be safe to assume that the machine is experiencing a lull in sales, and that customers accordingly may not witness any change of inventory groupings/apportionments (i.e. a customer is unlikely to walk up to the machine and witness any reallocation of inventory from a “red” group to a “green” group).

According to one proactive inventory grouping embodiment, which is illustrated by FIG. 2, the illustrated proactive inventory grouping process functions to, among other things, allocate products available for sale to inventory groups based on (1) the relative value ratings of the products, and (2) stored rules for determining, among other things, whether products should be included in package offers. A description of the steps of FIG. 2, which provides a flow chart for such a proactive inventory grouping process, follows:

1. Step 100: Determine Value Rating of Each Inventoried Item.

At Step 100, the vending machine may determine a value rating of products by, for example, accessing an inventory database to determine, among other things, products in inventory and characteristics thereof.

The value ratings of products may be used to determine the products which various inventory groups include. For example, each product that a first inventory group includes may have a rating that is not less than a rating of any product that the second inventory group includes. As another example, a first inventory group may include a certain portion of the highest rated products (e.g., the products with the five highest value ratings; the highest 50%, by value rating, of all products).

The Table 17 immediately below describes an example inventory database:

TABLE 17
Example Inventory Database

| | | | | | | Quantity | | | | |
|---|---|---|---|---|---|---|---|---|---|---|
| | | | | | | at | | | | |
| | Row | | | | | Beginning | | | Actual | Ideal |
| Product | Position | Product | Retail | | | of Fill | Quantity | Restock | Sales | Sales |
| Name | Identifier | Category | Price | Cost | Margin | Period | Remaining | Date | Rate | Rate |
| Coca- | A1 | Beverage | $.75 | $.35 | $.40 | 20 | 8 | Jun. 30, 2003 | 1.2/day | 1.3/day |
| Cola ® | | | | | | | | | | |
| Diet | A2 | Beverage | $.75 | $.30 | $.45 | 20 | 6 | Jun. 30, 2003 | 1.4/day | 1.3/day |
| Coke ® | | | | | | | | | | |
| A&W | A3 | Beverage | $.65 | $.35 | $.30 | 20 | 9 | Jun. 30, 2003 | 1.1/day | 1.3/day |
| Root | | | | | | | | | | |
| Beer ® | | | | | | | | | | |
| Doritos ® | B1 | Snack | $.50 | $.30 | $.20 | 25 | 11 | Jun. 30, 2003 | 1.4/day | 1.6/day |
| Lay's ® | B2 | Snack | $.75 | $.30 | $.45 | 25 | 7 | Jun. 30, 2003 | 1.8/day | 1.6/day |
| Potato | | | | | | | | | | |
| Chips | | | | | | | | | | |
| Cheetos ® | B3 | Snack | $.60 | $.30 | $.30 | 25 | 17 | Jun. 30, 2003 | 0.8/day | 1.6/day |
| Double- | C1 | Chewing | $.35 | $.20 | $.15 | 40 | 18 | Jun. 30, 2003 | 2.2/day | 2.6/day |
| Mint ® | | Gum | | | | | | | | |
| Juicy | C2 | Chewing | $.35 | $.20 | $.15 | 40 | 23 | Jun. 30, 2003 | 1.7/day | 2.6/day |
| Fruit ® | | Gum | | | | | | | | |
| Dentyne ® | C3 | Chewing | $.40 | $.20 | $.20 | 40 | 36 | Jun. 30, 2003 | 1.1/day | 2.6/day |
| | | Gum | | | | | | | | |

As the above inventory database (Table 17) illustrates, for each product, a corresponding product category, retail price, cost, margin, quantity at the beginning of the fill period, quantity remaining as of the current date/time, restock date, actual sales rate and ideal sales rate. The data stored by such a database may be entered by an operator (e.g., who restocks the vending machine), determined by the vending machine with its peripheral devices (e.g., data indicating that a product has been sold, that an amount of money has been received), set randomly, and/or calculated from available data (e.g., other data stored by the inventory database or another database).

The exemplary data in the above inventory database assumes that the beginning of the fill period was Jun. 15, 2003, and that the current date is Jun. 25, 2003 (i.e. 10 days into the fill period). Further, the exemplary data in the above inventory database will be referred to throughout the remaining discussion of this process to illustrate steps of the example proactive inventory grouping embodiment in which the value rating of individual products are considered. For the purpose of this ongoing example, it shall be assumed that a package offer to a customer will define two products which may be purchased together for $1.00, in which one product is included in a first (“green”) inventory group, and one product is included in a second (“red”) inventory group.

At Step 100, a value rating is determined for each inventoried product. There are many ways that value ratings could be represented and many ways that value ratings could be determined.

A value rating may be represented as a numerical quantity, a set of numerical quantities (e.g., a vector, a matrix), or any other quantity that may be used for purposes of comparison and/or evaluation. A value rating may also be qualitative, such as “high”, “medium”, or “low”. In one or more embodiments, the value rating of one or more products may be determined by considering one or more of (i) the time remaining until a restock date, (ii) the time remaining until an expiration date of a product or products, (iii) an actual sales rate of a product or products, (iv) a target or ideal sales rate of a product or products, (v) the cost of a product or products, (vi) the retail price of an individual unit of a product or products, (vii) the retail profit margin of a product or products when sold for the retail price, (viii) the historical acceptance rate of a package instance comprising a given combination of products, and/or (ix) one or more products' income or profit contribution factor(s).

Thus, a value rating may be determined using a formula in which any of the above criteria (i) through (ix) may serve as variables. For example, in one embodiment, a value rating is determined by identifying a product's retail profit margin (as determined by subtracting the product's cost from the product's retail price). For example, following the exemplary data in the above inventory database, the vending machine control system would determine that a Diet Coke® soda has a margin of $0.45. The value rating of each product margin may be that product's margin, some proportion of the margin, or some other variation of the margin.

In another embodiment, value ratings may be determined by multiplying a product's margin by its actual sales rate expressed as a percentage of the product's ideal sales rate. By using a product's actual sales rate as a basis for predicting future sales, the vending machine control system can determine the likelihood (e.g., as a percentage) that the particular product will sell at the product's ideal sales rate. In turn, by multiplying this percentage by the product's margin, a value rating can be determined. (Note, however, at the beginning of a fill period, a vending machine may determine a product's sales rate to be zero, as no sales data for that period has yet been collected, or may determine the product's sales rate based on data obtained from a prior fill period.) The table immediately below illustrates such an embodiment in the context of the ongoing example. In the illustrated embodiment, the value rating of each product (as described above in the inventory database) is calculated by multiplying each product's margin by a percentage that reflects the product's actual sales rate divided by the product's ideal sales rate:

TABLE 18
Values calculated based on Actual and Desired Sales Rates

| | | | | Actual Sales | |
|---|---|---|---|---|---|
| | | | | Rate as | |
| | | | Ideal | percent of | |
| | | Actual Sales | Sales | ideal sales | Value |
| Product | Margin | Rate | Rate | rate | Rating |
| Coca-Cola ® | $.40 | 1.2/day | 1.3/day | 92% | $.37 |
| Diet Coke ® | $.45 | 1.4/day | 1.3/day | 107% | $.48 |
| A&W Root | $.30 | 1.1/day | 1.3/day | 85% | $.26 |
| Beer ® | | | | | |
| Doritos ® | $.20 | 1.4/day | 1.6/day | 88% | $.18 |
| Lay's ® Potato | $.45 | 1.8/day | 1.6/day | 113% | $.51 |
| Chips | | | | | |
| Cheetos ® | $.30 | 0.8/day | 1.6/day | 50% | $.15 |
| Double-Mint ® | $.15 | 2.2/day | 2.6/day | 85% | $.13 |
| Juicy Fruit ® | $.15 | 1.7/day | 2.6/day | 65% | $.10 |
| Dentyne ® | $.20 | 1.1/day | 2.6/day | 42% | $.08 |

In various embodiments, products can be scored, sorted and/or ranked based on their relative value ratings, and such data can be stored in RAM pending Step 200, below, at which point the scoring, sorting and/or ranking may be considered in the allocation of products to inventory groups. Thus, following the ongoing example (in which the value rating of each product in the above inventory database was calculated by multiplying each product's margin by its actual sales rate as a percentage of its ideal sales rate), inventoried products can be sorted in descending order based on their relative value ratings, as illustrated by the table immediately below:

TABLE 19
Values calculated based on Actual and Desired Sales Rates

| | | | | Actual sales | |
|---|---|---|---|---|---|
| | | Actual | | rate as percent | |
| | | Sales | Ideal Sales | of ideal sales | Value |
| Product | Margin | Rate | Rate | rate | Rating |
| Lay's ® Potato | $.45 | 1.8/day | 1.6/day | 113% | $.51 |
| Chips | | | | | |
| Diet Coke ® | $.45 | 1.4/day | 1.3/day | 107% | $.48 |
| Coca-Cola ® | $.40 | 1.2/day | 1.3/day | 92% | $.37 |
| A&W Root | $.30 | 1.1/day | 1.3/day | 85% | $.26 |
| Beer ® | | | | | |
| Doritos ® | $.20 | 1.4/day | 1.6/day | 88% | $.18 |
| Cheetos ® | $.30 | 0.8/day | 1.6/day | 50% | $.15 |
| Double-Mint ® | $.15 | 2.2/day | 2.6/day | 85% | $.13 |
| Juicy Fruit ® | $.15 | 1.7/day | 2.6/day | 65% | $.10 |
| Dentyne ® | $.20 | 1.1/day | 2.6/day | 42% | $.08 |

In embodiments where value ratings of products are determined based on profit contribution factors, such products might be ranked or sorted according to their relative profit contribution percentages. For example, if a vending machine which sold only products A, B and C during a fill period realized a total of $100 in profit, $45 of which was generated through the sale of product A, $40 through product B and $15 through product C, then the products would be sorted in the order of A (45% of the total profit), B (40% of the total profit) and C (15% of the total profit). Further, in some embodiments, only those products that remain in inventory (i.e. are available for sale) at the time when Step 100 is executed are considered in the ranking or sorting, and thus, in the subsequent allocation procedure of Step 200, which defines one or more inventory groups.

2. Step 200: Determine Allocation of Products to Inventory Groups Based on Value Rating Determination and Stored Rules.

The value rating associated with each product may be used in assigning products to inventory groups.

In one embodiment, an inventory group may define a given number of component product “slots”, or a designated number of products that may be allocated to that inventory group. In other words, an inventory group is defined in part according to how many products the inventory group should include.

For example, a vending machine may be configured to have two inventory groups, such as “green” group and “red” group, in which the red group has three component product slots and the green group has six component product slots. Thus a customer might be offered to select one component product from the three red slots (i.e. select one product from three possible products) and one component from the six green slots (i.e. select one product from six possible products). The slots of a group may be “filled” according to value ratings of products. For example, the five products having the highest profit contribution factors may be allocated to the “green” inventory group, and the six with the lowest profit contribution factors may be allocated to the “red” inventory group. As described above, two or more groups may include the same product, and no group may include certain products. Thus, where a green group includes five products and a red group includes six products, there may be eleven products available for sale, or more or less than eleven.

In another embodiment, a predetermined percentage of the products (or of only the products which are available for sale) may be allocated to each group so that, for example, 50% of the products will be allocated to the “red” group and the remaining 50% of products will be allocated to the “green” group. In particular, it can be advantageous to allocate similar products to a group. For example, the top 50% (by value rating) of products are allocated to one group, and the remaining products are allocated to another group.

In another embodiment, all products having a value rating over a certain threshold (e.g., over $0.25) may be placed in a particular inventory group (e.g., in the “red” inventory group).

Each inventory group may be associated with a rule (e.g., a stored value rating-based allocation rule) defining the products that are allocated to the inventory group. For example, in an embodiment where three component product slots are “red” and six component product slots are “green”, a profitability-based allocation rule may provide that (1) the three inventoried products having the highest value ratings are to be allocated to the “red” inventory group, and (2) the six inventoried products having the lowest value ratings are to be allocated to the “green” inventory group. Thus, continuing with the ongoing example, Lay's® Potato Chips, Diet Coke® and Coca-Cola® would be allocated to the red inventory group; and A&W Root Beer®, Doritos®, Cheetos®, Double-Mint®, Juicy Fruit® and Dentyne® would be allocated to the green inventory group. Accordingly, a package offer may provide that a customer may purchase one product from the red group and one product from the green group for $1.00.

In an alternate embodiment, rather than having a fixed number of inventory slots or a percentage-based division of products among inventory groups, the number of slots in each inventory group may be determined randomly and/or pursuant to a genetic algorithm, whereby a given slot configuration is tested randomly and evaluated against other configurations.

Further, a set of package offer rules may also be employed in determining how to allocate products to different inventory groups. An exemplary Package Offer Rules Database is represented by the Table 20 immediately below:

TABLE 20
Package Offer Rules Database

| Package | |
|---|---|
| Offer Rule | |
| Number | Rule |
| 1 | Products from “beverage” category cannot be in same |
| | inventory grouping as products from |
| | “chewing gum” category. |
| 2 | Total margin of package instance based on $1.00 package |
| | price cannot be equal to or less than 50% of the sum |
| | of the individual component products' margins. |
| 3 | Do not allocate to inventory groups those products selling |
| | at ≧110% of target sales rate. |
| 4 | Cheetos ® must be both in red and green inventory groups |

Although rules may be represented as being stored in a database for reference, such rules may be implemented in an wide variety of manners, such as (i) “hard coded” into software and/or hardware, and (ii) coded in software/hardware with reference to parameters which are stored in a database or other memory structure.

As illustrated, a database may provide one or more rules that govern the allocation of products to inventory groups, whether or not with reference to the value ratings of the products. The exemplary data in the above database of Table 5 depicts several rules. For example, as demonstrated by Package Offer Rule Number 1, a package offer rule may provide that products from certain categories may or may not be packaged with products from other categories. Such a rule may be desirable to ensure that only certain combinations of products are offered and/or so that certain combinations of products are not offered. For example, it may be decided (e.g., by an operator) that certain products complement each other, as may a beverage and a snack. Conversely, it may be decided (e.g., by an operator) that certain products should not be included in a package offer (e.g., as in Package Offer Rule Number 1, “beverages” cannot be included in package offers with “chewing gum”). Products that are affected by such rules (e.g., whether a product is a “beverage”) can be determined by appropriate notation or data stored in an inventory database. For example, all products that are “beverages” can be indicated as such by a flag in the corresponding record of the product. Alternatively, the rule which refers to beverages can in fact directly refer to a specific plurality of products (e.g., each identified by a respective product code).

Further, as demonstrated by Package Offer Rule Number 2, a package offer rule may provide that the total margin of a package instance, based on a given package price, cannot be equal to or less than a certain percent of the sum of the individual component product's margins (based on their respective individual retail prices).

Similarly, a package offer rule may provide that the total margin of a package instance, based on a given package price, cannot be less than the margin that would result from a sale of the individual products at their retail prices, unless a threshold volume of sales (e.g., as measured by units sold, or units sold per time period) for one or more of the component products is likely to be achieved. Such a rule may be desirable to ensure that any discounts offered by way of package offers are sufficiently offset by an increase in sales volume. For example, by requiring that a certain package instance have a certain historic acceptance rate, operators can rest assured that a discount offered for the products by virtue of a package price that is less than the sum of the component products' individual retail prices will not likely result in a decrease in profits.

Further still, a package offer rule may provide that products selling above or below a given actual sales rate may or may not be included in certain inventory groups (or in any inventory group). For example, Package Offer Rule Number 3 illustrates a rule that provides that a product having an actual sales rate above a certain threshold is not to be included in inventory groups (e.g., t any inventory group which might be used in a package offer). Such a rule can be useful in preventing price dilution that may otherwise result when very popular products are sold on promotion through package offers. As is known, price dilution generally involves the negative effect on profitability that can ensue when a product is sold for a price lower than a customer otherwise would have paid for the product.

Some embodiments can reduce or eliminate the effects of dilution that may otherwise result when package prices are less than the sum of the individual component products' retail prices. In other words, because very popular products are highly likely to sell at their current retail prices, it may be decided (e.g., by an operator) that very popular products should not ever be sold at a discount, even for purposes of promoting the sale of additional (relatively less popular) products through package offers. Alternatively, it may be desirable to package together only products having actual sales rates above a certain threshold with products having actual sales rates below a certain threshold. In this manner, an operator may attempt to leverage the popularity of a given product to sell additional, relatively less popular products.

Further still, an inventory group may be defined to include a particular set of products based on what product the customers first selects (e.g., if product A1 is selected, then the second inventory group is defined to include products B1, B2 and B3).

Moreover, a rule may provide that particular products are to be included in some, all or no inventory groups. For example, Package Offer Rule Number 4, above, illustrates an example rule that requires Cheetos® to be included in both green and red inventory groups, regardless of value rating.

Thus, continuing with the ongoing example, the table immediately below illustrates the effect of Package Offer Rules 1, 3 and 4 on the inventory group allocations:

TABLE 21
Effect of Package Offer Rules

| | | | | | Preliminary | | |
|---|---|---|---|---|---|---|---|
| | | | | | Inventory | | |
| | | | | | Grouping | | |
| | | | | | (i.e. | Inventory | Relevant |
| | | | | Actual | before | Grouping | Package |
| | | | | Sales | application | after | Offer Rule |
| | | | | Rate as | of | considering | (from |
| | | | | percent of | Package | Package | Package |
| | Product | Retail | | ideal sales | Offer | Offer | Offer Rule |
| Product | Category | Price | Margin | rate | Rules) | Rules | Database) |
| Lay's ® | Snack | $.75 | $.45 | 113% | Red | None | 3 |
| Potato | | | | | | | |
| Chips | | | | | | | |
| Diet | Beverage | $.75 | $.45 | 107% | Red | Red | N/a |
| Coke ® | | | | | | | |
| Coca- | Beverage | $.75 | $.40 | 92% | Red | Red | N/a |
| Cola ® | | | | | | | |
| A&W ® | Beverage | $.65 | $.30 | 85% | Green | None | 1 |
| Root Beer | | | | | | | |
| Doritos ® | Snack | $.50 | $.20 | 88% | Green | Red | N/a |
| Cheetos ® | Snack | $.60 | $.30 | 50% | Green | Green, | 4 |
| | | | | | | Red | |
| Double- | Chewing | $.35 | $.15 | 85% | Green | Green | N/a |
| Mint ® | Gum | | | | | | |
| Juicy | Chewing | $.35 | $.15 | 65% | Green | Green | N/a |
| Fruit ® | Gum | | | | | | |
| Dentyne ® | Chewing | $.40 | $.20 | 42% | Green | Green | N/a |
| | Gum | | | | | | |

As shown, Package Offer Rule 3, which functions to prevent packaging of products which have sales rates greater or equal to 110% of their target sales rates, precludes the inclusion in any package offer of Lay's® potato chips, which has an actual sales rate of 113% of its target sales rate. Further, pursuant to Package Offer Rule 4, Cheetos® are allocated to both the red and green inventory groups, despite the initial value rating-based allocation of Cheetos® solely to the green inventory group. Additionally, considering Package Offer Rule 1, A&W Root Beer®, a beverage, cannot be included in the green inventory grouping because chewing gum products preliminarily exist in the green inventory grouping as a result of the above-illustrated allocation based on value rating.

Thus, without yet considering Package Offer Rule 2, the possible combinations of component products (i.e. the package instances) are illustrated in the table immediately below:

TABLE 22
Possible Combinations

| Product 1 | Product 2 |
|---|---|
| Diet Coke ® | Cheetos ® |
| Diet Coke ® | Double-Mint ® |
| Diet Coke ® | Juicy Fruit ® |
| Diet Coke ® | Dentyne ® |
| Coca-Cola ® | Cheetos ® |
| Coca-Cola ® | Double-Mint ® |
| Coca-Cola ® | Juicy Fruit ® |
| Coca-Cola ® | Dentyne ® |
| Doritos ® | Cheetos ® |
| Doritos ® | Double-Mint ® |
| Doritos ® | Juicy Fruit ® |
| Doritos ® | Dentyne ® |
| Cheetos ® | Cheetos ® |
| Cheetos ® | Double-Mint ® |
| Cheetos ® | Juicy Fruit ® |
| Cheetos ® | Dentyne ® |

However, considering Package Offer Rule 2, which provides that the total margin of a package instance based on a $1.00 package price cannot be equal to or less than 50% of the sum of the individual component product's margins, it becomes apparent that the package instance where Coca-Cola® and Cheetos® are purchased together for the package price of $1.00 violates Package Offer Rule 2. The table immediately below shows, for each potential instance in the ongoing example, whether or not that package instance violates Package Offer Rule 2:

TABLE 23
Violation of Package Offer Rule 2

| | | | | | | | | Total | | |
|---|---|---|---|---|---|---|---|---|---|---|
| | | | | | | | | Margin | | |
| | | | | | | | | of | | |
| | | | | | | | | Package | Sum of | |
| | | | | | | | | Instance | Product 1 | |
| | | | | | | | | at | Margin | |
| | | | | | | | | $1.00 | at | |
| | | | | | | | | Package | Retail | |
| | | | Product 1 | | | | Product 2 | Price | Price + Product 2 | Violates |
| | | | Margin | | | | Margin | (i.e. | Margin | Package |
| | Product 1 | | at | | Product 2 | | at | $1.00 − (Cost | at | Offer |
| | Retail | | Retail | | Retail | Product 2 | Retail | Product1 + Cost | Retail | Rule |
| Product 1 | Price | Product 1 Cost | Price | Product 2 | Price | Cost | Price | Product2) | Price | 2? |
| Diet | $.75 | $.30 | $.45 | Cheetos ® | $.60 | $.30 | $.30 | $.40 | $.75 | No |
| Coke ® | | | | | | | | | | |
| Diet | $.75 | $.30 | $.45 | Double- | $.35 | $.20 | $.15 | $.50 | $.60 | No |
| Coke ® | | | | Mint ® | | | | | | |
| Diet | $.75 | $.30 | $.45 | Juicy | $.35 | $.20 | $.15 | $.50 | $.60 | No |
| Coke ® | | | | Fruit ® | | | | | | |
| Diet | $.75 | $.30 | $.45 | Dentyne ® | $.40 | $.20 | $.20 | $.50 | $.65 | No |
| Coke ® | | | | | | | | | | |
| Coca- | $.75 | $.35 | $.40 | Cheetos ® | $.60 | $.30 | $.30 | $.35 | $.70 | Yes |
| Cola ® | | | | | | | | | | |
| Coca- | $.75 | $.35 | $.40 | Double- | $.35 | $.20 | $.15 | $.45 | $.55 | No |
| Cola ® | | | | Mint ® | | | | | | |
| Coca- | $.75 | $.35 | $.40 | Juicy | $.35 | $.20 | $.15 | $.45 | $.55 | No |
| Cola ® | | | | Fruit ® | | | | | | |
| Coca- | $.75 | $.35 | $.40 | Dentyne ® | $.40 | $.20 | $.20 | $.45 | $.60 | No |
| Cola ® | | | | | | | | | | |
| Doritos ® | $.50 | $.30 | $.20 | Cheetos ® | $.60 | $.30 | $.30 | $.40 | $.50 | No |
| Doritos ® | $.50 | $.30 | $.20 | Double- | $.35 | $.20 | $.15 | $.50 | $.35 | No |
| | | | | Mint ® | | | | | | |
| Doritos ® | $.50 | $.30 | $.20 | Juicy | $.35 | $.20 | $.15 | $.50 | $.35 | No |
| | | | | Fruit ® | | | | | | |
| Doritos ® | $.50 | $.30 | $.20 | Dentyne ® | $.40 | $.20 | $.20 | $.50 | $.40 | No |
| Cheetos ® | $.60 | $.30 | $.30 | Cheetos ® | $.60 | $.30 | $.30 | $.40 | $.60 | No |
| Cheetos ® | $.60 | $.30 | $.30 | Double- | $.35 | $.20 | $.15 | $.50 | $.45 | No |
| | | | | Mint ® | | | | | | |
| Cheetos ® | $.60 | $.30 | $.30 | Juicy | $.35 | $.20 | $.15 | $.50 | $.45 | No |
| | | | | Fruit ® | | | | | | |
| Cheetos ® | $.60 | $.30 | $.30 | Dentyne ® | $.40 | $.20 | $.20 | $.50 | $.50 | No |

As shown in the above example, the package instance including Coca-Cola® and Cheetos® is impermissible according to Package Offer Rule 2. Thus, the vending control system may make an adjustment to the inventory group allocations so that Coca-Cola® is not offered with Cheetos®. Because, in this example, Rule 4 provides that Cheetos® must be included in both the green and red inventory groups, Coca-Cola® may be removed from the red inventory group so that Coca-Cola® cannot be selected by a customer along with Cheetos®, a green inventory product, pursuant to a package offer. Thus, in this ongoing example, Coca-Cola® would not be assigned to either inventory group. Accordingly, Coca-Cola® would not be included in an offer that is defined solely by inventory groups, and thus could not be selected by a customer as a component product pursuant to such a package offer.

Thus, after preliminarily allocating the inventoried products in the ongoing example to red and/or green inventory groups based on their relative value ratings and then considering all the package offer rules in the exemplary Package Offer Rules Database, the possible package instances, and the component products' inventory groupings in each instance, are shown in the table immediately below:

TABLE 24
Package Instances

| | Inventory | | Inventory |
|---|---|---|---|
| Product 1 | Grouping | Product 2 | Grouping |
| Diet Coke ® | Red | Cheetos ® | Green |
| Diet Coke ® | Red | Double-Mint ® | Green |
| Diet Coke ® | Red | Juicy Fruit ® | Green |
| Diet Coke ® | Red | Dentyne ® | Green |
| Doritos ® | Red | Cheetos ® | Green |
| Doritos ® | Red | Double-Mint ® | Green |
| Doritos ® | Red | Juicy Fruit ® | Green |
| Doritos ® | Red | Dentyne ® | Green |
| Cheetos ® | Red or Green | Cheetos ® | Green or Red |
| Cheetos ® | Red | Double-Mint ® | Green |
| Cheetos ® | Red | Juicy Fruit ® | Green |
| Cheetos ® | Red | Dentyne ® | Green |

3. Step 300: Output Package Offer.

According to the described embodiment, after the inventoried products have been allocated to the inventory group(s), the vending machine may output a package offer to customers via one or more output devices. For example, an LCD display may read “Pick one red product and one green product for $1.00!”, and LED displays located proximately to several products may illuminate or flash in red and/or green as determined by the inventory groups. Following the ongoing example, the LED displays located proximately to the following products would flash in red: Diet Coke®, Doritos®, and Cheetos®. Additionally, the LED displays located proximately to the following products would flash in green: Dentyne®, Cheetos®, Double-Mint® and Juicy Fruit®.

Many methods are contemplated for communicating offers via output devices. For example, in one embodiment, package offers may be communicated entirely through an LCD display (e.g., through digital icons representing the qualifying products). Alternatively, in another embodiment, a package offer may be communicated through a combination of static displays (e.g., painted or printed signage reading “Pick one red product and one green product for $1.00”) and LED displays located proximately to qualifying component products (e.g., LEDs next to qualifying products may flash in red and/or green as appropriate).

4. Step 400: Process Transaction in Accordance with Package Offer.

After a package offer is output to a customer, a customer may accept such a package offer. Accordingly, at Step 400, the vending machine may receive, through an input device, an indication of a customer's acceptance of a package offer. Such an indication may comprise the receipt of payment (e.g., currency, a payment identifier such as a credit card number) through payment processing mechanisms such as coin acceptors, bill validators and/or card readers.

In embodiments where a customer has prepaid for products, the “receipt of payment” for the offered products may comprise a command by the customer to redeem prepaid credit, units or the like. For example, the customer could enter, via a touch screen, a code which uniquely identifies his previous prepayment for a certain number of products (e.g., five units of any product, six units of any beverage). Additionally or alternatively, the prepayment could be evidenced by a magnetic strip card or bar code which is read by a peripheral of the vending machine.

Alternatively or additionally, an indication of acceptance of the offer may comprise a signal, received through an input device such as a keypad or touch screen, indicating that the customer desires to purchase a combination of products pursuant to a package offer (e.g., clicking a “YES” button on a touch screen).

In accordance with Step 400, a customer selects at least one product from each of at least two inventory groups. Thus, a customer may select a product from a first inventory group by inputting, into a keypad or touch screen, an indication of a product that the first inventory group includes (e.g., a “red” product). Following the ongoing example, a customer may select from the red inventory group either Diet Coke®, Doritos®, or Cheetos® by inputting into a keypad his or her selection of Row Position Identifier A2, B1 or B3, respectively. After the customer selects a first product from the first inventory group, the customer may be instructed to and the customer may indeed select a second product from a second inventory group. Following the ongoing example, a customer may select, from the green inventory group, Dentyne®, Cheetos®, Double-Mint® or Juicy Fruit® by inputting into a keypad his or her selection of Row Position Identifier C3, B3, C1 or C2, respectively.

In some embodiments, a default time for selecting the second product is provided such that if the customer does not select a second product from the second inventory group within the default time, the vending machine may (1) consummate the transaction as if the first selected product was purchased at its retail price by dispensing a unit of the product and providing change, if appropriate; (2) prompt the customer with a reminder message via an output device; or (3) automatically identify and dispense, as the second component product, a unit of a “default” product that the second inventory group includes (e.g., a stored rule may provide that the product in the second inventory group having the highest retail profit margin is automatically dispensed).

In some embodiments, if the customer does not select an appropriate second product but rather selects an inappropriate product (e.g., selects a product that is not allocated to the second inventory group), then the vending machine may output, through an output device, an error message prompting the customer to select a product from the appropriate (second) inventory group.

At Step 400 the vending machine may also process payment in a conventional manner such as by (i) detecting an amount that is deposited/rendered/provided, comparing that amount to a (package) price, and dispensing change due if appropriate, or (ii) requesting a credit authorization from a remote computer, such as a computer operated by a credit card transaction processing company (e.g., First Data Corp.).

Payment may have been previously rendered (e.g., $5 was previously paid for the right to purchase five pairs of products in the future). If so, and if the products pursuant to such prepayment are being redeemed in the transaction, many well known processes may be employed to debit the prepaid account for the redeemed products.

Further, at Step 400, depending on which products were selected by the customer, the vending machine control system may, in a manner known in the art, transmit one or more signals to a product dispensing apparatus to dispense the at least two products. In one embodiment, dispensing signals are sent to corresponding product dispensing actuators/motors after the customer selects all component products. In another embodiment, such dispensing signals are sent to corresponding product actuators/motors substantially immediately after each component product is selected, so that products are made available immediately following selection.

5. Step 500: Record Results in Database.

At Step 500, the vending machine records results of the transaction in a database or similar memory structure. Step 500 may include the step of (1) updating one or more inventory records in an inventory database to reflect the vending of products (i.e. the quantity available of products sold is decreased to account for sales of units of the products), and/or (2) updating an acceptance or sales rate associated with a product or products to reflect the sale of a product or products (e.g., recording the units sold, the time of the sale and/or the date of the sale). Following the ongoing example, assuming that a customer on Jun. 25, 2003 purchased, for a $1.00 package price, one can of Diet Coke® and one package of Double-Mint® gum, then the above inventory database would be updated to reflect that five units of Diet Coke® and seventeen units of Double-Mint® gum remain in inventory and available for sale. Likewise, the actual sales rates of Diet Coke® would be updated from 1.2/day to 1.3/day; the actual sales rate of Double-Mint® gum would be updated from 2.2/day to 2.3/day. Thus, through the package promotion, Diet Coke® would have reached its ideal sales rate of 1.3/day, and the actual sales rate of Double-Mint® gum would have moved significantly closer to its ideal sales rate of 2.6/day.

Updating inventory amounts and sales rate data advantageously provides the vending machine with updated market data (e.g., supply and demand data) that can be fruitfully exploited in subsequent executions of the processes of various embodiments. In other words, such updated inventory amounts and sales rates can be referenced subsequently by the vending machine control system in subsequently making definitions of inventory group (see Steps 100 and 200, supra).

C. Reactive Inventory Grouping Embodiments

In “reactive inventory grouping” embodiments, a customer is offered the ability to purchase a combination of products for a single price by selecting a first product from a first group of inventoried products, and then picking a second product from a second inventory group which is revealed to the customer only after the first product is selected.

Such an embodiment can be desirable because it can provide customers with an entertaining way of interacting with a vending machine. In other words, because in this embodiment the second inventory group is not revealed to the customer until a first product is selected, customers may experience feelings of hopeful anticipation until such a second inventory group is revealed. This feeling may be analogous to the excitement and exhilaration some customers receive when gambling or playing a chance-based game.

Thus, in some embodiments, game-themed messages may be output through the one or more output devices prior to the revealing of the second inventory group, thereby incorporating a game-like feel into the customers experience with the vending machine. In other words, in some reactive inventory grouping embodiments, output devices may be configured to output game-themed animations, such as spinning slot machine reels, roulette wheels, or the like, before a second inventory group is revealed to the customer. Accordingly, such machines can present customers with the appearance that a (randomly determined) resolution or outcome of a game determines the products which the second inventory group includes. In this manner, the second inventory group may be presented as a “prize showcase” from which customers may select a prize.

Further, in some embodiments, reactive inventory grouping may be less computationally intensive or otherwise require less computing resources than, e.g., certain types of proactive inventory grouping, and accordingly can be more desirable to some vending machine operators (particularly in certain hardware environments).

1. Step 100: Output Package Offer.

At Step 100, the vending machine outputs a package offer to the customer regarding the availability of a package deal. For example, an LCD display may output a message reading “Pick 2 items for $1. Pick any item, and then a group of items will flash. Pick any flashing item as your second item.” Alternatively, such a message may be provided through a static means (e.g., painted or printed signage).

2. Step 200: Receive Customer Selection of First Product from First Inventory Group.

At Step 200, the vending machine control system receives, via one or more input devices, a signal indicating a customers selection of a first product, and that product is determined to be included in a first inventory group. In some embodiments, this step may be accompanied or preceded by payment processing steps, including the receipt of currency.

According to some embodiments, the selection of a product by a customer may be determined to not be included in the requisite inventory group. If so, then subsequent steps of the instant process might not be performed.

According to one embodiment, the first inventory group may comprise all inventoried products. Thus, according to such an embodiment, a customer may select any product in inventory as the first product. Thus the product selected might make no difference as to which products are included in the second inventory group.

However, according to another embodiment, the first inventory group may not include all products. In one embodiment, such a subset may be predetermined (e.g., defined by an operator and/or stored in a memory accessible to the vending machine control system). In another embodiment, the first inventory group may be determined (e.g., determined dynamically) to include products according to sale and/or cost data (and possibly stored rules or other logic mechanisms). Thus, for example, stored rules may provide that only those products selling at or less than a particular actual sales rate are to be included in the first inventory group. In this manner, the vending machine may be programmed to promote certain products in package promotions (e.g., upon selection of a product which is not selling as well as desired).

3. Step 300: Determine Second Inventory Group Based on Selection of First Product.

At Step 300, the vending machine defines a second inventory group based the customers selection of a first product. In some embodiments, the vending machine employs one or more rules (e.g., stored package offer rules) to determine which products are potentially eligible to be included in the second inventory group based on the first product (which was selected by the customer). For example, a package offer rule may provide that products from competing manufacturers cannot be purchased together pursuant to a package offer. Accordingly, the second inventory group would not include products which are manufactured by competitors of the manufacturer of the first, selected product. Alternatively or additionally, another package offer rule may provide that the second inventory group includes only products from categories that are “complementary” to the category of the first product. For example, if a customer were to select a beverage as his first product, the vending machine second group may only include products from the snack and gum categories.

Further, a package offer rule may provide that, if the first selected product's actual sales rate is above a certain threshold, only products selling at or less than a predetermined actual sales rate are to be included in the second inventory group. In this manner, vending machines according to various embodiments may exploit the popularity of a well-selling product to promote the sale of (relatively) less popular products.

Conversely, a package offer rule may provide that, if the first selected product's actual sales rate is below a certain threshold, only products selling above a predetermined actual sales rate are to be included in the second inventory group. In this manner, vending machines according to various embodiments may prompt customers to choose a less popular product in the hopes of a good deal on a more popular product, with an element of chance involved.

Alternatively or additionally, a value rating of each possible second product may be considered, as described above. For example, the vending machine control system may determine the value rating of one or more products and determine, based on stored rules, that only the five products having the highest value ratings may be included in the second inventory group. As in the case of the above-described proactive inventory grouping embodiments, the value rating of each possible second product may be determined, e.g., based on: (1) the product's margin, and/or (2) the product's margin multiplied by its actual sales rate expressed as a percentage of its ideal sales rate.

In an embodiment, the second inventory group may determined before the customer selects the first product, but the second inventory group is only revealed to the customer after the first product is selected.

In an embodiment, a plurality of second inventory groups may be determined. Thus, selection of a product included in any of the second inventory groups would be acceptable. Depending on which of the second groups the second selected products is included in, different actions may be taken (e.g., awarding bonus products or credits, providing entertaining displays or sounds). Thus an entertaining set of interactions can result from differentiating between acceptable second selections.

4. Step 400: Output Indication of Second Inventory Group to Customer Via Output Device(s).

After the second inventory group is determined, an indication of the products included in the second inventory group is output at Step 400 to the customer via one or more output devices. For example, LEDs located proximately to the products may illuminate or flash. Alternatively or additionally, an LCD may output graphical icons representing the qualifying products included in the second inventory group.

5. Step 500: Determine Whether Customer Selected Second Product from Second Inventory Group and Process Transaction Accordingly.

At Step 500, it is determined whether the customer selected the second product from the second inventory group. If the customer has selected a second product from the second inventory group by, for example, transmitting a signal to the vending machine processor via an input device such as a keypad, then the vending machine processor may actuate product dispensing apparatus to dispense units of the first and second selected products. (Alternatively, the vending machine control system may dispense a unit of the first product upon its selection at Step 200, and dispense a unit of the second product at Step 500 once it has been determined that the customer has selected a product from the second inventory group.)

In some embodiments, this step may be accompanied by payment processing steps, such as the receipt of payment and the dispensing of appropriate change (e.g., based on the difference between any payment tendered and the package price). It should be noted that such an embodiment would allow customers to select first products before depositing any currency, and then see which products are available as second products before committing to purchase any products whatsoever. In this manner, any anxiety caused to customers by virtue of the uncertain composition of the second inventory group can be reduced or eliminated.

In some embodiments, if the customer has selected a product that is not included within the second inventory group, the vending machine control system may output, through an output device, an error message. For example, an LCD may output a message that reads “Sorry, but the item you have selected is not eligible for the package deal. Please select a flashing item to continue or press “no thanks” to purchase your first selection at its retail price.”

In some embodiments, the vending machine control system may be configured to monitor the time starting, e.g., with a customer's initial selection of a first product. If the customer does not select a second product within a predetermined period of time, the vending machine may be configured to, e.g., consummate a transaction for the first product at its retail price, thereby assuming that the customer does not wish to select a second product from the second inventory group and accept a package offer.

Alternatively, at the end of such a predetermined period of time, the vending machine may automatically select and dispense a second product (e.g., a second product selected according to stored rules), and thereby complete a transaction at a package price. For example, stored rules may provide that the product in the second inventory group with the highest/lowest margin is automatically dispensed if no second product is selected within the predetermined period of time. Alternatively, stored rules may provide that the most/least popular product in the second inventory group (e.g., as indicated by its actual sales rate) is automatically dispensed if no second product is selected within the predetermined period of time.

If any products are dispensed at Step 500 (or earlier in the process, according to some embodiments), the vending machine may, as described above, record results of the transaction in a database or similar memory structure (e.g., update inventory records).

D. Miscellaneous Alternate and Additional Embodiments

1. Alternate Proactive Inventory Grouping Embodiment—Expected Profitability of Possible Allocations Considered

In another proactive inventory grouping embodiment, products are allocated to inventory groups based on the expected or predicted profitability of each possible “inventory allocation”. In other words, unlike the previously-described embodiments in which there are a predetermined or fixed number of product “slots” in each inventory group (e.g., per a stored rule), this embodiment allocates products to inventory groups by evaluating the expected profitability of each possible allocation of products (e.g., to at least two inventory groups).

For example, in a vending machine configured to sell four products (e.g., products A, B, C and D) in package deals from two inventory groups (e.g., red and green), in which all products are allocated to exactly one inventory group and an inventory group must contain at least one product, there are fourteen possible inventory allocations, as illustrated by the table immediately below:

TABLE 23
Allocations

| | Products in | Products in |
|---|---|---|
| Allocation | Red Group | Green Group |
| 1 | A | B, C, D |
| 2 | A, B | C, D |
| 3 | A, C | B, D |
| 4 | A, D | B, C |
| 5 | A, B, C | D |
| 6 | A, B, D | C |
| 7 | A, C, D | B |
| 8 | B | A, C, D |
| 9 | B, C | A, D |
| 10 | B, D | A, C |
| 11 | B, C, D | A |
| 12 | C | A, B, D |
| 13 | C, D | A, B |
| 14 | D | A, B, C |

As stated, the expected profitability of each possible allocation would be determined. Then, the vending machine control system would select the possible allocation with the highest expected profitability, and communicate a package offer accordingly. For example, if it was determined that Allocation 14 (in which product D is in the red inventory group and products A, B and C are in the green inventory group) is expected to be the most profitable, the vending machine may flash LEDs proximately located to each of the corresponding products in the appropriate colors to indicate that allocation of products to the two inventory groups.

There are many ways that the expected profitability of an allocation may be determined. According to one embodiment, the expected profitability of a given allocation may be determined by summing the expected profitabilities of each possible combination instance within that particular allocation. Thus, in the allocation in which product D is in the red inventory group and products A, B and C are in the green inventory group, the expected profitability for the instances “D with A”, “D with B”, and “D with C” would be individually determined and then added together to determine the total expected profitability of the allocation.

To determine the expected profitability of each instance within a given allocation, a variety of techniques may be employed. According to one embodiment, the expected profitability of a given instance is determined by multiplying the probability that the instance will be accepted within a given period (e.g., within 24 hours) by the margin of the package instance (e.g., the package price less the cost of the component products). In such an embodiment, the probability that a given instance will be selected may be determined based on a stored, received or calculated “acceptance rate” for the instance.

2. Multiple Package Offers in Proactive Inventory Grouping Embodiments

In some proactive inventory grouping embodiments, vending machines may be configured to simultaneously (or substantially simultaneously) output a plurality of package offers. Thus, after inventory groups are defined, the vending machine may output package offers that apply to the inventory groups. For example, for particular inventory groups, an offer may provide customers with the ability to choose which of the following to purchase:
(a) two products for a first inventory group for a first package price (e.g., two products from the “green” inventory group for $1.50),
(b) one product from a first inventory group and one product from a second inventory group for a second package price (e.g., one product from the green inventory group and one product from the red inventory group for $1.25), or
(c) two products from a second inventory group for a third package price (e.g., two products from the red inventory group for $1.00).

Any number of offers may be output simultaneously or substantially simultaneously.

In an embodiment, offers are not output simultaneously, but are instead triggered by an event. For example, a single offer may be output after a customer provides payment (e.g., inserts currency). If the customer does not select any product within a certain amount of time (e.g., within 20 seconds of inserting currency, within 20 seconds of the offer being provided) then additional offers may be provided. In such an embodiment, the initial offer may be the most profitable but possibly less desirable to the typical customer (e.g., a relatively high package price, high margin component products), and subsequent offers are less profitable, but more desirable to the customer (e.g., a relatively low package price, low margin component products)

In an embodiment, different sets of offers may be output at different times, according to various desirable factors described herein.

3. Alternative/Additional Ways to Present Package Offers

Many alternate or additional methods or formats for communicating package offers are contemplated.

In a proactive inventory grouping embodiment, a list of specific package instances could be output to customers via an output device, rather than (or in addition to) indicating the inventory grouping status of different products. For example, rather than merely outputting an offer that instructs prospective customers to select any “red” and any green” product for $1, a vending machine may also group certain package instances of “red” and “green” products and communicate the instances via an LCD display. Following the ongoing example from the above description of proactive inventory grouping embodiments (in which Diet Coke®, Doritos®, and Cheetos® were allocated to the red inventory group and Dentyne®, Cheetos®, Double-Mint® and Juicy Fruit® were allocated to the green inventory group), an LCD may output an offer visually representing a grouping of Diet Coke® with Dentyne®. Thus, rather than communicating all possible instances, only a certain number of instances may be shown through an LCD display (e.g., those with the highest or lowest historic acceptance rates). Further, package instances may be communicated through similarly colored LEDs. For example, a particular package instance comprising Diet Coke® and Dentyne® may be communicated by illuminating purple LEDs next to both Diet Coke® and Dentyne®, indicating that the products together comprise a single package instance.

In a proactive or reactive inventory grouping embodiment, customers may be offered the ability to purchase, for a package price, any combination of products whose retail prices total a certain sum. For example, customers may be offered the ability to purchase, for a $1 package price, any two products having a combined retail price of $1.30. Similarly, customers may be offered the ability to purchase any product having a first retail price (e.g., $0.85) and any product having a second retail price (e.g., $0.25) for a single package price (e.g., $1.00).

Further, in a proactive or reactive inventory grouping embodiment, certain (but not necessarily all) products that an inventory group includes may be given a visual preference (e.g., some red LEDs may flash at faster intervals than other red LEDs; some red LEDs may be illuminated brighter than other red LEDs, etc.). Thus, particular products included in an inventory group may be promoted over other products in the same inventory group. For example, products in an inventory group having a higher value rating may be indicated by brighter LED displays than products in that inventory group having a lower value rating. Alternatively, products that are selling at sales rates below a certain threshold may be indicated by brighter LED displays than products that are selling at sales rates above the threshold. This embodiment would help draw greater customer attention to products that are selling relatively poorly.

In yet another alternate embodiment, inventory groups are not dynamically determined (e.g., as in proactive or reactive inventory grouping embodiments), but are rather determined according to stored rules that govern which products may together comprise packages and which may not. For example, in an embodiment, a vending machine may be configured to allow a customer to pick three products for $1.00, provided that no two products are from the same shelf (row) of the vending machine. Thus, package offers may be communicated with fixed signs or other advertising on or around the shelves or the vending machine. In such embodiments, upon selection of a first product, a vending machine may prevent the selection and dispensing of certain products (e.g., products from the same shelf, row or category) as second products. Alternatively, a warning or other indication may be provided to the customer, and the customer allowed to select another product.

4. Cross-Machine Promotions

As stated, various embodiments can be configured to work in conjunction with two or more vending machines. Thus, according to some embodiments, pursuant to a package offer, customers may purchase two or more products for a single price, and may select and/or retrieve products from two or more vending machines.

Thus, a customer may view the inventory of two machines (which may be proximately-located), and may accept an offer output from a first machine or output from a peripheral device. The peripheral device may be stand-alone or integrated with one or more of the vending machines. The peripheral may communicate with one or more of the vending machines in nay of a number of well-known manners.

The vending machine or peripheral device may output a code, password, PIN, receipt or other substantially-unique identifier to the customer. This identifier may be redeemed at a participating vending machine, allowing the customer to retrieve products from one or more of the participating machines.

For example, after allocating inventoried products to at least two inventory groups spanning at least two machines using the above-disclosed methods, a first vending machine may output an offer reading “2 for $1! Select any flashing item from this machine AND any flashing item from the adjoining, machine for $1.” LEDs located proximately to the qualifying products may flash. A customer may then, after seeing the flashing products, decide to accept the package offer and deposit $1 into the first machine. The customer may then select a first product from the first vending machine, and the first vending machine may then output a (substantially-unique) bar code on a piece of paper (e.g., printed by an on-board printer, preprinted stock dispensed by a dispensing device). The customer could then be instructed, through the first vending machine's output device, to insert the piece of paper into a reader (e.g., ticket reader, bill acceptor, card reader, bar code reader) which is attached to or in communication with the second machine when the customer is ready to select his second product. Upon presenting the piece of paper (e.g., into the card reader), the second vending machine's processor would validate the code by querying either a local database (e.g., of previously agreed-upon codes) or a remote database (e.g., created and stored by the first machine). The second vending machine could then present to the customer the same inventory group as originally advertised at the time of the offer. Thus, the customer may return to select his second product at a later time (even after the second vending machines inventory has been reallocated to new inventory groupings), and the second vending machine could revert back to or recall the previous inventory grouping in effect at the time of the offer. This would allow the customer to select from the options that were originally presented to him (e.g., the products that were previously flashing in red are returned to red status upon presentment of the bar code identifier).

An apparatus and method for processing the sale of two products from two vending machines for a single price is disclosed with reference to U.S. Pat. No. 6,059,142 (to Wittern, Jr. et al.), the entirety of which is incorporated herein for all purposes.

5. Display of Retail Prices

In an embodiment, retail prices are not automatically communicated by output devices to customers. Instead, a customer must affirmatively inquire as to the retail price of a particular product. In this manner, customers are encouraged to accept package offers, which are actively promoted by the vending machine's output devices. However, in other embodiments, the retail prices of the individual products may be communicated contemporaneously with the presentation of package offers.

In an embodiment, customers may be permitted or required to select between various modes, such as “retail” and “package” modes, before transacting with the vending machine. That is, before selecting and purchasing any products, a customer may press a button on a touch screen or otherwise indicate whether the customer would like to (1) purchase a package (e.g., two products for $1.00), or (2) purchase one product for that product's retail price.

6. Opt Out of Inventory Groups for a Premium

In an embodiment, customers may be offered the option to pay a premium so that they can purchase two or more products from the same inventory group, rather than one from each. For example, a message on a vending machine's touch screen might read: Want two red items? Add $0.25.” In essence, such an embodiment would give the customer the ability to buy themselves out of the predefined inventory groups and would thereby ensure that customers are given more choice.

7. Periodic Random Allocation of Products to Inventory Groups

In an embodiment, one or more random products are allocated to inventory groups (periodically, after each transaction, at random times). This embodiment would tend to keep the inventory groups new and exciting for vending machines with many repeat customers (e.g., vending machines in office buildings). In such an environment, customers may tend to purchase the same products repeatedly. This embodiment thus may positively influence repetitive inventory grouping/allocation patterns.

8. Customers Offered Choice Between One or Two Products; Confirmation Screens

In an embodiment, vending machine transactions are limited to a certain price, and customers are given a choice between one higher price product, and two or more products from two or more inventory groups. For example, transactions may be limited to purchases of $1.25 and for $1.25 customers may purchase either (1) one (large) bottle of soda, or (2) two (small) cans of soda. Further, in an embodiment, vending machines may be configured to output “confirmation screens” in response to a customer's selection so that a customer must confirm her selection through an input device (e.g., a button) before such selections are accepted and the transactions are consummated.

9. Value-Back “Bonuses”

In an embodiment, customers who select two (or more) products as part of a given single-price package offer (e.g., two products for $5) may be offered a “bonus” (e.g., a third product) upon certain conditions (e.g., if certain rules are satisfied). Thus, in some embodiments, when customers select two (or more) products that together represent more than a threshold amount of realizable profit for the machine, such customers are offered a bonus that may be valued at an amount equal to, less than, or greater than the amount of additional realizable profit beyond the threshold amount. For example, if a customer selects two products from an inventory group typically associated with high-margin products, the machine may “give value back” to the customer in the form of a bonus, in order to bolster the goodwill with the customer and hopefully spur future transactions with the customer and favorable recommendations by the customer. Such an embodiment would work particularly well in situations in which a customer selects two products that having retail prices that, when aggregated, are less than the single package price. Thus, the vending machine would not take advantage of the customer's failure to realize the markup.

Bonuses may take many forms, including: (1) printed vouchers or tickets entitling customers to discounts (e.g., for the amount that surpasses the threshold amount) or free products from one or more vending machines in the future; (2) instant cash rebates (e.g., for the amount that surpasses the threshold amount; such amounts may be dispensed through change dispensing apparatus), and (3) extra product(s) (e.g., products which are valued at approximately the amount that surpasses the threshold amount) from the same vending machine or other vending machines.

In an embodiment, where appropriate (e.g., where one or more rules are satisfied, are not satisfied), bonuses may be selected by the customer. For example, the vending machine may output a message to the customer indicating that the customer may “select any additional ‘red’ flashing product”, and the customer's selection of a red product causes a unit of the red product to be dispensed. Further, a time limit may be imposed so that if the customer does not so select an appropriate product within a threshold amount of time (e.g., two minutes after the offer is presented), the vending machine may automatically issue a cash rebate, or provide no bonus.

In an embodiment, where appropriate (e.g., where one or more rules are satisfied, are not satisfied), bonuses may be communicated to customers through game-themed content or interface. For example, utilizing a “Price is Right®” game theme, customers may be given the opportunity to “spin” a “value wheel” for a bonus product by pressing a button on a touch screen. Once the customer has pressed the button, a wheel icon may be displayed as spinning on the touch screen, ultimately stopping on an indication of a bonus to be awarded (e.g., a particular product). Many other game themes are contemplated, including “Wheel of Fortune®”.

10. Subset of Inventory Considered in Allocation Process; “Rounded” Allocations

In an embodiment, the vending machine may only consider products placed in a single “column” or “shelf” of the vending machine when determining how to allocate products to inventory groups. For example, in a snack machine embodiment in which a vending machine has several shelves, products may happen to align in several columns. For example, a machine having four shelves, each capable of storing five products (i.e. ten helixes per shelf in a double helix snack machine), would have five columns. The operator may program the machine so that products stocked in the two rightmost columns are to be allocated to the “red” group, and that products stocked in the two leftmost columns are to be allocated to the “green” group. Thus, in such an embodiment, the vending machine would only determine (e.g., dynamically) how to allocate the inventory stocked in the center column to the different inventory groups (green and red).

The vending machine may determine, for example, that three of the five products in the center column are to be allocated to the “red” inventory group. In such embodiments, the vending machine may be further configured to allocate all products in the column to the group that dominates the column. That is, in this example, all products in the center column would be allocated to the red inventory group because a majority (three of the five) products in the center column were initially allocated to the red group. Such a “rounded allocation” may be desirable in some markets, as it would provide a convenient, user-friendly way to communicate inventory groupings to customers. That is, in such an embodiment, customers may easily see that all products on the right of the machine are “red”, while all products on the left of the machine are “green”.

11. Transaction Status Messages/Screens

In an embodiment in which customers are permitted to choose two or more products for a single price, one or more output devices may be configured to communicate the status of a transaction to a customer. For example, after a customer selects a first product, an indication of the first product may be communicated to the customer via an output device (e.g., an icon of the selected first product may appear on an LCD display). Further, instructions regarding the selection of a second product may be communicated through such output devices. That is, after a customer has selected a first product from a first inventory group, a message may be output to the customer instructing the customer to select a second product from a second inventory group. For example, after selecting a product from a first inventory group (e.g., a product on a first shelf; a product indicated by a “green” flashing light), the customer may be instructed to pick a product from a second inventory group (e.g., a product on a second shelf; a product indicated by a “red” flashing light).

12. Package Offer Row

In an embodiment, a vending machine may be configured dispense two (or more) products from a particular row or other particular location for a single price. Thus, a row of a vending machine may be designated as a “package offer” row, and the vending machine may be configured to consecutively dispense, from such a row, units of two (or more) products upon tender of a package price and selection of a corresponding row identifier (e.g., “A1” may correspond to a package offer row which provides two units of Snickers® candy bars for $1.00). Further, such “package offer” rows may be configured to prevent the dispensing of single units of product for retail prices (i.e. such rows may be exclusively used for package offers).

A package offer row may be stocked with alternating types of products. For example, a Snickers® candy bar may be followed by a Milky Way® candy bar, which is followed by a Snickers® candy bar, and so on. Thus, purchasing from such a package offer row can allow diverse combinations of products (e.g., “A2′ may correspond to a package offer row which provides one unit of Snickers® candy bar and one unit of Milky Way® candy bar for $1.00).

In such embodiments, a vending machine may be configured to dispense two (or more) products from a first row for a single price, while dispensing only one product from a second row for a single price. Alternatively, every row in a vending machine may be configured as a “package offer” row.

IX. Rules of Interpretation

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this patent application) nor the Abstract (set forth at the end of this patent application) is to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term “process” or a like term. Accordingly, any reference in a claim to a “step” or “steps” of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” means any one or more microprocessors, CPU devices, computing devices, microcontrollers, digital signal processors, or like devices.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

Some embodiments can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present disclosure.

What is claimed is:

1. A method, comprising:
determining, based at least in part on sales data of a vending machine, a jackpot amount that may be awarded as a customer prize;
displaying the jackpot amount;
determining an interaction of a customer with the vending machine;
determining whether the interaction of the customer with the vending machine qualifies the customer to receive the jackpot amount; and
providing, in the case that it is determined that the customer qualifies to receive the jackpot amount, the jackpot amount to the customer.

2. The method of claim 1, wherein the payout amount comprises at least one of: (i) a number of free units of products offered for sale via the vending machine, and (ii) an amount of credit in an account associated with both the customer and the vending machine.

3. The method of claim 1, wherein the interaction of the customer with the vending machine comprises at least one of: (i) the customer purchasing a product from the vending machine, and (ii) the customer signing up for an account via the vending machine.

4. The method of claim 1, wherein the interaction of the customer with the vending machine comprises the customer redeeming a unit of product pursuant to a subscription account associated with the vending machine.

5. The method of claim 1, wherein the determining of whether the interaction of the customer with the vending machine qualifies the customer to receive the jackpot amount, comprises:
determining a random number; and
determining whether the random number matches a pre-determined jackpot number.

6. The method of claim 1, further comprising:
notifying the customer, in the case that it is determined that the customer qualifies to receive the jackpot amount, that the customer has won the jackpot amount.

7. The method of claim 6, wherein the notifying comprises:
printing a voucher indicative of the winning of the jackpot amount.

8. The method of claim 7, wherein the voucher comprises an indication of a code that may be redeemed to obtain the jackpot amount.

9. The method of claim 6, wherein the notifying comprises:
providing an indication of the winning of the jackpot amount via a game-themed output.

10. The method of claim 1, wherein a probability that the customer will qualify to receive the jackpot amount is determined based at least in part on the sales data of the vending machine.

11. The method of claim 1, wherein a probability that the customer will qualify to receive the jackpot amount is determined based at least in part on a product selected by the customer during the interaction of the customer with the vending machine.

12. The method of claim 1, wherein a probability that the customer will qualify to receive the jackpot amount is determined based at least in part on a type of payment tendered by the customer during the interaction of the customer with the vending machine.

13. The method of claim 1, wherein the jackpot amount is funded by a pre-determined percentage of each sales transaction at the vending machine being contributed to the jackpot amount.

14. The method of claim 13, wherein the pre-determined percentage of each sales transaction comprises a pre-determined percentage of retail prices of products sold during each transaction.

15. The method of claim 13, wherein the pre-determined percentage of each sales transaction comprises a pre-determined percentage of a profit margin realized by each sales transaction.

16. The method of claim 1, wherein the jackpot amount is funded by a pre-determined contribution amount for each sales transaction conducted by the vending machine.

17. The method of claim 1, wherein the jackpot amount is further based at least in part on sales data of one or more other vending machines.

18. A method, comprising:
displaying, via a vending machine, a jackpot amount;
receiving, via a vending machine, an indication of a product selection from a customer;
receiving, via the vending machine, an indication of funds provided by the customer in exchange for the selected product;
determining whether the customer is a winner of the jackpot; and
adding, in the case that the customer is determined not to be a winner of the jackpot, an amount to the jackpot.

19. The method of claim 18, further comprising:
receiving an indication of an update amount to be added to the jackpot, the update amount based on sales data of another vending machine;
adding the update amount to the jackpot; and
displaying the updated jackpot amount.

20. A system, comprising:
a first vending machine to dispense a first set of products to customers and to display a jackpot amount;
a second vending machine to dispense a second set of products to customers and to display the jackpot amount; and
a server in communication with each of the first and second vending machines, wherein the server is operable to define the jackpot amount based on sales data of each of the first and second vending machines.
